(19) United States
(12) Patent Application Publication
(10) Pub. No.: US 2022/0261623 A1
(43) Pub. Date: Aug. 18, 2022

(54) SYSTEM AND METHOD FOR CHANNEL-SEPARABLE OPERATIONS IN DEEP NEURAL NETWORKS

(71) Applicant: Intel Corporation, Santa Clara, CA (US)

(72) Inventors: Raymond Jit-Hung Sung, San Francisco, CA (US); Debabrata Mohapatra, San Jose, CA (US); Arnab Raha, Santa Clara, CA (US); Deepak Abraham Mathaikutty, Chandler, AZ (US); Praveen Kumar Gupta, Hillsboro, OR (US)

(73) Assignee: Intel Corporation, Santa Clara, CA (US)

(21) Appl. No.: 17/733,692

(22) Filed: Apr. 29, 2022

(51) Int. Cl. G06N 3/063; G06F 15/80; G06F 7/544; G06F 7/523; G06F 7/50

(52) U.S. Cl. CPC G06N 3/063; G06F 15/80; G06F 7/50; G06F 7/523; G06F 7/5443

(57) ABSTRACT

An DNN accelerator includes a column of PEs and an external adder assembly for performing depthwise convolution. Each PE includes register files, multipliers, and an internal adder assembly. Each register file can store an operand (input operand, weight operand, etc.) of the depthwise convolution. The operand includes a sequence of elements, each of which corresponds to a different depthwise channel. A multiplier can perform a sequence of multiplications on two operands, e.g., an input operand and a weight operand, and generate a product operand. The internal adder assembly can accumulate product operands and generate an output operand of the PE. The output operand includes output elements, each of which corresponds to a different depthwise channel. The operands may be reused in different rounds of operations by the multipliers. The external adder assembly can accumulate output operands of multiple PEs and generate an output operand of the PE column.

### TECHNICAL FIELD

This disclosure relates generally to deep neural networks (DNNs), and more specifically, to channel-separable operations in DNNs.

### BACKGROUND

DNNs are used extensively for a variety of artificial intelligence applications ranging from computer vision to speech recognition and natural language processing due to their ability to achieve high accuracy. However, the high accuracy comes at the expense of significant energy cost. DNNs have extremely high computing demands as each inference can require hundreds of millions of multiply-accumulate (MAC) operations and other types of operations. Therefore, techniques to improve energy efficiency of DNNs are needed.

### BRIEF DESCRIPTION OF THE DRAWINGS

Embodiments will be readily understood by the following detailed description in conjunction with the accompanying drawings. To facilitate this description, like reference numerals designate like structural elements. Embodiments are illustrated by way of example, and not by way of limitation, in the figures of the accompanying drawings.

FIG. 1 illustrates a layer architecture of an example DNN, in accordance with various embodiments.

FIGS. 2A-2C illustrates data reuse in different rounds of MAC operations in an example depthwise convolution, in accordance with various embodiments.

FIG. 3 is a block diagram of a DNN accelerator, in accordance with various embodiments.

FIG. 4 illustrates a processing element (PE) array, in accordance with various embodiments.

FIG. 5 is a block diagram of a PE, in accordance with various embodiments.

FIG. 6 illustrates an example memory layout within a PE column for reusing data in a depthwise convolution, in accordance with various embodiments.

FIGS. 7A-7I illustrate example rounds of multiplication operations in a depthwise convolution, in accordance with various embodiments.

FIG. 8 illustrates another example memory layout within a PE column for reusing data in a depthwise convolution, in accordance with various embodiments.

FIGS. 9A-9C illustrate other example rounds of multiplication operations in a depthwise convolution, in accordance with various embodiments.

FIG. 10 illustrates an example internal adder assembly in a PE, in accordance with various embodiments.

FIG. 11 illustrates an external adder assembly coupled to a PE column, in accordance with various embodiments.

FIG. 12 illustrates FPMAC operations within a PE, in accordance with various embodiments.

FIG. 13 illustrates an example memory layout within a PE column for reusing data in a floating point (FP) depthwise convolution, in accordance with various embodiments.

FIG. 14 illustrates an example memory layout within two PE columns for reusing data in a FP depthwise convolution, in accordance with various embodiments.

FIGS. 15A and 15B illustrate example rounds of FPMAC operations in a FP depthwise convolution, in accordance with various embodiments.

FIG. 16 illustrates an example channel-separable pooling operation within a PE, in accordance with various embodiments.

FIG. 17 illustrates another example channel-separable pooling operation, in accordance with various embodiments.

FIG. 18 illustrates an example channel-separable elementwise add operation, in accordance with various embodiments.

FIG. 19 illustrates another example channel-separable elementwise addition, in accordance with various embodiments.

FIG. 20 illustrates an example channel-separable elementwise multiplication, in accordance with various embodiments.

FIG. 21 is a flowchart illustrating a method for depthwise convolution with data reuse, in accordance with various embodiments.

FIG. 22 illustrates a deep learning environment, in accordance with various embodiments.

FIG. 23 is a block diagram of a DNN system, in accordance with various embodiments.

FIG. 24 is a block diagram of an example computing device, in accordance with various embodiments.

### DETAILED DESCRIPTION

### Overview

A DNN typically include different types of layers (such as convolutional layers, pooling layers, etc.) for performing different types of operations. The convolutional layers are usually the most compute and memory intensive of all the layers. Residual Networks are one of the networks that use convolutional layers and have been shown to be highly accurate, yet compute efficient, for various image classification, image localization, object detection, object tracking and instance/semantic segmentation tasks. However, the number of weights and MAC operations in Residual Networks cause significant computational and storage requirements that can be too expensive for applications with limited computing resources, such as mobile and edge applications.

To reduce the computational and storage requirements, an alternative type of convolution, called depthwise separable convolution, has been proposed. This lightweight model performs slightly worse than state-of-the art Residual Networks in terms of classification accuracy but requires far fewer parameters and multiply-additions. This is because the standard convolution operation has the effect of filtering features based on the convolutional kernels and combining features to produce a new representation. In contrast, depthwise separable convolution splits the filtering and combination steps into two separate steps: depthwise convolutions and pointwise convolutions. The combination of the two steps is less computationally expensive than standard convolution operation.

One technique to enable depthwise convolution is to introduce a separate compute unit for depthwise convolution. As standard convolution is still more prevalent in many DNNs than depthwise convolution, this technique requires that dedicated hardware, which is optimized specifically for processing depthwise convolution, co-exists alongside hardware for standard convolutions within a DNN accelerator. However, DNN accelerators with separate compute arrays for standard convolution and depthwise convolution incurs a prohibitively large silicon area footprint and leakage power which are major drawbacks of this approach. Such use of silicon area, extra leakage power and the associated difficulties of distributing data to multiple processing arrays precludes such a solution for many edge DNN accelerators.

Another technique is to execute depthwise convolution on existing hardware optimized for standard convolution. However, this technique uses a small fraction of the available MACs during depthwise convolution and hence performance will suffer. Not all MACs that would normally be operating on input channels in each cycle during standard convolution can be used during depthwise convolution. MAC utilization can be less than 7%. The percentage of underutilized MACs will continue to rise as the process nodes advance from one generation to the next due to memories and wires not scaling nearly as well as logic. It makes sense for future designs to increase the number of MACs since logic is relatively free. However, if the MACs cannot be properly utilized for edge DNN workloads, then adding more of them does not make sense. Further, many weights and activations need to be read from external memory since this solution has no way to reuse the input activation data when performing depthwise convolution. That can cause high amounts of data movement from the external memory to the local storage at the PEs, causing much power dissipation.

Also, this technique fails to efficiently execute other channel-separable neural network layers, such as pooling, elementwise addition, and elementwise multiplication, as the accelerators are optimized for accumulation of input channels. This often forces the compiler to schedule these layers on a general-purpose microprocessor or vector processor thus reducing overall system performance.

Embodiments of the present disclosure may improve on at least some of the challenges and issues described above by providing DNN accelerators that can efficiently process both standard convolution and depthwise convolution. Such DNN accelerators may also be used for other types of channel-separable operations, such as pooling, elementwise addition, elementwise multiplication, etc.

An example DNN accelerator includes a memory, a PE assembly, one or more external adder assemblies, and a controlling module. The memory may store data to be used for depthwise convolutions and data generate through depthwise convolutions, such as input feature maps (IFMs), filters, output feature maps (OFMs), and so on. The PE assembly includes PE that can perform MAC operations. An external adder assembly can perform accumulation operations on outputs of PEs and generate final outputs, e.g., an OFM or a portion of an OFM. The controlling module may control data transfer between the other components, data processing within another component, etc., to facilities data reuse in depthwise convolutions.

In some embodiments, the controlling module may form and send input operands and weight operands to PEs. An input operand includes input elements from an IFM of a depth convolution. Each input element may correspond to a different channel of the IFM. The input elements may be arranged in an order of the channels in the IFM. A weight operand includes weights from a filter of the depth convolution. Each weight may correspond to a different channel. The controlling module may send same input operands and weight operands to multiple PEs so that the input operands and weight operands can be reused across these PEs in the depth convolution. Also, same input operands may be reused within a single PE in different rounds of MAC operations by the PE. For instance, the PE may include multipliers, each of which may perform a sequence of multiplications on an input operand and a weight operand in a single round. A first multiplier may use a first input operand and a first weight operand in a first round. The first input operand and a second weight operand may be used by a second multiplier in a second round. The first input operand may further be used in subsequent rounds by other multipliers. That way, the first input operand is used in multiple rounds. The data reuse among multiple PEs and within a single PE can reduce time and energy needed to load the data and therefore, improve efficiency of the depthwise convolution.

In addition to the multiplications, the depthwise convolution may also include accumulations performed by adders inside PEs (i.e., internal adders), which may be arranged in internal adder assemblies, and adders outside PEs (i.e., external adders), which may be arranged in the external adder assembly. In some embodiments, an internal adder assembly may perform inter row-wise reduction by accumulating products generated through weights arranged in a same row of the filter. The internal adder assembly may generate an output operand of the corresponding PE. The output operand includes a sequence of output elements, each of which may corresponds to a different channel. The output operand may be stored in a register file of the PE. The external adder assembly may perform intra row-wise reduction by accumulating output operands of multiple PEs. The external adder assembly may generate one or more final output operands, which may constitute at least a portion of the OFM of the depthwise convolution.

Compared with conventional depthwise convolution, depthwise convolutions in the present disclosure can be performed with less data read accesses through data reuse. Also, depthwise convolutions as well as other channel-separable operations can be performed by using same compute unit as that used for standard convolution, so that silicon area and leakage power can be save. Thus, the present disclosure can improve efficiency of channel-separable neural network layers. Such improvement may continue to scale as additional silicon area may be used for additional MACs, which may cause percentage of under-used MACs to increase in future designs.

For purposes of explanation, specific numbers, materials and configurations are set forth in order to provide a thorough understanding of the illustrative implementations. However, it will be apparent to one skilled in the art that the present disclosure may be practiced without the specific details or/and that the present disclosure may be practiced with only some of the described aspects. In other instances, well known features are omitted or simplified in order not to obscure the illustrative implementations.

Further, references are made to the accompanying drawings that form a part hereof, and in which is shown, by way of illustration, embodiments that may be practiced. It is to be understood that other embodiments may be utilized and structural or logical changes may be made without departing from the scope of the present disclosure. Therefore, the following detailed description is not to be taken in a limiting sense.

Various operations may be described as multiple discrete actions or operations in turn, in a manner that is most helpful in understanding the claimed subject matter. However, the order of description should not be construed as to imply that these operations are necessarily order dependent. In particular, these operations may not be performed in the order of presentation. Operations described may be performed in a different order from the described embodiment. Various additional operations may be performed, or described operations may be omitted in additional embodiments.

For the purposes of the present disclosure, the phrase “A and/or B” means (A), (B), or (A and B). For the purposes of the present disclosure, the phrase “A, B, and/or C” means (A), (B), (C), (A and B), (A and C), (B and C), or (A, B, and C). The term “between,” when used with reference to measurement ranges, is inclusive of the ends of the measurement ranges.

The description uses the phrases “in an embodiment” or “in embodiments,” which may each refer to one or more of the same or different embodiments. The terms “comprising,” “including,” “having,” and the like, as used with respect to embodiments of the present disclosure, are synonymous. The disclosure may use perspective-based descriptions such as “above,” “below,” “top,” “bottom,” and “side” to explain various features of the drawings, but these terms are simply for ease of discussion, and do not imply a desired or required orientation. The accompanying drawings are not necessarily drawn to scale. Unless otherwise specified, the use of the ordinal adjectives “first,” “second,” and “third,” etc., to describe a common object, merely indicate that different instances of like objects are being referred to, and are not intended to imply that the objects so described must be in a given sequence, either temporally, spatially, in ranking or in any other manner.

In the following detailed description, various aspects of the illustrative implementations will be described using terms commonly employed by those skilled in the art to convey the substance of their work to others skilled in the art.

The terms “substantially,” “close,” “approximately,” “near,” and “about,” generally refer to being within +/−20% of a target value based on the input operand of a particular value as described herein or as known in the art. Similarly, terms indicating orientation of various elements, e.g., “coplanar,” “perpendicular,” “orthogonal,” “parallel,” or any other angle between the elements, generally refer to being within +/−5-20% of a target value based on the input operand of a particular value as described herein or as known in the art.

In addition, the terms “comprise,” “comprising,” “include,” “including,” “have,” “having” or any other variation thereof, are intended to cover a non-exclusive inclusion. For example, a method, process, device, or DNN accelerator that comprises a list of elements is not necessarily limited to only those elements but may include other elements not expressly listed or inherent to such method, process, device, or DNN accelerators. Also, the term “or” refers to an inclusive “or” and not to an exclusive “or.”

The DNN accelerators, methods and devices of this disclosure each have several innovative aspects, no single one of which is solely responsible for all desirable attributes disclosed herein. Details of one or more implementations of the subject matter described in this specification are set forth in the description below and the accompanying drawings.

Example DNN Layer Architecture

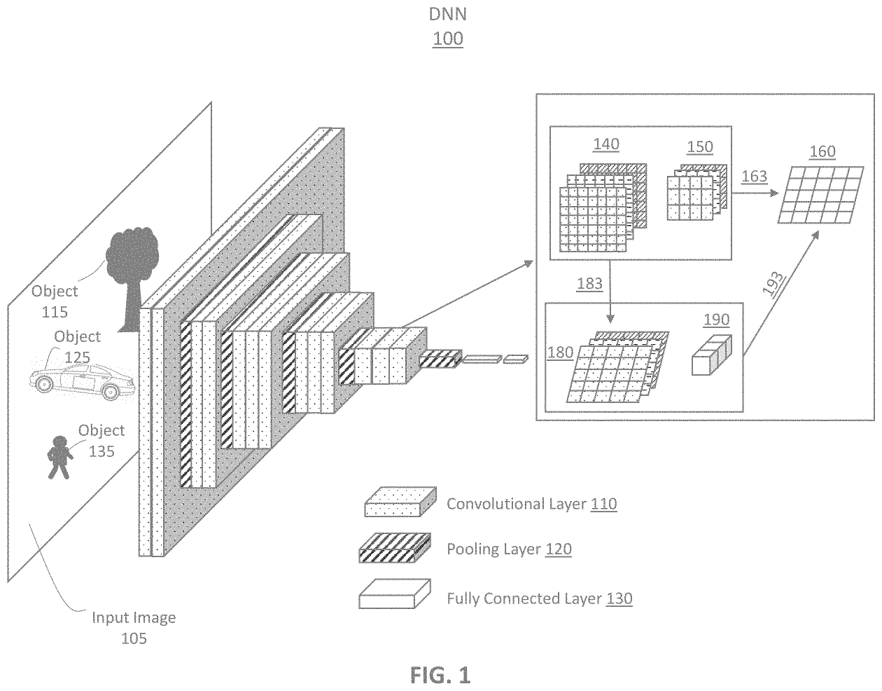

FIG. 1 illustrates a layer architecture of an example DNN 100, in accordance with various embodiments. For purpose of illustration, the DNN 100 in FIG. 1 is a Visual Geometry Group (VGG)-based convolutional neural network (CNN). In other embodiments, the DNN 100 may be other types of DNNs. The DNN 100 is trained to receive images and output classifications of objects in the images. In the embodiments of FIG. 1, the DNN 100 receives an input image 105 that includes objects 115, 125, and 135. The DNN 100 includes a sequence of layers comprising a plurality of convolutional layers 110 (individually referred to as “convolutional layer 110”), a plurality of pooling layers 120 (individually referred to as “pooling layer 120”), and a plurality of fully connected layers 130 (individually referred to as “fully connected layer 130”). In other embodiments, the DNN 100 may include fewer, more, or different layers.

The convolutional layers 110 summarize the presence of features in the input image 105. The convolutional layers 110 function as feature extractors. The first layer of the DNN 100 is a convolutional layer 110. In an example, a convolutional layer 110 performs a convolution on an input tensor 140 (also referred to as IFM 140) and a filter 150. As shown in FIG. 1, the IFM 140 is represented by a 7×7×3 three-dimensional (3D) matrix. The IFM 140 includes three input channels, each of which is represented by a 7×7 two-dimensional (2D) array. The 7×7 2D array includes 7 input elements (also referred to as input points) in each row and 7 input elements in each column. The filter 150 is represented by a 3×3×3 3D matrix. The filter 150 includes three kernels, each of which may correspond to a different input channel of the IFM 140. A kernel a 2D array of weights, where the weights are arranged in columns and rows. A kernel can be smaller than the IFM. In the embodiments of FIG. 1, each kernel is represented by a 3×3 2D array. The 3×3 kernel includes 3 weights in each row and 3 weights in each column. Weights can be initialized and updated by backpropagation using gradient descent. The magnitudes of the weights can indicate importance of the filter 150 in extracting features from the IFM 140.

The convolution includes MAC operations with the input elements in the IFM 140 and the weights in the filter 150. The convolution may be a standard convolution 163 or a depthwise convolution 183. In the standard convolution 163, the whole filter 150 slides across the IFM 140. All the input channels are combined to produce an output tensor 160 (also referred to as OFM 160). The OFM 160 is represented by a 5×5 2D array. The 5×5 2D array includes 5 output elements (also referred to as output points) in each row and 5 output elements in each column. For purpose of illustration, the standard convolution includes one filter in the embodiments of FIG. 1. In embodiments where there are multiple filters, the standard convolution may produce multiple output channels in the OFM 160.

The multiplication applied between a kernel-sized patch of the IFM 140 and a kernel may be a dot product. A dot product is the elementwise multiplication between the kernel-sized patch of the IFM 140 and the corresponding kernel, which is then summed, always resulting in a single value. Because it results in a single value, the operation is often referred to as the “scalar product.” Using a kernel smaller than the IFM 140 is intentional as it allows the same kernel (set of weights) to be multiplied by the IFM 140 multiple times at different points on the IFM 140. Specifically, the kernel is applied systematically to each overlapping part or kernel-sized patch of the IFM 140, left to right, top to bottom. The result from multiplying the kernel with the IFM 140 one time is a single value. As the kernel is applied multiple times to the IFM 140, the multiplication result is a 2D array of output elements. As such, the 2D output array (i.e., the OFM 160) from the standard convolution 163 is referred to an OFM.

In the depthwise convolution 183, the input channels are not combined. Rather, MAC operations are performed on an individual input channel and an individual kernel and produce an output channel. As shown in FIG. 1, the depthwise convolution 183 produces a depthwise output tensor 180. The depthwise output tensor 180 is represented by a 5×5×3 3D matrix. The depthwise output tensor 180 includes three output channels, each of which is represented by a 5×5 2D array. The 5×5 2D array includes 5 output elements in each row and 5 output elements in each column. Each output channel is a result of MAC operations of an input channel of the IFM 140 and a kernel of the filter 150. For instance, the first output channel (patterned with dots) is a result of MAC operations of the first input channel (patterned with dots) and the first kernel (patterned with dots), the second output channel (patterned with horizontal strips) is a result of MAC operations of the second input channel (patterned with horizontal strips) and the second kernel (patterned with horizontal strips), and the third output channel (patterned with diagonal stripes) is a result of MAC operations of the third input channel (patterned with diagonal stripes) and the third kernel (patterned with diagonal stripes). In such a depthwise convolution, the number of input channels equals the number of output channels, and each output channel corresponds to a different input channel. The input channels and output channels are referred to collectively as depthwise channels. After the depthwise convolution, a pointwise convolution 193 is then performed on the depthwise output tensor 180 and a 1×1×3 tensor 190 to produce the OFM 160.

The OFM 160 is then passed to the next layer in the sequence. In some embodiments, the OFM 160 is passed through an activation function. An example activation function is the rectified linear activation function (ReLU). ReLU is a calculation that returns the value provided as input directly, or the value zero if the input is zero or less. The convolutional layer 110 may receive several images as input and calculates the convolution of each of them with each of the kernels. This process can be repeated several times. For instance, the OFM 160 is passed to the subsequent convolutional layer 110 (i.e., the convolutional layer 110 following the convolutional layer 110 generating the OFM 160 in the sequence). The subsequent convolutional layers 110 performs a convolution on the OFM 160 with new kernels and generates a new feature map. The new feature map may also be normalized and resized. The new feature map can be kerneled again by a further subsequent convolutional layer 110, and so on.

In some embodiments, a convolutional layer 110 has four hyperparameters: the number of kernels, the size F kernels (e.g., a kernel is of dimensions F×F×D pixels), the S step with which the window corresponding to the kernel is dragged on the image (e.g., a step of one means moving the window one pixel at a time), and the zero-padding P (e.g., adding a black contour of P pixels thickness to the input image of the convolutional layer 110). The convolutional layers 110 may perform various types of convolutions, such as 2-dimensional convolution, dilated or atrous convolution, spatial separable convolution, depthwise separable convolution, transposed convolution, and so on. The DNN 100 includes 16 convolutional layers 110. In other embodiments, the DNN 100 may include a different number of convolutional layers.

The pooling layers 120 down-sample feature maps generated by the convolutional layers, e.g., by summarizing the presents of features in the patches of the feature maps. A pooling layer 120 is placed between two convolution layers 110: a preceding convolutional layer 110 (the convolution layer 110 preceding the pooling layer 120 in the sequence of layers) and a subsequent convolutional layer 110 (the convolution layer 110 subsequent to the pooling layer 120 in the sequence of layers). In some embodiments, a pooling layer 120 is added after a convolutional layer 110, e.g., after an activation function (e.g., ReLU) has been applied to the OFM 160.

A pooling layer 120 receives feature maps generated by the preceding convolution layer 110 and applies a pooling operation to the feature maps. The pooling operation reduces the size of the feature maps while preserving their important characteristics. Accordingly, the pooling operation improves the efficiency of the DNN and avoids over-learning. The pooling layers 120 may perform the pooling operation through average pooling (calculating the average value for each patch on the feature map), max pooling (calculating the maximum value for each patch of the feature map), or a combination of both. The size of the pooling operation is smaller than the size of the feature maps. In various embodiments, the pooling operation is 2×2 pixels applied with a stride of two pixels, so that the pooling operation reduces the size of a feature map by a factor of 2, e.g., the number of pixels or values in the feature map is reduced to one quarter the size. In an example, a pooling layer 120 applied to a feature map of 6×6 results in an output pooled feature map of 3×3. The output of the pooling layer 120 is inputted into the subsequent convolution layer 110 for further feature extraction. In some embodiments, the pooling layer 120 operates upon each feature map separately to create a new set of the same number of pooled feature maps.

The fully connected layers 130 are the last layers of the DNN. The fully connected layers 130 may be convolutional or not. The fully connected layers 130 receives an input operand. The input operand defines the output of the convolutional layers 110 and pooling layers 120 and includes the values of the last feature map generated by the last pooling layer 120 in the sequence. The fully connected layers 130 applies a linear combination and an activation function to the input operand and generates an individual partial sum. The individual partial sum may contain as many elements as there are classes: element i represents the probability that the image belongs to class i. Each element is therefore between 0 and 1, and the sum of all is worth one. These probabilities are calculated by the last fully connected layer 130 by using a logistic function (binary classification) or a softmax function (multi-class classification) as an activation function.

In some embodiments, the fully connected layers 130 classify the input image 105 and returns an operand of size N, where N is the number of classes in the image classification problem. In the embodiments of FIG. 1, N equals 3, as there are three objects 115, 125, and 135 in the input image. Each element of the operand indicates the probability for the input image 105 to belong to a class. To calculate the probabilities, the fully connected layers 130 multiply each input element by weight, makes the sum, and then applies an activation function (e.g., logistic if N=2, softmax if N>2). This is equivalent to multiplying the input operand by the matrix containing the weights. In an example, the individual partial sum includes three probabilities: a first probability indicating the object 115 being a tree, a second probability indicating the object 125 being a car, and a third probability indicating the object 135 being a person. In other embodiments where the input image 105 includes different objects or a different number of objects, the individual partial sum can be different.

Example Depthwise Convolution

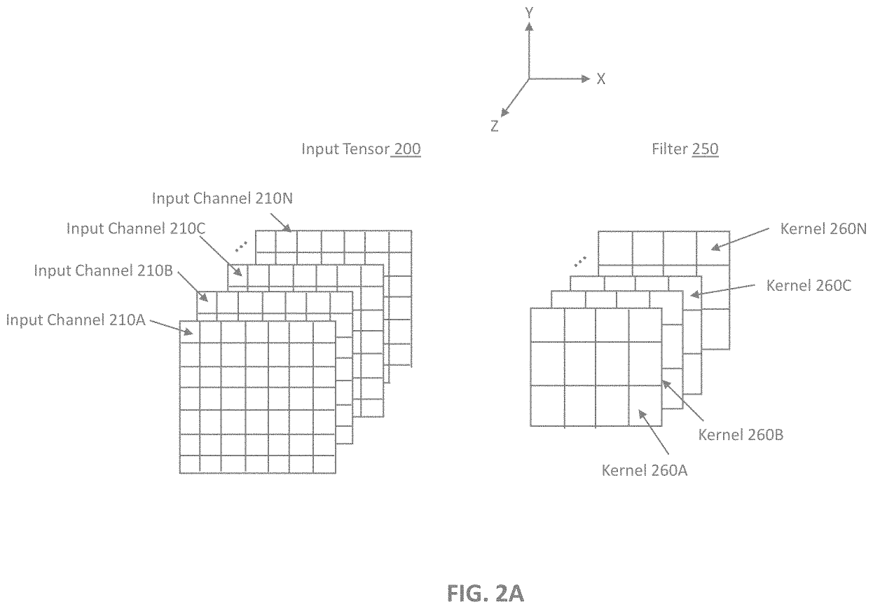

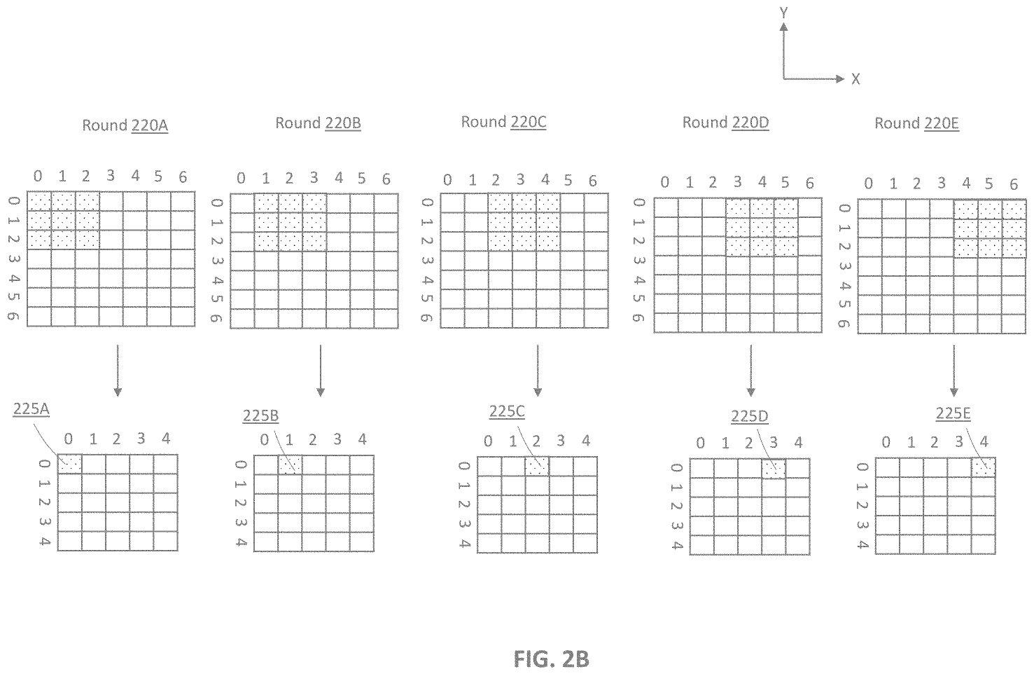

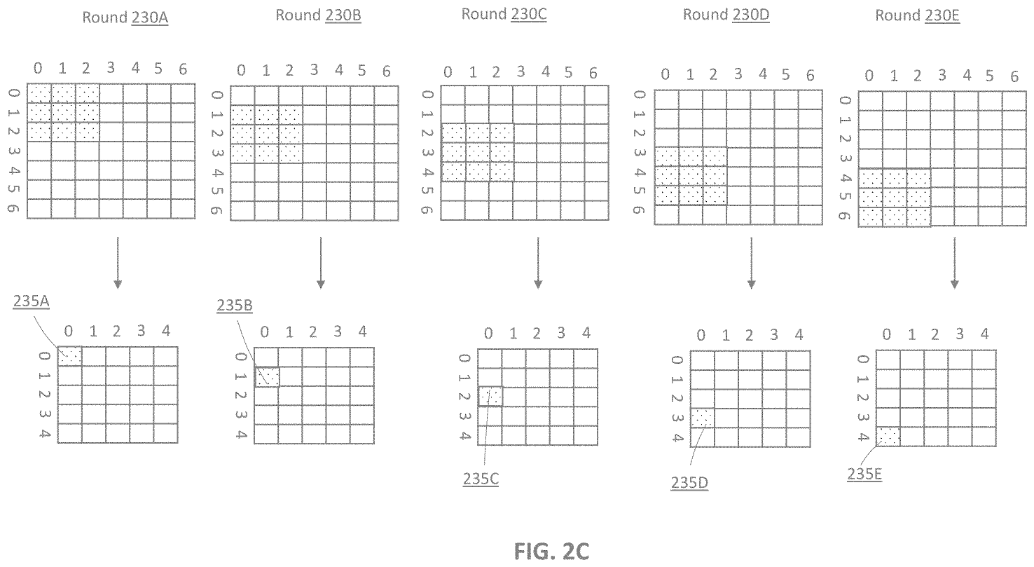

FIGS. 2A-2C illustrates data reuse in different rounds of MAC operations in an example depthwise convolution, in accordance with various embodiments. The depthwise convolution is performed on an input tensor 200 and a filter 250, which are shown in FIG. 2A. The input tensor 200 includes a plurality of input channels 210A-N (collectively referred to as “input channels 210” or “input channel 210”). Each input channel 210 includes a 7×7 array, where input elements are arranged in 7 rows and 7 columns. The filter includes a plurality of kernels 260A-N (collectively referred to as “kernels 260” or “kernel 260”). Each input channel 210 includes a 3×3 array, where weights are arranged in 3 rows and 3 columns. In other embodiments, the input tensor 200 or filter 250 may include a different number of channels, and each channel may include a different number of rows or columns. In the embodiments of FIGS. 2A-2C, the channels are arranged along the Z-axis, rows are along the X-axis, and columns are along the Y-axis.

FIG. 2B shows reuse of input elements in different rounds of the depthwise convolution along the X-axis. FIG. 2B shows a sequence of five rounds 220A-E (collectively referred to as “rounds 220” or “round 220”) of the depthwise convolution, during which a kernel 260 slide through an input channel 210 along the X-axis. The five rounds produce five output elements 225A-E (collectively referred to as “output elements 225” or “output element 225”) that constitute a row of an output channel. Each round 220 includes MAC operations on the kernel 260 and a portion of an input channel 210 that has the size of the kernel 260, which produce a single output element 225.

In FIG. 2B, each row of the input channel 210 has a X coordinate, each column of the input channel 210 has a Y coordinate, and each input element can be identified with its XY coordinates. As shown in FIG. 2B, the round 220A uses input elements of X0-X2/Y0-Y2, the round 220B uses input elements of X1-X3/Y0-Y2, the round 220C uses input elements of X2-X4/Y0-Y2, the round 220D uses input elements of X3-X5/Y0-Y2, and the round 220E uses input elements of X4-X6/Y0-Y2. Thus, six input elements from a preceding round can be reused in the subsequent round.

FIG. 2C shows reuse of input elements in different rounds of the depthwise convolution along the Y-axis. FIG. 2C shows a sequence of five rounds 230A-E (collectively referred to as “rounds 230” or “round 230”) of the depthwise convolution, during which a kernel 260 slide through an input channel 210 along the Y-axis. The five rounds produce five output elements 235A-E (collectively referred to as “output elements 235” or “output element 235”) that constitute a column of an output channel. Each round 230 includes MAC operations on the kernel 260 and a portion of an input channel 210 that has the size of the kernel 260, which produce a single output element 235.

The round 230A uses input elements of X0-X2/Y0-Y2, the round 230B uses input elements of X0-X2/Y1-Y3, the round 230C uses input elements of X0-X2/Y2-Y4, the round 230D uses input elements of X0-X2/Y3-Y5, and the round 230E uses input elements of X0-X2/Y4-Y6. Thus, six input elements from a preceding round can be reused in the subsequent round. Even though not shown in FIG. 2B or FIG. 2C, more data reuse along the Y-axis and the Y-axis can be implemented in the depthwise convolution. Such data reuse can improve efficiency of the depth convolution. For instance, resources needed to load data or update memory can be reduced.

Example DNN Accelerator

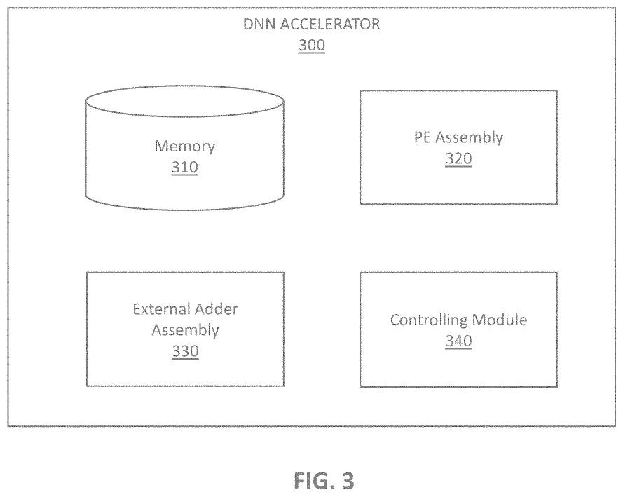

FIG. 3 is a block diagram of a DNN accelerator 300, in accordance with various embodiments. The DNN accelerator 300 may be a DNN layer (e.g., a convolutional layer 110), or a portion of a DNN layer. The DNN accelerator 300 can perform depthwise convolutions with data reuse. The DNN accelerator 300 includes a memory 310, a PE assembly 320, an external adder assembly 330, and a controlling module 340. In some embodiments, the DNN accelerator 300 may include more, fewer, or different components. For instance, the DNN accelerator 300 may include multiple PE arrays. A component of the DNN accelerator 300 may be arranged externally to the DNN accelerator 300. Also, some of all functions of a component may be performed by a different component of the DNN accelerator 300 or an external system.

The memory 310 stores data associated with MAC operations, including data to be used for MAC operations, data generated from MAC operations, etc. For instance, the memory stores some or all of the IFMs, filters, and OFMs of a DNN layer. In some embodiments, the memory 310 is a SRAM. The memory 310 may be byte-addressable, and each memory address identifies a single byte (eight bits) of storage. The memory 310 includes a plurality of storage units, each of which has a memory address. In an example, a storage unit may store a single byte, and data larger than a single byte may be stored in storage units with consecutive memory addresses, i.e., adjacent storage units. For instance, a storage unit can store an integer number in the INT8 format, versus two storage units may be needed to store a number in the FP16 or BF16 format, which has 16 bits. In some embodiments, 16 bits can be transferred from the memory 310 in a single reading cycle. In other embodiments, 16 bits can be transferred from the memory 310 in multiple reading cycles, such as two cycles.

The PE assembly 320 includes a plurality of PEs. The PEs may be arranged in columns, or columns and rows. The PE assembly 320 may be a tile, or a portion of a tile, of a DNN layer having a tile architecture. The DNN layer may include one or more other PE assemblies that may operate in parallel with the PE assembly 320. In some embodiments, the PE assembly 320 receive an IFM and one or more filters of a DNN layer and performs MAC operations with the IFM and filters.

In some embodiments, the PE assembly 320 may have a depthwise convolution mode, in which it performs a depthwise convolution on an IFM and a filter, or a standard convolution mode, in which it performs a standard convolution on an IFM and a filter. In a depthwise convolution, a PE may perform MAC operations on one or more input operand and one or more weight operands. An input operand may include a sequence of input elements from the IFM. Each input element in the input operand may correspond to a different depthwise channel. The number of input elements in the input operand may equal the number of depthwise channels in the IFM. The input elements in an input operand may have the same XY coordinates. A weight operand may include a plurality of weights from the filter. Each weight of the weight operand may correspond to a different depthwise channel.

The MAC operations may include a sequence of multiplications for an individual input operand and an individual weight operand. Each multiplication in the sequence (also referred to as a cycle) is a multiplication of a different input element in the input operand with a different weight in the weight operand. For instance, the first cycle includes multiplication of the first input element in the input operand with the first weight in the weight operand, the second cycle includes multiplication of the second input element in the input operand with the second weight in the weight operand, and so on. The sequence of multiplication produces a product operand that includes a sequence of products. Each product may correspond to a different depthwise channel. The MAC operation may also include accumulations operations in which multiple product operands are accumulated to produce an output operand of the PE. The output operand may include a sequence of output elements, each of which corresponds to a different depthwise channel. The PE assembly 320 may output multiple output operands at a time, each of which is generated by a different PE.

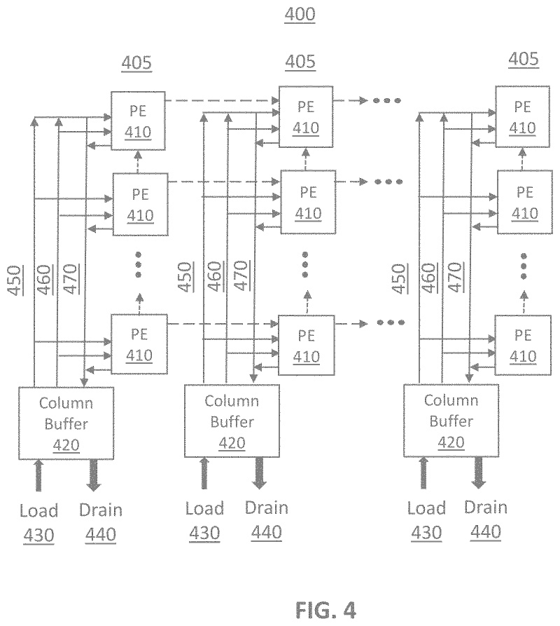

In a standard convolution, MAC operations may include accumulations across the channels. For instance, as opposed to generating an output operand, a PE may accumulate products across different channels to generate a single output point. More details regarding the PE assembly 320 are described below in conjunction with FIGS. 3 and 4.

The external adder assembly 330 is coupled to the PE assembly 320. In a depthwise convolution, the external adder assembly 330 may perform accumulation operations on multiple output operands from the PE assembly 320 (e.g., from some or all of the PEs in the PE assembly 320) and generate a new output operand. The external adder assembly 330 may generate a single or multiple new output operands.

In some embodiments, the external adder assembly 330 includes a plurality of external adders (i.e., adders external to the PEs in the PE assembly 320). The external adders may be arranged in a sequence of tiers. An external adder in the first tier receives output operands from two or more PEs in the PE assembly 320 (e.g., two or more PEs in a column of the PE assembly 320) and can generate a new output operand through accumulation operations on the PE output operands. An external adder in the second tier or following tiers receives output operands from two or more external adders in the precedent tier and can accumulate these output operands to generate a new output operand.

In some embodiments, one or more final output operands of the depthwise convolution may be obtained from a particular tier of these tiers. The particular tier may be identified from the sequence of tiers based on a size of the filter, a number of PEs coupled to the external adder assembly 330, other factors, etc. For instance, each external adder in the particular tier generates a final output operand. The final output operand is a portion of the OFM of the depthwise convolution. The final output operand includes a sequence of output elements in the OFM, each of the output elements may correspond to a different depthwise channel.

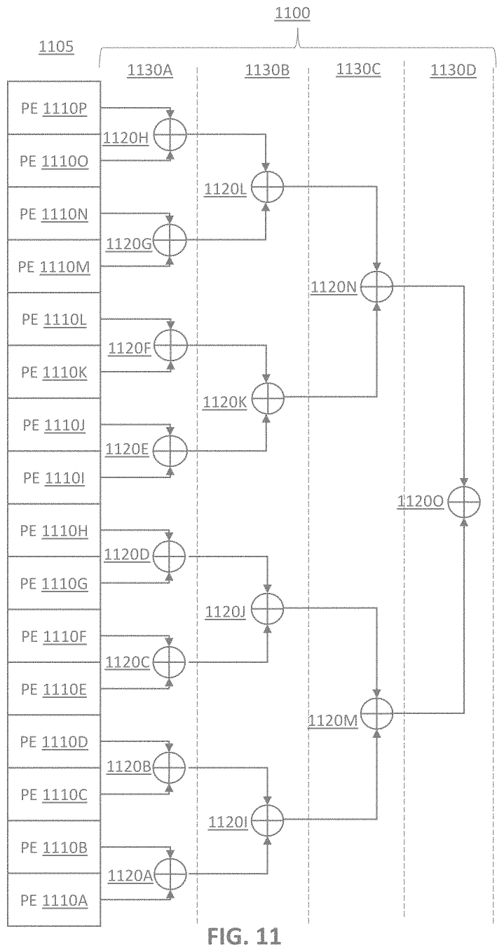

Even though FIG. 3 shows a single external adder assembly 330, the DNN accelerator 300 may include multiple external adder assemblies 330. For instance, the DNN accelerator 300 may include an external adder assembly 330 for each PE column in the PE assembly 320. The final output operands extracted from the external adder assemblies 330 constitute the OFM of the depthwise convolution. More details regarding external adder assembly are provided below in conjunction with FIG. 11.

The controlling module 340 controls one or more other components of the DNN accelerator 300, such as data transfer between other components of the DNN accelerator 300, data processing within another components of the DNN accelerator 300, and so on. For instance, the controlling module 340 may control data transfer from the memory 310 to the PE assembly 320, data layout within PE assembly 320, data processing within the PE assembly 320, data transfer between the PE assembly 320 and the external adder assembly 330, data processing within the external adder assembly 330, data output from the external adder assembly 330, and so on. In some embodiments, the controlling module 340 can facilitate data reuse during depthwise convolutions to improve efficiency of the DNN accelerator 300 for processing depthwise convolutions.

The controlling module 340 may form input operands from an IFM stored in the memory 310 and transfers the input operands to PEs in the PE assembly 320. The controlling module 340 may also form weight operands from a filter stored in the memory 310 and transfers the weights operands to the PEs. In some embodiments, the controlling module 340 determines how many register files in a PE can be used to store input operands and how many register files can be used to store weight operands. Based on the number of the register files, the controlling module 340 may determine the number of input operands and the number of weight operands to be transferred to the PE for the PE to perform a round of MAC operations. The controlling module 340 may transfer new data (e.g., new input operand) to the PE for a new round of MAC operations. The controlling module 340 may also instruct the PE to reuse at least some of the input operands from the previous round in the new round.

In an example, the controlling module 340 may instruct, for a first round at a first time, a first multiplier in the PE to perform multiplication operations on a first input operand from a first input register file in the PE and a first weight operand from a first weight register file in the PE. For a second round at a second time, the controlling module 340 may instruct a second multiplier of the PE to perform multiplication operations on the first input operand and a second weight operand from a second weight register file, so that the first input operand is reused in both rounds within the PE.

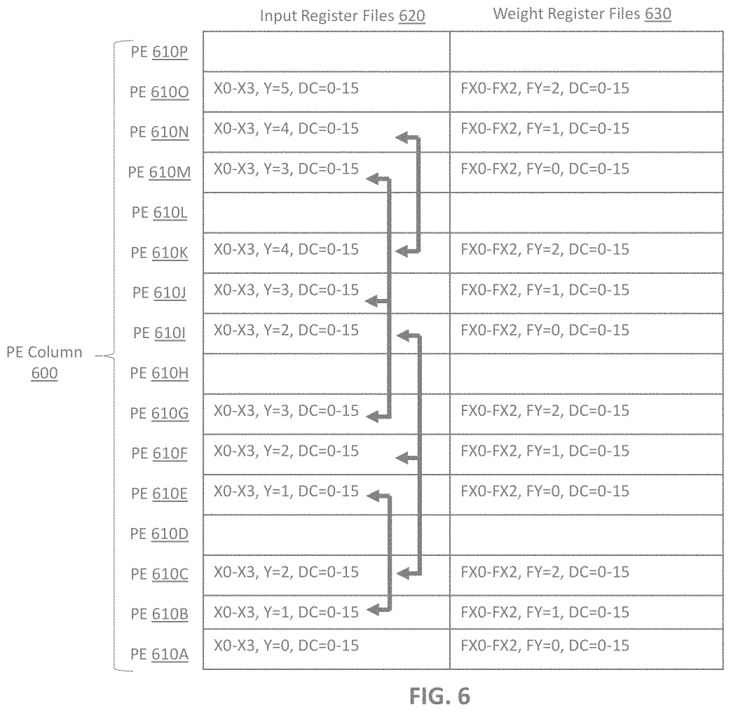

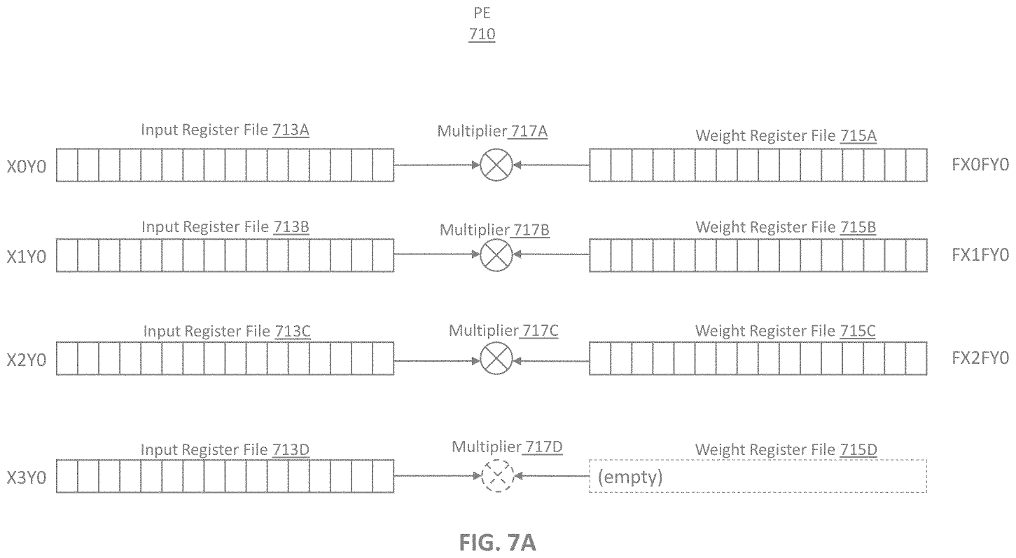

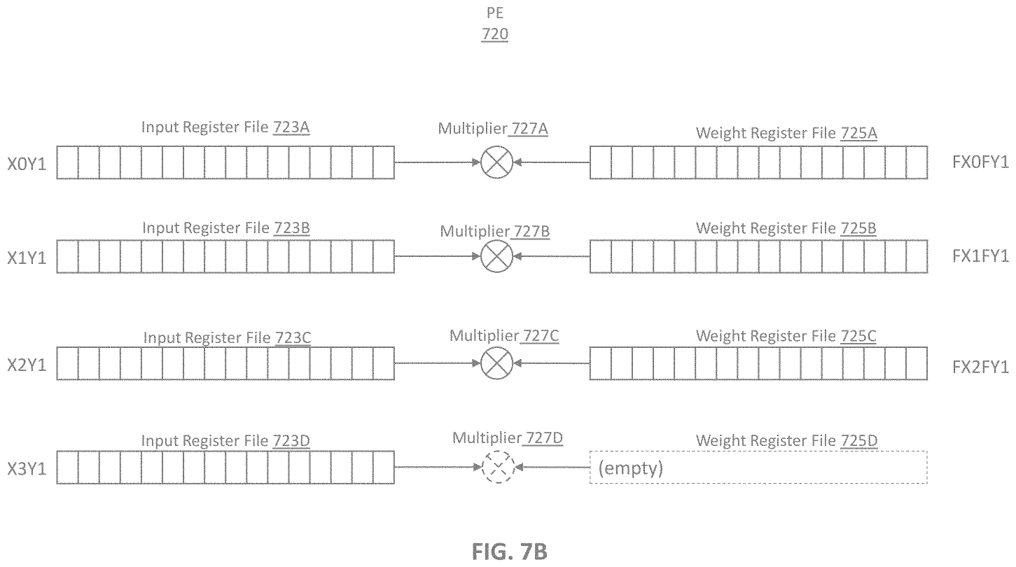

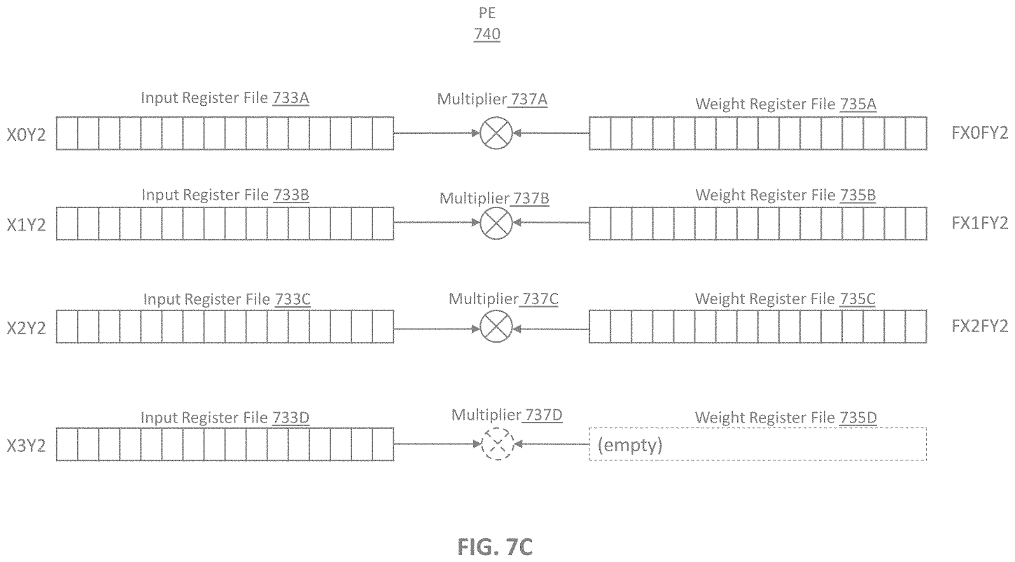

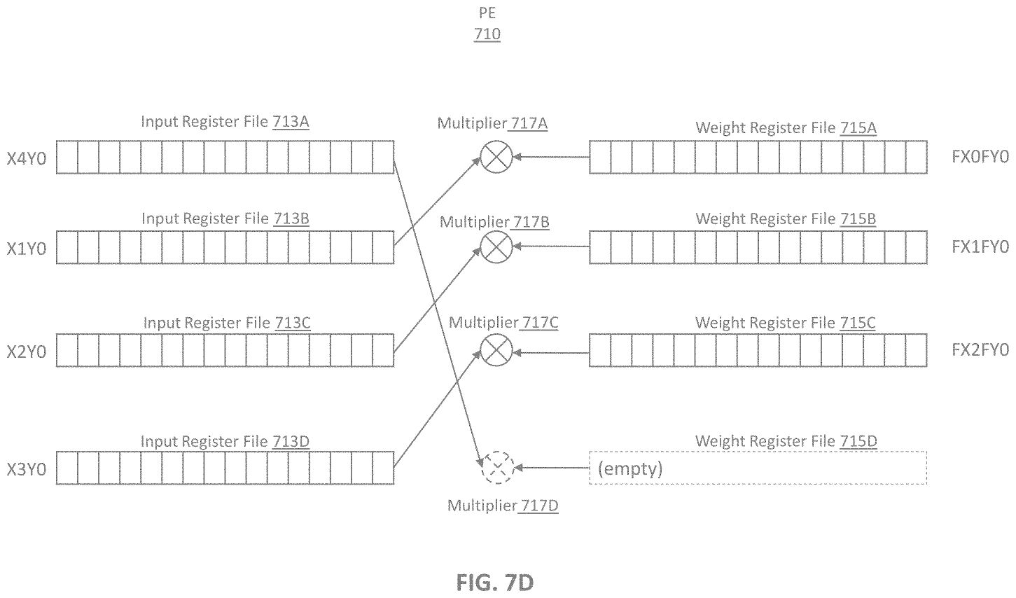

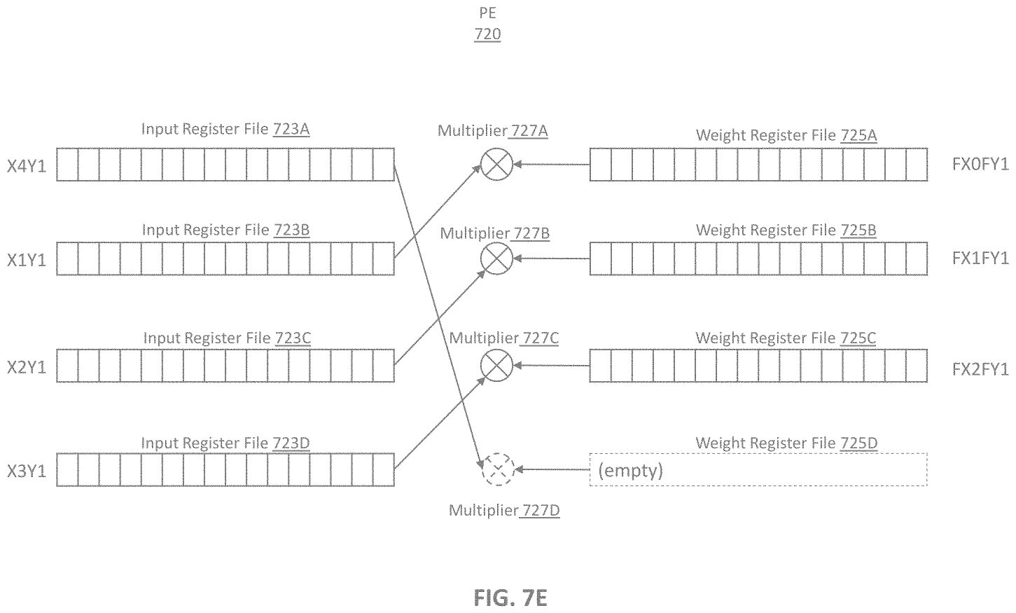

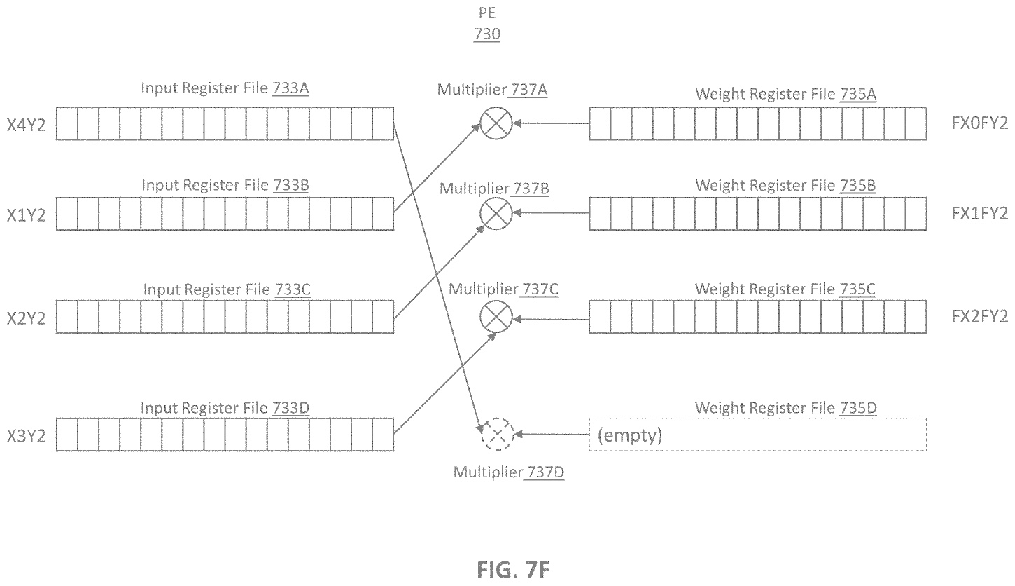

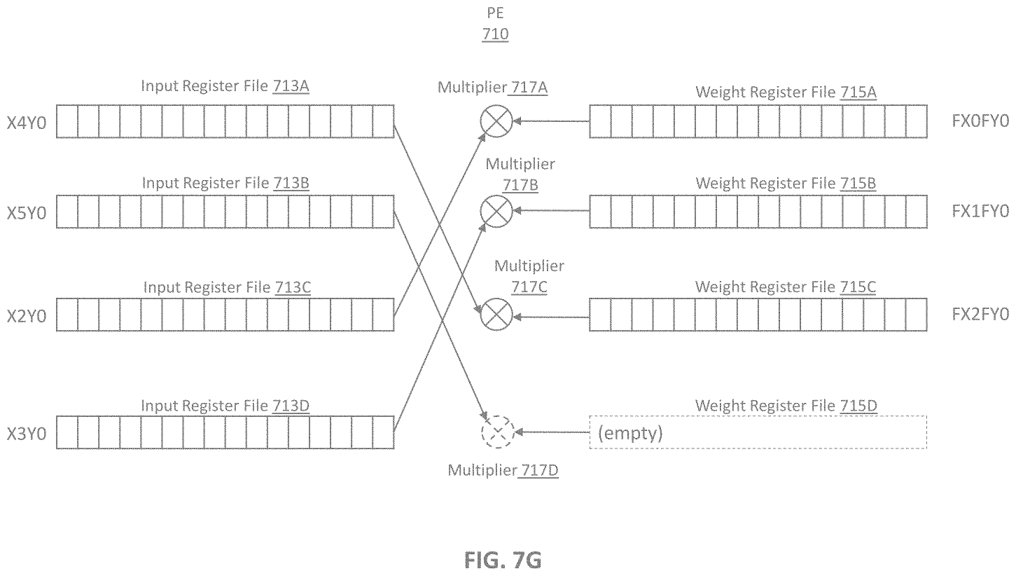

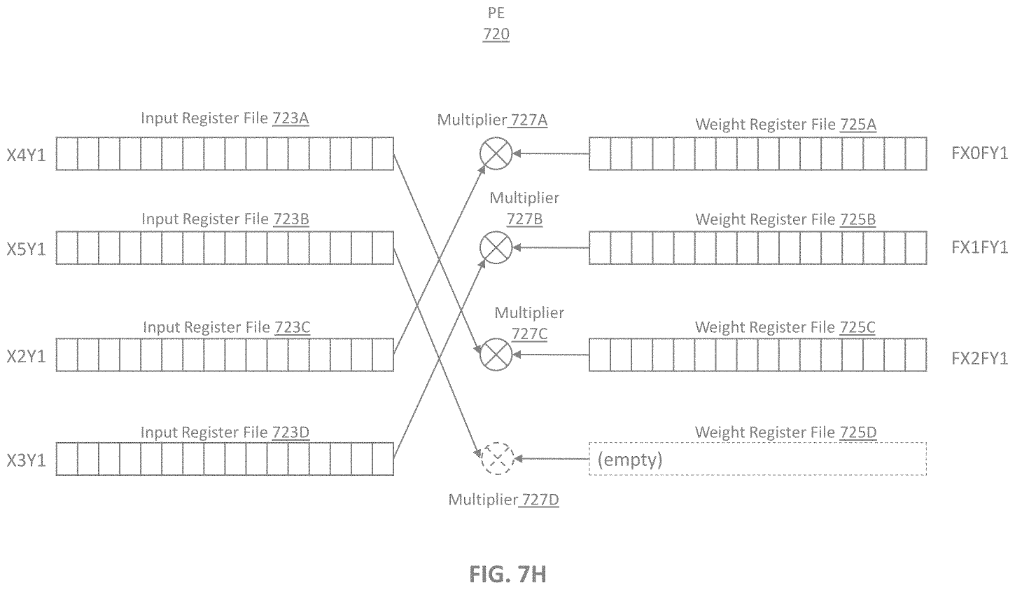

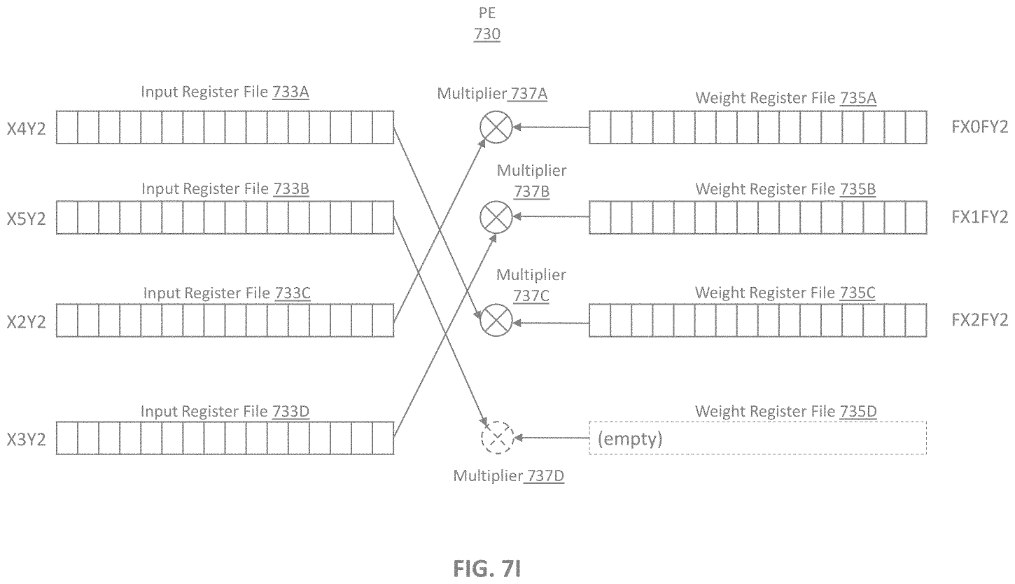

Additionally or alternatively, the controlling module 340 can facilitate data reuse across different PEs. For instance, the controlling module 340 may send same input operands and same weight operands to different PEs, which may perform MAC operations on the same data at the same time. More details regarding data reuse are provided below in conjunction with FIGS. 6, 7A-I, 8, and 9A-C.

In some embodiments, the controlling module 340 identifies which tier in the external adder assembly 330 generates final output operands. The controlling module 340 may determine a size of the filter. The size of the filter may be the number of rows and the number of columns in a kernel of the filter. The controlling module 340 may identify the tier based on one or more factors, such as the filter size, the number of PEs that are associated with the external adder assembly 330, the stride of the depthwise convolution, distribution of convolution work on the PE assembly 320, other factors, or some combination thereof. In embodiments where the PEs associated with the external adder assembly 330 are arranged in a PE column, the controlling module 340 determines the number of PEs in the PE column.

FIG. 4 illustrates a PE array 400, in accordance with various embodiments. The PE array 400 is an embodiment of the PE assembly 320 in FIG. 3. The PE array 400 includes a plurality of PEs 410 (individually referred to as “PE 410”). The PEs 410 perform MAC operations. The PEs 410 may also be referred to as neurons in the DNN. Each PE 410 has two input signals 450 and 460 and an output signal 470. The input signal 450 is at least a portion of an IFM to the layer. The input signal 460 is at least a portion of a filter of the layer. In some embodiments, the input signal 450 of a PE 410 includes one or more input operands, and the input signal 460 includes one or more weight operand.

Each PE 410 performs an MAC operation on the input signals 450 and 460 and outputs the output signal 470, which is a result of the MAC operation. Some or all of the input signals 450 and 460 and the output signal 470 may be in an integer format, such as INT8, or FP format, such as FP16 or BF16. For purpose of simplicity and illustration, the input signals and output signal of all the PEs 410 have the same reference numbers, but the PEs 410 may receive different input signals and output different output signals from each other. Also, a PE 410 may be different from another PE 410, e.g., including more, fewer, or different components.

As shown in FIG. 4, the PEs 410 are connected to each other, as indicated by the dash arrows in FIG. 4. The output signal 470 of an PE 410 may be sent to many other PEs 410 (and possibly back to itself) as input signals via the interconnections between PEs 410. In some embodiments, the output signal 470 of an PE 410 may incorporate the output signals of one or more other PEs 410 through an accumulate operation of the PE 410 and generates an internal partial sum of the PE array. More details about the PEs 410 are described below in conjunction with FIG. 4B.

In the embodiments of FIG. 4, the PEs 410 are arranged into columns 405 (individually referred to as “column 405”). The input and weights of the layer may be distributed to the PEs 410 based on the columns 405. Each column 405 has a column buffer 420. The column buffer 420 stores data provided to the PEs 410 in the column 405 for a short amount of time. The column buffer 420 may also store data output by the last PE 410 in the column 405. The output of the last PE 410 may be a sum of the MAC operations of all the PEs 410 in the column 405, which is a column-level internal partial sum of the PE array 400. In other embodiments, input and weights may be distributed to the PEs 410 based on rows in the PE array 400. The PE array 400 may include row buffers in lieu of column buffers 420. A row buffer may store input signals of the PEs in the corresponding row and may also store a row-level internal partial sum of the PE array 400.

As shown in FIG. 4, each column buffer 420 is associated with a load 430 and a drain 440. The data provided to the column 405 is transmitted to the column buffer 420 through the load 430, e.g., through upper memory hierarchies, e.g., the memory 310 in FIG. 3. The data generated by the column 405 is extracted from the column buffers 420 through the drain 440. In some embodiments, data extracted from a column buffer 420 is sent to upper memory hierarchies, e.g., the memory 310 in FIG. 3, through the drain operation. In some embodiments, the drain operation does not start until all the PEs 410 in the column 405 has finished their MAC operations. In some embodiments, the load 430 or drain 440 may be controlled by the controlling module 340. Even though not shown in FIG. 4, one or more columns 405 may be associated with an external adder assembly, e.g., the external adder assembly 330.

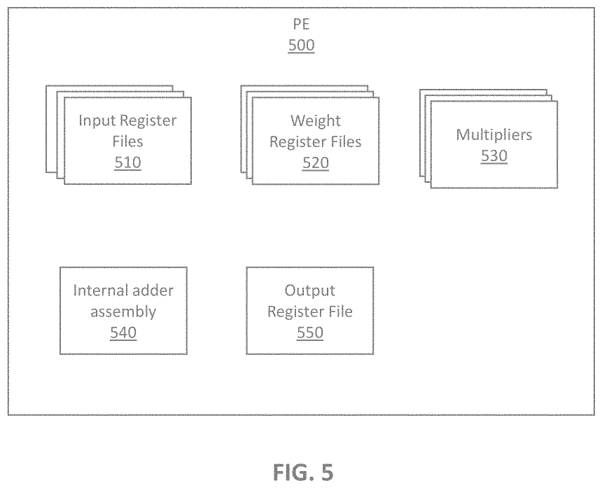

FIG. 5 is a block diagram of a PE 500, in accordance with various embodiments. The PE 500 may be an embodiment of the PE 410 in FIG. 4. The PE 500 includes input register files 510 (individually referred to as “input register file 510”), weight registers file 520 (individually referred to as “weight register file 520”), multipliers 530 (individually referred to as “multiplier 530”), an internal adder assembly 540, and an output register file 550. In other embodiments, the PE 500 may include fewer, more, or different components. For instance, the PE 500 may include multiple output register files 530.

The input register files 510 temporarily store input operands for MAC operations by the PE 500. In some embodiments, an input register file 510 may store a single input operand at a time. In other embodiments, an input register file 510 may store multiple input operand or a portion of an input operand at a time. An input operand includes a plurality of input elements in an IFM. The input elements of an input operand may be stored sequentially in the input register file 510 so the input elements can be processed sequentially. In some embodiments, each input element in the input operand may be from a different input channel of the IFM. The input operand may include an input element from each of the input channels of the IFM, and the number of input element in an input operand may equal the number of the input channels. The input elements in an input operand may have the same XY coordinates, which may be used as the XY coordinates of the input operand. For instance, all the input elements of an input operand may be X0Y0, X0Y1, X1Y1, etc.

The weight register file 520 temporarily stores weight operands for MAC operations by the PE 500. The weight operands include weights in the filters of the DNN layer. In some embodiments, the weight register file 520 may store a single weight operand at a time. other embodiments, an input register file 510 may store multiple weight operands or a portion of a weight operand at a time. A weight operand may include a plurality of weights. The weights of a weight operand may be stored sequentially in the weight register file 520 so the weight can be processed sequentially. In some embodiments, for a multiplication operation that involves a weight operand and an input operand, each weight in the weight operand may correspond to an input element of the input operand. The number of weights in the weight operand may equal the number of the input elements in the input operand.

In some embodiments, a weight register file 520 may be the same or similar as an input register file 510, e.g., having the same size, etc. The PE 500 may include a plurality of register files, some of which are designated as the input register files 510 for storing input operands, some of which are designated as the weight register files 520 for storing weight operands, and some of which are designated as the output register file 550 for storing output operands. In other embodiments, register files in the PE 500 may be designated for other purposes, e.g., for storing scale operands used in elementwise add operations, etc. The designation of the register files may be controlled by the controlling module 340.

The multipliers 530 perform multiplication operations on input operands and weight operands. A multiplier 530 may perform a sequence of multiplication operations on a single input operand and a single weight operand and generates a product operand including a sequence of products. Each multiplication operation in the sequence includes multiplying an input element in the input operand and a weight in the weight operand. In some embodiments, a position (or index) of the input element in the input operand matches the position (or index) of the weight in the weight operand. For instance, the first multiplication operation is a multiplication of the first input element in the input operand and the first weight in the weight operand, the second multiplication operation is a multiplication of the second input element in the input operand and the second weight in the weight operand, the third multiplication operation is a multiplication of the third input element in the input operand and the third weight in the weight operand, and so on. The input element and weight in the same multiplication operation may correspond to the same depthwise channel, and their product may also correspond to the same depthwise channel.

Multiple multipliers 530 may perform multiplication operations simultaneously. These multiplication operations may be referred to as a round of multiplication operations. In a round of multiplication operations by the multipliers 530, each of the multipliers 530 may use a different input operand and a different weight operand. The different input operands or weight operands may be stored in different register files of the PE 500. For instance, a first multiplier 530 uses a first input operand (e.g., stored in a first input register file 510) and a first weight operand (e.g., stored in a first weight register file 520), versus a second multiplier 530 uses a second input operand (e.g., stored in a second input register file 510) and a second weight operand (e.g., stored in a second weight register file 520), a third multiplier 530 uses a third input operand (e.g., stored in a third input register file 510) and a third weight operand (e.g., stored in a third weight register file 520), and so on. For an individual multiplier 530, the round of multiplication operations may include a plurality of cycles. A cycle includes a multiplication operation on an input element and a weight.

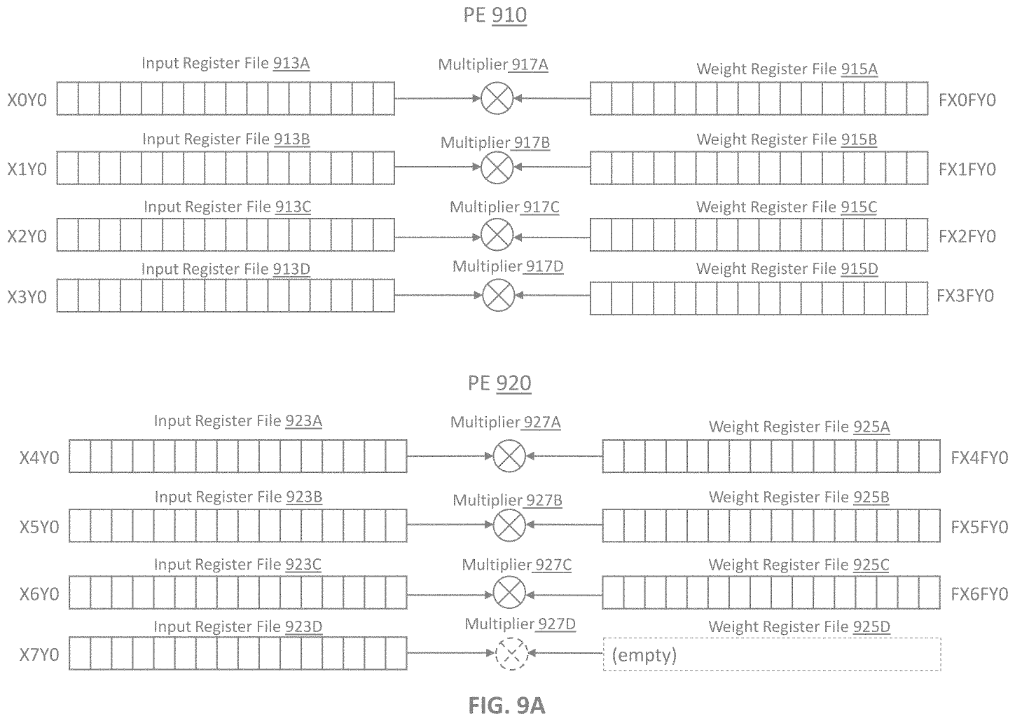

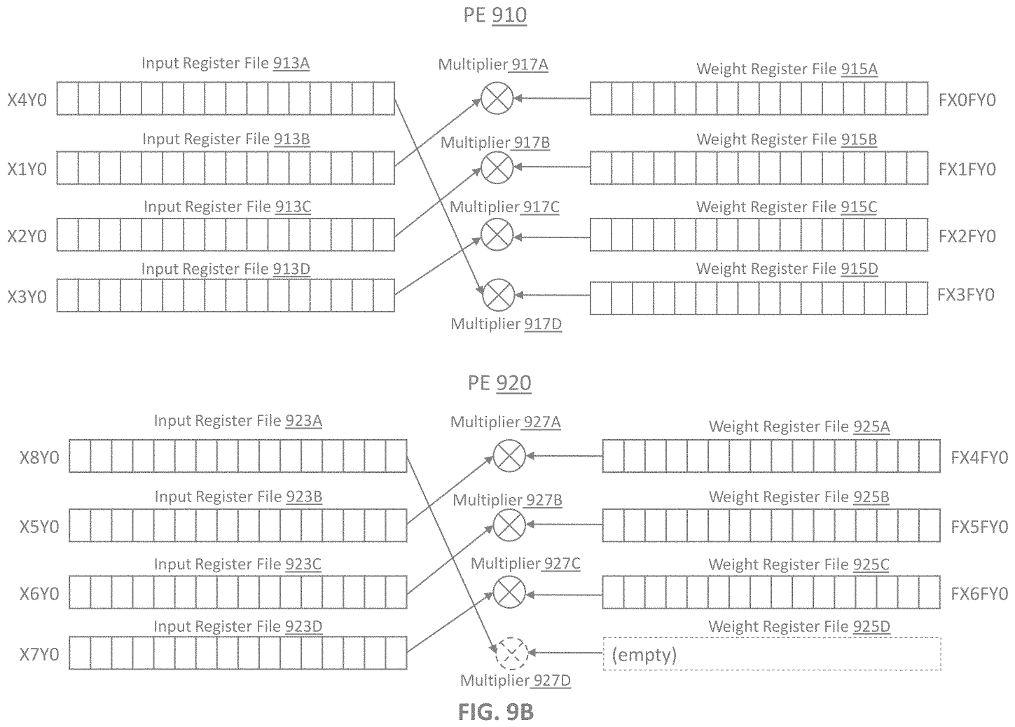

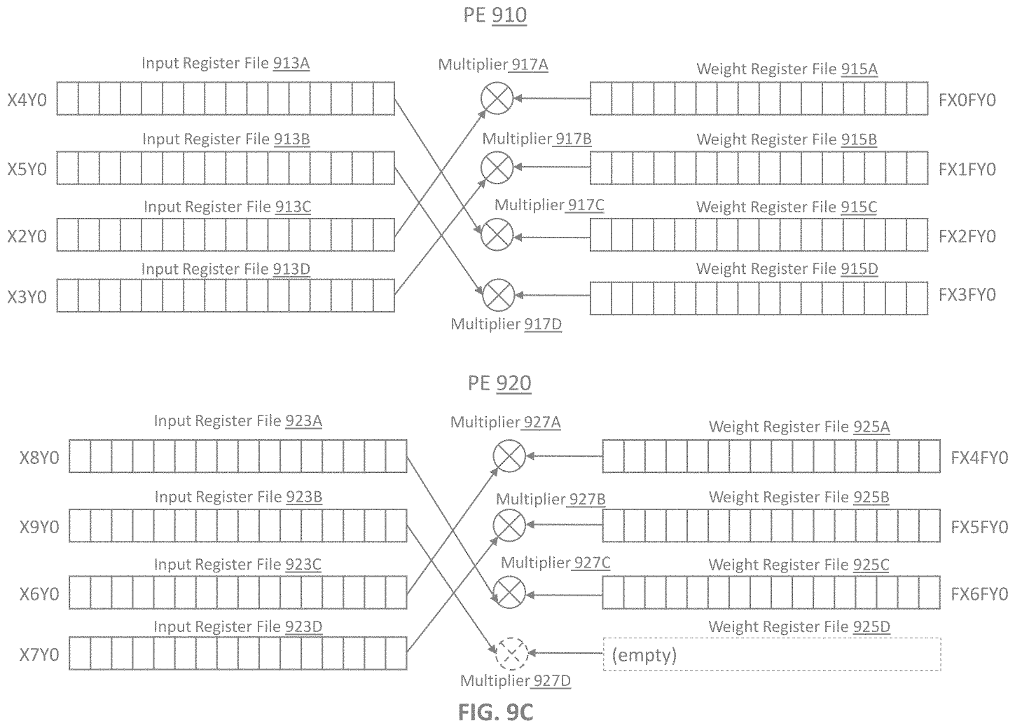

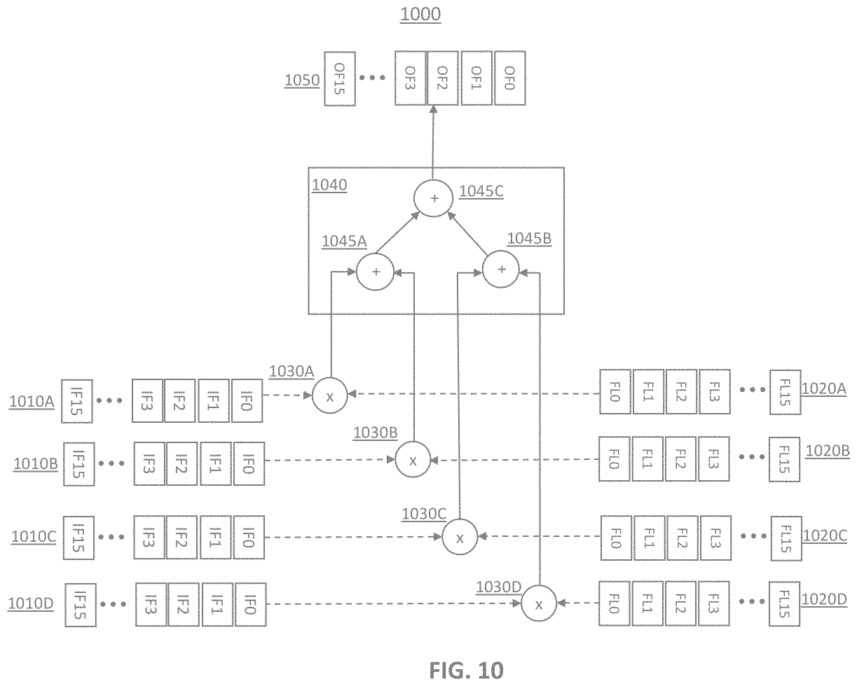

The multipliers 530 may perform multiple rounds of multiplication operations. A multiplier 530 may use the same weight operand but different input operands in different rounds. For instance, the multiplier 530 performs a sequence of multiplication operations on a first input operand stored in a first input register file in a first round, versus a second input operand stored in a second input register file in a second round. In the second round, a different multiplier 530 may use the first input operand and a different weight operand to perform another sequence of multiplication operations. That way, the first input operand is reused in the second round. The first input operand may be further reused in additional rounds, e.g., by additional multipliers 530. More details regarding reuse of input operands are provided below in conjunction with FIGS. 9A-I and FIGS. 10A-C.

The internal adder assembly 540 includes adders inside the PE 500, i.e., internal adders. The internal adder assembly 540 may perform accumulation operations on two or more products operands from multipliers 530, and produce an output operand of the PE 500. In some embodiments, the internal adders are arranged in a sequence of tiers. A tier includes one or more internal adders. For the first tier of the internal adder assembly 540, an internal adder may receive product operands from two or more multipliers 530 and generate a sum operand through a sequence of accumulation operations. Each accumulation operation produces a sum of two or more products, each of which is from a different multiplier 530. The sum operand includes a sequence of sums, each of which is a result of an accumulation operation and corresponds to a depthwise channel. For the other tier(s) of the internal adder assembly 540, an internal adder in a tier receives sum operands from the precedent tier in the sequence. Each of these number may be generated by a different internal adder in the precedent tier. A ratio of the number of internal adders in a tier to the number of internal adders in a subsequent tier may be 2:1. In some embodiments, the last tier of the internal adder assembly 540 may include a single internal adder, which produces the output operand of the PE 500. More details regarding internal adder assembly are described below in conjunction with FIG. 10.

The output register file 550 stores output operands of the PE 500. In some embodiments, the output register file 550 may store an output operand at a time. In other embodiments, the output register file 550 may store multiple output operand or a portion of an output operand at a time. An output operand includes a plurality of output elements in an IFM. The output elements of an output operand may be stored sequentially in the output register file 550 so the output elements can be processed sequentially. In some embodiments, each output element in the output operand corresponds to a different depthwise channel and is an element of a different output channel of the OFM of the depthwise convolution. The number of output element in an output operand may equal the number of the depthwise channels of the depthwise convolution.

Example Depthwise Convolution with Data Reuse

FIG. 6 illustrates an example memory layout within a PE column 600 for reusing data in a depthwise convolution, in accordance with various embodiments. The PE column 600 may be an embodiment of a PE column 405 in FIG. 4. In some embodiments, the memory layout is determined and implemented through the controlling module 340. For purpose of illustration, the PE column 600 includes 16 PEs 610A-O (collectively referred to as “PEs 610” or “PE 610”). Each PE 610 includes four input register files 620 for storing input operands and four weight register files 630 for storing weight operands. Each register file may store 16 data entries. A data entry may have a size of 1 byte. Also, the depth convolution is a 3×3s1 depth convolution and has 16 depthwise channels, 3×3 refers to a 3×3 kernel, and s1 refers to a stride of 1. There are 16 depthwise channels. In other embodiments, the PE column 600 may include a different number of PEs 610, the PEs 610 may be arranged in multiple columns, or a PE 610 may include a different number of register files. Also, the memory layout can be accommodated for depthwise convolutions having other filter sizes or strides.

In the embodiments of FIG. 6, the PEs 610A-C, 610E-G, 610I-K, and 610M-O are active, versus the PEs 610D, 610H, 610L, and 610P are inactive. An active PE 610 is loaded with input operands and weight operands and perform MAC operations of the depthwise convolution. An inactive PE 610 is not loaded with input operands and weight operands and do not perform MAC operations of the depthwise convolution. In other embodiments, a different number of PEs 610 may be active. The number of active PEs 610 may depend on the size of the kernel. For instance, all PEs 610 in the PE column 600 may be active for a depth convolution with a 4×4 kernel.

The PE column 600 can be loaded with a portion of an IFM or a whole IFM. In the embodiments of FIG. 6, as each PE 610 includes four input register files 620, the PE column 600 is loaded with input elements having four X coordinates: X0-X3, i.e., the input elements in the first four columns of each channel of the IFM. The PE column 600 includes four PE groups, each of which includes three PEs 610 (e.g., PE 610A-C is the first group, PE 610E-G is the second group, PE 610I-K is the third group, and PE 610M-O is the fourth group), Each PE group may perform a weight overlanding operation. The output of the three PEs 610 in the same PE group will be accumulated to produce a final output of the PE column. The final output includes an output element for each depthwise channel.

The data layout within the PE column 600 achieves input data reuse in the Y direction. The input elements loaded to some of the 610 have the same Y coordinate. As shown by the arrows in FIG. 6, the PE 610B and PE 610E receive the same input elements (X0-X3 and Y=1); the PE 610C, PE 610F, and PE 610I receive the same input elements (X0-X3 and Y=2); the PE 610G, PE 610J, and PE 610M receive the same input elements (X0-X3 and Y=3); and the PE 610K and PE 610N receive the same input elements (X0-X3 and Y=4).

Also, as each PE 610 includes four weight register files 630, each PE 610 can store up to four corresponding coordinates for the filter. As the kernel is 3×3, each PE 610 stores three coordinates for the filter, which are FX0-FX2. As shown in Error! Reference source not found. 6, row 0 (FY=0) of the 3×3 kernel are broadcast to the PEs 610A, 610E, 610I, and 610M. Row 1 (FY=1) of the 3×3 kernel are broadcast to the PEs 6106, 610F, 610J, and 610N. Row 2 (FY=2) of the 3×3 kernel are broadcast to the PEs 610C, 610G, 610K, and 610O. This allows each of the PEs 610 to operate on a single row of the 3×3 kernel.

Each PE 610 receives 16 depthwise channels (DC0-15) for the input elements as well as the weights. Different from depthwise convolutions performed by conventional DNN accelerators, there is no reduction in the Z direction in the embodiments of FIG. 6. Rather, the depthwise convolution in the embodiments of FIG. 6 include an intra row-wise reduction within a single PE 610 through an internal adder assembly of the PE 610 and an inter row-wise reduction across multiple PEs 610 within the column through an external adder assembly. More details regarding internal adder assembly and external adder assembly are provided below in conjunction with FIGS. 10 and 11, respectively. The input element reuse in the X direction occurs within an individual PE 610. More details regarding input element reuse in the X direction are provided below in conjunction with FIGS. 7A-1 and 9A-C.

Even though not shown in FIG. 6, the depthwise convolution may use other PEs that may be arranged in the same PE column 600 or one or more additional PE columns. The output of the PEs may be combined to generate the OFM. The memory layout shown in FIG. 6 may be for a single round of MAC operations in the depthwise convolution, such as the first round. The memory layout may change for another round of MAC operations in the depthwise convolution. For instance, some of the input register files 620 of a PE 610 may be loaded with new input operands in the subsequent round, and the new input operands may replace the input operands in the current round. The other input register files 620 of the PE 610 may store the same input operands in the subsequent round, in which these input operands will be reused for the subsequent round of MAC operations.

FIGS. 7A-I illustrate example rounds of multiplication operations in a depthwise convolution, in accordance with various embodiments. In the embodiments of FIGS. 7A-I, the depth convolution is a 3×3s1 depth convolution and has 16 depthwise channels. The depthwise convolution may be based on the memory data layout shown in FIG. 6. In other embodiments, the depth convolution may use a different kernel size, a different stride, or a different number of depthwise channels. For purpose of simplicity and illustrations, FIGS. 7A-I shows rounds of MAC operations in three PEs 710, 720, and 730, which may be an embodiment of the PEs 610A, 610B, and 610C, respectively.

FIGS. 7A-C shows a first round of MAC operations in the PEs 710, 720, and 730. As shown in FIG. 7A, the PE 710 includes four input register files 713A-D (collectively referred to as “input register files 713” or “input register file 713”), four weight register files 715A-D (collectively referred to as “weight register files 715” or “weight register file 715”), and four multipliers 717A-D (collectively referred to as “multipliers 717” or “multiplier 717”). Even though not shown in FIG. 7A, the PE 710 may include other components, such as an internal adder assembly, an output register file, etc. Also, the PE 710 may include a different number of input register files or weight register files.

In the first round, each of the input register files 713A-D is loaded with an input operand that includes 16 input elements that are arranged in a sequence. The input register file 713A stores input elements with XY coordinates of X0Y0, the input register file 713B stores input elements with XY coordinates of X1Y0, the input register file 713C stores input elements with XY coordinates of X2Y0, and the input register file 713D stores input elements with XY coordinates of X3Y0. An input element is represented by a rectangular. The 16 input elements are a portion of an IFM. Each input element corresponds to a different depthwise channel.

Each of the weight register files 715A-C is loaded with a weight operand that includes a sequence of 16 weights, each of which is represented by a rectangular. The weight register file 715A stores weights with XY coordinates of FX0FY0, the weight register file 715B stores weights with XY coordinates of FX1FY0, and the weight register file 715C stores weights with XY coordinates of FX2FY0. However, the weight register file 715D is empty, represented by a dash box. Each weight corresponds to a different depthwise channel. A weight may correspond to the same depthwise channel as an input element, and the position of the weight in the weight operand may be the same as the position of the input element in the input operand. In some embodiments, the size of an input element or weight may be 1 byte, and an input register file 713 or weight register file 715 has a storage capacity of 16 bytes or more.

The multiplier 717A receives the input operand from the input register file 713A and the weight operand from the weight register file 715A. In the first MAC round, the multiplier 717A sequentially performs 16 cycles of multiplication operations. In each cycle, the multiplier 717A multiplies an input element and a weight and generates a product. The input element and weight may correspond to the same depthwise channel. The multiplier 717A processes the input elements and weights sequentially based on their positions in the input operand and weight operand. For instance, the multiplier 717A multiples the first input element and the first weight in the first cycle, multiples the second input element and the second weight in the second cycle, and continues till it finishes the multiplication of the sixteenth input element and the sixteenth weight in the sixteenth cycle.

Similarly, the multiplier 717B receives the input operand from the input register file 713B and the weight operand from the weight register file 715B. In the first MBC round, the multiplier 717B sequentially performs 16 cycles of multiplication operations. In each cycle, the multiplier 717B multiplies an input element and a weight, which correspond to the same depthwise channel, and generates a product. The multiplier 717C receives the input operand from the input register file 713C and the weight operand from the weight register file 715C. In the first MCC round, the multiplier 717C sequentially performs 16 cycles of multiplication operations. In each cycle, the multiplier 717C multiplies an input element and a weight, which correspond to the same depthwise channel, and generates a product.

The multipliers 717A-C may operate simultaneously. In some embodiments, the cycles of multiplication operations by the multipliers 717A-C may be synchronized. For instance, the multipliers 7171A-C perform each of the 16 cycles at a same time. The multiplier 717D is inactive in this MAC round.

As shown in FIG. 7B, the PE 720 includes four input register files 723A-D (collectively referred to as “input register files 723” or “input register file 723”), four weight register files 725A-D (collectively referred to as “weight register files 725” or “weight register file 725”), and four multipliers 727A-D (collectively referred to as “multipliers 727” or “multiplier 727”). Even though not shown in FIG. 7B, the PE 720 may include other components, such as an internal adder assembly, an output register file, etc. Also, the PE 720 may include a different number of input register files or weight register files. The PE 720 may be an embodiment of the PE 610B in FIG. 6.

Each of the input register files 723A-D stores an input operand that includes 16 input elements that are arranged in a sequence. The input register file 723A stores input elements with XY coordinates of X0Y1, the input register file 723B stores input elements with XY coordinates of X1Y1, the input register file 723C stores input elements with XY coordinates of X2Y1, and the input register file 723D stores input elements with XY coordinates of X3Y1. Each of the weight register files 725A-C stores a weight operand that includes a sequence of 16 weights, each of which is represented by a rectangular. The weight register file 725A stores weights with XY coordinates of FX0FY1, the weight register file 725B stores weights with XY coordinates of FX1FY1, and the weight register file 725C stores weights with XY coordinates of FX2FY1. However, the weight register file 725D is empty, represented by a dash box. Each of the multipliers 727A-C receives the input operand from the corresponding input register file 723 and the weight operand from the corresponding weight register file 725 and performs 16 cycles of multiplication operations. The multiplier 727D is inactive in the first MAC round.

As shown in FIG. 7C, the PE 730 includes four input register files 733A-D (collectively referred to as “input register files 733” or “input register file 733”), four weight register files 735A-D (collectively referred to as “weight register files 735” or “weight register file 735”), and four multipliers 737A-D (collectively referred to as “multipliers 737” or “multiplier 737”). Even though not shown in FIG. 7B, the PE 730 may include other components, such as an internal adder assembly, an output register file, etc. Also, the PE 730 may include a different number of input register files or weight register files. The PE 730 may be an embodiment of the PE 610C in FIG. 6.

Each of the input register files 733A-D stores an input operand that includes 16 input elements that are arranged in a sequence. The input register file 733A stores input elements with XY coordinates of X0Y2, the input register file 733B stores input elements with XY coordinates of X1Y2, the input register file 733C stores input elements with XY coordinates of X2Y2, and the input register file 733D stores input elements with XY coordinates of X3Y2. Each of the weight register files 735A-C stores a weight operand that includes a sequence of 16 weights, each of which is represented by a rectangular. The weight register file 735A stores weights with XY coordinates of FX0FY2, the weight register file 735B stores weights with XY coordinates of FX1FY2, and the weight register file 735C stores weights with XY coordinates of FX2FY2. However, the weight register file 735D is empty, represented by a dash box. Each of the multipliers 737A-C receives the input operand from the corresponding input register file 733 and the weight operand from the corresponding weight register file 735 and performs 16 cycles of multiplication operations. The multiplier 737D is inactive in the first MAC round. Even though not shown in FIGS. 7A-C, the first round of MAC operations may be operated by additional PEs.

FIGS. 7D-F shows a second round of MAC operations in the PEs 710, 720, and 730. In the second round, the PEs 710, 720, and 730 are able to use some of the input elements and weights that were loaded to the register files of the PEs 710, 720, and 730 in the first round, which can avoid reloading these input elements and weights. Accordingly, the time and energy that would have been required for reloading the data are saved.

FIG. 7D shows MAC operations in the PE 710 in the second round. As shown in FIG. 7D, the input register file 713A is loaded with a new input operand X4Y0 in the second round, but the input register files 713B-D store the same input operands as the first round. Also, the weight register files 715A-C stores the same weight operands as the first round and the weight register file 715D remain empty. In the second round, each of the multipliers 717A-C performs multiplication operations with a different input operand but the same weight operand, compared with the first round. For instance, the multiplier 717A performs multiplication operations with X1Y0 and FX0FY0 in the second round, versus X0Y0 and FX0FY0 in the first round; the multiplier 717B performs multiplication operations with X2Y0 and FX0FY0 in the second round, versus X2Y0 and FX0FY0 in the first round; and the multiplier 717C performs multiplication operations with X3Y0 and FX0FY0 in the second round, versus X2Y0 and FX0FY0 in the first round. Thus, the input operands X1Y0, X2Y0, and X3Y0 are reused in the second round.

FIG. 7E shows MAC operations in the PE 720 in the second round. As shown in FIG. 7E, the input register file 723A is loaded with a new input operand X4Y1 in the second round, but the input register files 723B-D store the same input operands as the first round. Also, the weight register files 725A-C stores the same weight operands as the first round and the weight register file 725D remain empty. In the second round, each of the multipliers 727A-C performs multiplication operations with a different input operand but the same weight operand, compared with the first round. For instance, the multiplier 727A performs multiplication operations with X1Y1 and FX0FY1 in the second round, versus X0Y1 and FX0FY1 in the first round; the multiplier 727B performs multiplication operations with X2Y1 and FX0FY1 in the second round, versus X2Y1 and FX0FY1 in the first round; and the multiplier 727C performs multiplication operations with X3Y1 and FX0FY1 in the second round, versus X2Y1 and FX0FY1 in the first round. Thus, the input operands X1Y1, X2Y1, and X3Y1 are reused in the second round.

FIG. 7F shows MAC operations in the PE 730 in the second round. As shown in FIG. 7F, the input register file 733A is loaded with a new input operand X4Y2 in the second round, but the input register files 733B-D store the same input operands as the first round. Also, the weight register files 735A-C stores the same weight operands as the first round and the weight register file 735D remain empty. In the second round, each of the multipliers 737A-C performs multiplication operations with a different input operand but the same weight operand, compared with the first round. For instance, the multiplier 737A performs multiplication operations with X1Y2 and FX0FY2 in the second round, versus X0Y2 and FX0FY2 in the first round; the multiplier 737B performs multiplication operations with X2Y2 and FX0FY2 in the second round, versus X2Y2 and FX0FY2 in the first round; and the multiplier 737C performs multiplication operations with X3Y2 and FX0FY2 in the second round, versus X2Y2 and FX0FY2 in the first round. Thus, the input operands X1Y2, X2Y2, and X3Y2 are reused in the second round.

FIGS. 7G-I shows the third round of MAC operations in the PEs 710, 720, and 730. In the third round, the PEs 710, 720, and 730 are able to use some of the input elements and weights that were loaded to the register files of the PEs 710, 720, and 730 in the first round and the second round, which can avoid reloading these input elements and weights. Accordingly, the time and energy that would have been required for reloading the data are saved.

FIG. 7G shows MAC operations in the PE 710 in the third round. As shown in FIG. 7G, the input register file 713B is loaded with a new input operand X5Y0 in the second round, but the input register files 713A stores the same input operands as the second round, and the input register files 713C and 713D store the same input operands as the first round. Also, the weight register files 715A-C stores the same weight operands as the first round and the weight register file 715D remain empty. In the third round, each of the multipliers 717A-C performs multiplication operations with a different input operand but the same weight operand, compared with the second round. For instance, the multiplier 717A performs multiplication operations with X2Y0 and FX0FY0 in the second round, the multiplier 717B performs multiplication operations with X3Y0 and FX0FY0, and the multiplier 717C performs multiplication operations with X4Y0 and FX0FY0. The input operands X2Y0 and X3Y0 are reused again in the third round.

FIG. 7H shows MAC operations in the PE 720 in the third round. As shown in FIG. 7H, the input register file 723B is loaded with a new input operand X5Y1 in the second round, but the input register files 723A stores the same input operands as the second round, and the input register files 723C and 723D store the same input operands as the first round. Also, the weight register files 725A-C stores the same weight operands as the first round and the weight register file 725D remain empty. In the third round, each of the multipliers 727A-C performs multiplication operations with a different input operand but the same weight operand, compared with the second round. For instance, the multiplier 727A performs multiplication operations with X2Y1 and FX0FY1 in the second round, the multiplier 727B performs multiplication operations with X3Y1 and FX0FY1, and the multiplier 727C performs multiplication operations with X4Y1 and FX0FY1. The input operands X2Y1 and X3Y1 are reused again in the third round.

FIG. 7I shows MAC operations in the PE 730 in the third round. As shown in FIG. 7I, the input register file 733B is loaded with a new input operand X5Y2 in the second round, but the input register files 733A stores the same input operands as the second round, and the input register files 733C and 733D store the same input operands as the first round. Also, the weight register files 735A-C stores the same weight operands as the first round and the weight register file 735D remain empty. In the third round, each of the multipliers 737A-C performs multiplication operations with a different input operand but the same weight operand, compared with the second round. For instance, the multiplier 737A performs multiplication operations with X2Y2 and FX0FY2 in the second round, the multiplier 737B performs multiplication operations with X3Y2 and FX0FY2, and the multiplier 737C performs multiplication operations with X4Y2 and FX0FY2. The input operands X2Y2 and X3Y2 are reused again in the third round. Even though not shown in FIGS. 7A-7I, the depth convolution may include additional rounds, where input elements and weights can be further reused.

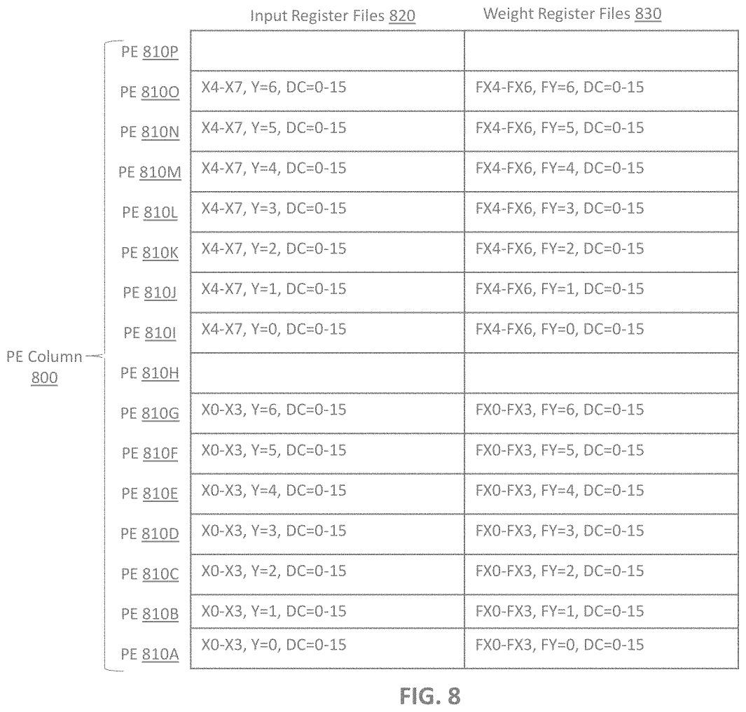

FIG. 8 illustrates another example memory layout within a PE column 800 for reusing data in a depthwise convolution, in accordance with various embodiments. The PE column 800 may be an embodiment of a PE column 405 in FIG. 4. In some embodiments, the memory layout is determined and implemented through the controlling module 340. Different from the depth convolution described in conjunction with FIGS. 6 and 7A-1, the depth convolution in the embodiments of FIG. 8 is a 7×7s1 depth convolution, 7×7 refers to a 7×7 kernel, and s1 refers to a stride of 1. Similar to the PE column 600, the PE column 800 includes 16 PEs 810A-O (collectively referred to as “PEs 810” or “PE 810”). Each PE 810 includes four input register files 820 for storing input operands and four weight register files 830 for storing weight operands. Each register file may store 16 data entries. A data entry may have a size of 1 byte. In other embodiments, the PE column 800 may include a different number of PEs 810, the PEs 810 may be arranged in multiple columns, or a PE 810 may include a different number of register files.

In the embodiments of FIG. 8, the PEs 810A-G and 810I-O are active (meaning these PEs 810 are loaded with input operands and weight operands and perform MAC operations of the depthwise convolution), versus the PEs 810H and 810P are inactive (meaning these PEs 810 are not loaded with input operands and weight operands and do not perform MAC operations of the depthwise convolution). In other embodiments, a different number of PEs 810 may be active. The number of active PEs 810 may depend on the size of the kernel. For instance, all PEs 810 in the PE column 800 may be active for a depth convolution with a 4×4, 8×8, or other kernels.

The active PEs 810 in the PE column 800 can be loaded with a portion of an IFM or a whole IFM. As each PE 810 includes four input register files 820, the PE column 800 is loaded with input elements having four X coordinates: X0-X3, i.e., the input elements in the first four columns of each channel of the IFM. Given that the kernel size is 7 in the embodiments of FIG. 8, the data layout within the PE column 800 does not implement input data reuse in the Y direction. As shown in FIG. 8, the PEs 810 are loaded with different input elements. The output of all the active PEs 810 will be accumulated to produce a final output of the PE column. The final output includes an output element for each depthwise channel.

Also, as each PE 810 includes four weight register files 830, each PE 810 can store up to four corresponding coordinates for the filter. As shown in FIG. 8, the weight register files 830 of each of the PEs 810A-G store four X coordinates for the filter (i.e., FX0-FX3), versus the weight register files 830 of each of the PEs 810I-O store one X coordinate for the filter (i.e., FX4). As shown in Error! Reference source not found. 8, row 0 (FY=0) of the 7×7 kernel are broadcast to the PEs 810A and 810I, row 1 (FY=1) of the 7×7 kernel are broadcast to the PEs 810B and 810J, row 2 (FY=2) of the 7×7 kernel are broadcast to the PEs 810C and 810K, row 3 (FY=3) of the 7×7 kernel are broadcast to the PEs 810D and 810L, row 4 (FY=4) of the 7×7 kernel are broadcast to the PEs 810E and 810M, row 5 (FY=5) of the 7×7 kernel are broadcast to the PEs 810F and 810N, and row 6 (FY=6) of the 7×7 kernel are broadcast to the PEs 810G and 810O. This allows each of the PEs 810 to operate on a single row of the 7×7 kernel.

Each active PE 810 receives 16 depthwise channels (DC0-15) for the input elements as well as the weights. Different from depthwise convolutions performed by conventional DNN accelerators, there is no reduction in the Z direction in the embodiments of FIG. 8. Rather, the depthwise convolution in the embodiments of FIG. 8 include an intra row-wise reduction within a single PE 810 through an internal adder assembly of the PE 810 and an inter row-wise reduction across multiple PEs 810 within the column through an external adder assembly. More details regarding internal adder assembly and external adder assembly are provided below in conjunction with FIGS. 10 and 11, respectively. The input element reuse in the X direction occurs within an individual PE 810. More details regarding input element reuse in the X direction are provided below in conjunction with FIGS. 9A-C.

Even though not shown in FIG. 8, the depthwise convolution may use other PEs that may be arranged in the same PE column 800 or one or more additional PE columns. The output of the PEs may be combined to generate the OFM. The memory layout shown in FIG. 8 may be for a single round of MAC operations in the depthwise convolution, such as the first round. The memory layout may change for another round of MAC operations in the depthwise convolution. For instance, some of the input register files 820 of a PE 810 may be loaded with new input operands in the subsequent round, and the new input operands may replace the input operands in the current round. The other input register files 820 of the PE 810 may store the same input operands in the subsequent round, in which these input operands will be reused for the subsequent round of MAC operations.

FIGS. 9A-C illustrate other example rounds of multiplication operations in a depthwise convolution, in accordance with various embodiments. In the embodiments of FIGS. 9A-C, the depth convolution is a 7×7s1 depth convolution. The depthwise convolution may be based on the memory data layout shown in FIG. 8. In other embodiments, the depth convolution may use a different kernel size, a different stride, or a different number of depthwise channels. For purpose of simplicity and illustrations, FIGS. 9A-C shows three rounds of MAC operations in two PEs 910 and 920, which may be an embodiment of the PEs 810A and 810I, respectively.

FIG. 9A shows the first round of MAC operations in the PEs 910 and 920. As shown in FIG. 9A, the PE 910 includes four input register files 913A-D (collectively referred to as “input register files 913” or “input register file 913”), four weight register files 915A-D (collectively referred to as “weight register files 915” or “weight register file 915”), and four multipliers 917A-D (collectively referred to as “multipliers 917” or “multiplier 917”). Even though not shown in FIG. 9A, the PE 910 may include other components, such as an internal adder assembly, an output register file, etc. Also, the PE 910 may include a different number of input register files or weight register files.

In the PE 910, each of the input register files 913A-D is loaded with an input operand that includes 16 input elements that are arranged in a sequence. The input register file 913A stores input elements with XY coordinates of X0Y0, the input register file 913B stores input elements with XY coordinates of X1Y0, the input register file 913C stores input elements with XY coordinates of X2Y0, and the input register file 913D stores input elements with XY coordinates of X3Y0. An input element is represented by a rectangular. The 16 input elements are a portion of an IFM. Each input element corresponds to a different depthwise channel.

Each of the weight register files 915A-D is loaded with a weight operand that includes a sequence of 16 weights, each of which is represented by a rectangular. The weight register file 915A stores weights with XY coordinates of FX0FY0, the weight register file 915B stores weights with XY coordinates of FX1FY0, the weight register file 915C stores weights with XY coordinates of FX2FY0, and the weight register file 915D stores weights with XY coordinates of FX3FY0. Each weight corresponds to a different depthwise channel. A weight may correspond to the same depthwise channel as an input element, and the position of the weight in the weight operand may be the same as the position of the input element in the input operand. In some embodiments, the size of an input element or weight may be 1 byte, and an input register file 610 or weight register file 620 has a storage capacity of 16 bytes or more.

The multiplier 917A receives the input operand X0Y0 from the input register file 913A and the weight operand FX0FY0 from the weight register file 915A. In the first MAC round, the multiplier 917A sequentially performs 16 cycles of multiplication operations. In each cycle, the multiplier 917A multiplies an input element and a weight and generates a product. The input element and weight may correspond to the same depthwise channel. Similarly, the multiplier 917B performs 16 cycles of multiplication operations based on the input operand X1Y0 from the input register file 913B and the weight operand FX1FY0 from the weight register file 915B, the multiplier 917C performs 16 cycles of multiplication operations based on the input operand X2Y0 from the input register file 913C and the weight operand FX2Y0 from the weight register file 915C, and the multiplier 917D performs 16 cycles of multiplication operations based on the input operand X3Y0 from the input register file 913D and the weight operand FX3Y0 from the weight register file 915D.

In the PE 920, each of the input register files 923A-D is loaded with an input operand that includes 16 input elements that are arranged in a sequence. The input register file 923A stores input elements with XY coordinates of X4Y0, the input register file 923B stores input elements with XY coordinates of X5Y0, the input register file 923C stores input elements with XY coordinates of X6Y0, and the input register file 923D stores input elements with XY coordinates of X7Y0. An input element is represented by a rectangular. The 16 input elements are a portion of an IFM. Each input element corresponds to a different depthwise channel.

Each of the weight register files 925A-C is loaded with a weight operand that includes a sequence of 16 weights, each of which is represented by a rectangular. The weight register file 925A stores weights with XY coordinates of FX4FY0, the weight register file 925B stores weights with XY coordinates of FX5FY0, and the weight register file 925C stores weights with XY coordinates of FX6FY0. The weight register file 925D is empty. Each weight corresponds to a different depthwise channel. A weight may correspond to the same depthwise channel as an input element, and the position of the weight in the weight operand may be the same as the position of the input element in the input operand.

In the first MAC round, the multiplier 927A performs 16 cycles of multiplication operations based on the input operand X4Y0 from the input register file 923A and the weight operand FX4FY0 from the weight register file 925A, the multiplier 927B performs 16 cycles of multiplication operations based on the input operand X5Y0 from the input register file 923B and the weight operand FX5FY0 from the weight register file 925B, and the multiplier 927C performs 16 cycles of multiplication operations based on the input operand X6Y0 from the input register file 923C and the weight operand FX6Y0 from the weight register file 925C. The multiplier 927D is inactive.

FIG. 9B shows the second round of MAC operations in the PEs 910 and 920. In the PE 910, the input register file 913A is loaded with a new input operand X4Y0, but the input operands in the other input register files 913B-D are not changed. Also, the weight operands in the weight register files 915 are not changed. Each of the multipliers 917 uses the same weight operand but a different input operand to perform multiplication operations in the second round, compared with the first round.

As shown in FIG. 9B, the multiplier 917A performs multiplication operations based on the input operand X1Y0 from the input register file 913B and the weight operand FX0FY0 from the weight register file 915A, the multiplier 917B performs multiplication operations based on the input operand X2Y0 from the input register file 913C and the weight operand FX1FY0 from the weight register file 915B, the multiplier 917C performs multiplication operations based on the input operand X3Y0 from the input register file 913D and the weight operand FX2Y0 from the weight register file 915C, and the multiplier 917D performs multiplication operations based on the input operand X4Y0 from the input register file 913A and the weight operand FX3Y0 from the weight register file 915D. Thus, the input operands X1Y0, X2Y0, and X3Y0 and all the weight operands are reused in the second round.

In the PE 920, the input register file 923A is loaded with a new input operand X8Y0, but the input operands in the other input register files 923B-D are not changed. Also, the weight operands in the weight register files 925 are not changed. Each of the multipliers 927 uses the same weight operand but a different input operand to perform multiplication operations in the second round, compared with the first round. As shown in FIG. 9B, the multiplier 927A performs multiplication operations based on the input operand X5Y0 from the input register file 923B and the weight operand FX4FY0 from the weight register file 925A, the multiplier 927B performs multiplication operations based on the input operand X6Y0 from the input register file 923C and the weight operand FX5FY0 from the weight register file 925B, and the multiplier 927C performs multiplication operations based on the input operand X7Y0 from the input register file 923D and the weight operand FX6Y0 from the weight register file 925C. The multiplier 927D remains inactive. Thus, the input operands X5Y0, X6Y0, and X7Y0 and all the weight operands are reused in the second round.

FIG. 9C shows the third round of MAC operations in the PEs 910 and 920. In the PE 910, the input register file 913B is loaded with a new input operand X5Y0, but the input operands in the other input register files 913 are not changed from the second round. Also, the weight operands in the weight register files 915 are not changed. Each of the multipliers 917 uses the same weight operand but a different input operand to perform multiplication operations, compared with the first or second round. The multiplier 917A performs multiplication operations based on the input operand X2Y0 from the input register file 913C and the weight operand FX0FY0 from the weight register file 915A, the multiplier 917B performs multiplication operations based on the input operand X3Y0 from the input register file 913D and the weight operand FX1FY0 from the weight register file 915B, the multiplier 917C performs multiplication operations based on the input operand X4Y0 from the input register file 913A and the weight operand FX2Y0 from the weight register file 915C, and the multiplier 917D performs multiplication operations based on the input operand X5Y0 from the input register file 913B and the weight operand FX3Y0 from the weight register file 915D. Thus, the input operands X4Y0, X2Y0, and X3Y0 and all the weight operands are reused, and the input operands X2Y0 and X3Y0 and all the weight operands are reused twice.

In the PE 920, the input register file 923B is loaded with a new input operand X9Y0, but the input operands in the other input register files 923 are not changed. Also, the weight operands in the weight register files 925 are not changed. Each of the multipliers 927 uses the same weight operand but a different input operand to perform multiplication operations, compared with the first or second round. The multiplier 927A performs multiplication operations based on the input operand X6Y0 from the input register file 923C and the weight operand FX4FY0 from the weight register file 925A, the multiplier 927B performs multiplication operations based on the input operand X7Y0 from the input register file 923D and the weight operand FX5FY0 from the weight register file 925B, and the multiplier 927C performs multiplication operations based on the input operand X8Y0 from the input register file 923A and the weight operand FX6Y0 from the weight register file 925C. The multiplier 927D remains inactive. Thus, the input operands X8Y0, X6Y0, and X7Y0 and all the weight operands are reused. Particularly, the input operands X6Y0 and X7Y0 and all the weight operands are reused twice.

FIGS. 7A-7I and FIG. 9A0C shows multiplication operations by multipliers in PEs. As mentioned above, a depth convolution also includes an intra row-wise reduction within a single PE through an internal adder assembly of the PE.

FIG. 10 illustrates an example internal adder assembly 1040 in a PE 1000, in accordance with various embodiments. The PE 1000 may be an embodiment of the PE 500 in FIG. 5. For purpose of illustration, the PE 1000 includes four input register files 1010 (collectively referred to as “input register files 1010” or “input register file 1010”), four weight register files 1020 (collectively referred to as “weight register files 1020” or “weight register file 1020”), four multipliers 1030A-D (collectively referred to as “multipliers 1030” or “multiplier 1030”), an internal adder assembly 1040 that includes three internal adders 1045A-C collectively referred to as “internal adders 1045” or “internal adder 1045”), and an output register file 1050. In other embodiments, the PE 1000 may include a different number of input register files 1010, weight register files 1020, multipliers 1030, internal adders 1045, or output register file 1050.

In the embodiments of FIG. 10, each input register file 1010 stores an input operand that includes 16 input elements, IF0-IF15, for 16 depthwise channels. Each weight register file 1020 stores a weight operand that includes 16 weights, FL0-FL15. Each multiplier 1030 receives an input operand from an input register file 1010 and a weight from a weight register file 1020. The multiplier 1030 performs 16 cycles of multiplication operations. In each cycle, the multiplier 1030 multiplies an input element and a weight and generates a product. The multiplier 1030 processes the input elements and weights sequentially based on their positions in the input operand and weight operand. For instance, the multiplier 1030 multiples IF0 and FL0 in the first cycle, multiples IF1 and FL1 in the second cycle, and continues till it finishes the multiplication of IF15 and FL15 in the sixteenth cycle. The multipliers 1030 may operate simultaneously. In the embodiments of FIG. 10, all the input register files 1010 and all the weight register files 1020 store data and all the multipliers 1030 are active. In other embodiments, one or more of the input register files 1010 or of the weight register files 1020 may be empty, and one or more of the multipliers 1030 may be inactive.

The products generated by the multipliers 1030 are fed into the internal adder assembly 1040. The internal adder assembly 1040 performs an intra row-wise reduction. As shown in FIG. 10, the internal adders 1045 are arranged into two tiers in the internal adder assembly 1040, where the internal adders 1045A and 1045B are in the first tier, and the internal adder 1045C is in the second tier. The internal adder 1045A receives products from the multipliers 1030A and 1030B and performs accumulation operations on these products. In some embodiments, the internal adder 1045A performs 16 cycles of accumulation operation, each of which corresponds to a different depthwise channel and is an accumulation of products for the corresponding depthwise channel. For instance, in the first cycle, the internal adder 1045A accumulates the product of IF0 times FL0 from the multiplier 1030A and the product of IF0 times FL0 from the multiplier 1030B. In the second cycle of accumulation operation, the internal adder 1045A accumulates the product of IF1 times FL1 from the multiplier 1030A and the product of IF1 times FL1 from the multiplier 1030B, and so on. Similarly, the internal adder 1045B receives products from the multipliers 1030C and 1030D and may perform 16 cycles of accumulation operation on these products. The internal adders 1045A and 1045B may operate simultaneously. The internal adder assembly 1040 may perform an intra row-wise reduction within the PE 1000 during the depthwise convolution.

The sums generated by the internal adders 1045A and 1045B are fed to the internal adder 1045C. In some embodiments, the internal adder 1045C performs 16 cycles of accumulation operation, each of which corresponds to a different depthwise channel and is an accumulation of sums, which are the internal adders 1045A and 1045B, for the corresponding depthwise channel. The internal adder 1045C outputs an output operand that is stored in the output register file 1050 of the PE 1000. The output operand includes 16 output elements OF0-OF16. The output operand may be a portion of an OFM of the depthwise convolution. Each output element may correspond to a different depthwise channel.

Through the accumulation operations by the internal adders 1045A-C, the internal adder assembly 1040 performs a reduction within a row of the kernel, i.e., intra row-wise reduction. In an example where the depthwise convolution is 3×3s1 (e.g., the depthwise convolution described above in conjunction with FIGS. 6 and 7A-I), the internal PE adder assembly 1040 can perform a reduction of 3 points within a row of the 3×3 kernel and generates a sum that equals X0Y0×FX0FY0+X1Y0×FX1FY0+X2Y0×FX2FY0 for each of the 16 depthwise channels.

In some embodiments, the size of an output element may be 1 byte, and the output register file 1050 has a storage capacity of 16 bytes or more. As the output register file 1050 can store 16 output elements at a time, the PE 1000 can receive the 16 depthwise channels to compute and store 16 output elements without having to perform any reduction in the Z direction. This is more advantageous than conventional DNN accelerators, which processes a single output element at a time within a single PE while consuming all the input channels associated with the generation of that output element by distributing the input channels across multiple multipliers. Such DNN accelerators may operate well for standard convolutions, but are inefficient for depthwise convolutions, as the number of input channels in depthwise convolution that needs to be accumulated is 1 (depthwise convolution does not include accumulation across multiple input channels) and hence usually just 1 of the multipliers are active at a time.

In addition to the more efficient depthwise convolution, the PE 1000 can also perform standard convolutions. For instance, one or more of the internal adders 1045 may perform an accumulation across the 16 channels and generate a single output point. In some embodiments, the PE 1000 may have a depthwise convolution mode and a standard convolution mode. The PE 1000 performs depthwise convolutions when it is in the depthwise convolution mode and performs standard convolutions when it is in the standard convolution mode.

In addition to the intra row-wise reduction, a depthwise convolution may also include inter row-wise reduction across PEs within a PE column. As mentioned above, such inter row-wise reduction may be performed by using an external adder assembly.

FIG. 11 illustrates an external adder assembly 1100 coupled to a PE column 1105, in accordance with various embodiments. The external adder assembly 1100 generates final outputs of the PE column 1105. For purpose of illustration, the PE column 1105 includes 16 PEs 1110A-P (collectively referred to as “PEs 1110” or “PE 1110”) that are arranged in a column. In other embodiments, the PE column 1105 may include a different number of PEs 1110, which may be arranged in a different number of columns.

The external adder assembly 1100 includes 15 external adders 1120A-O (collectively referred to as “external adders 1120” or “external adder 1120”) that are external to the PEs 1110. The external adders 1120 are arranged in four tiers 1130A-D (collectively referred to as “tiers 1130” or “tier 1130”). The first tier 1130A includes the external adders 1120A-H, the second tier 1130B includes the external adders 11201-L, the third tier 1130C includes the external adders 1120M and 1120N, and the fourth tier includes the external adder 11200. As shown in FIG. 11, each external adder 1120 in the first tier 1130A is associated with two PEs 1110 in the PE column 1105. The external adder 1120 receives outputs of the two PEs 1110 and produce a sum of the PE outputs. In the other tiers 1130B-D, each external adder 1120 is associated with two external adders 1120 in the previous tier. The external adder 1120 receives outputs of the two external adders 1120 and produce a sum of the external adder outputs.

The external adder assembly 1100 may have a depthwise convolution mode and a standard convolution mode. The external adder assembly 1100 performs accumulations for depthwise convolutions when it is in the depthwise convolution mode and performs accumulations for standard convolutions when it is in the standard convolution mode. In the depthwise convolution mode, an external adder 1120 in the first tier 1130A may receive two output operands from two PEs 1110 as a first input operand and a second input operand of the external adder 1120. The external adder 1120 may perform a sequence of accumulations, each of which generates a sum of an element in the first input operand and an element in the second input operand. The two elements may correspond to the same depthwise channel. The result of the sequence of accumulations is an output operand of the external adder 1120. An external adder 1120 in one of the other tiers 1130B-D may receive two output operands from two external adders 1120 in the previous tier as a first input operand and a second input operand of the external adder 1120. The external adder 1120 may perform a sequence of accumulations, each of which generates a sum of an element in the first input operand and an element in the second input operand. The two elements may correspond to the same depthwise channel. The result of the sequence of accumulations is an output operand of the external adder 1120. In some embodiments, one or more PEs may be inactive, and the input of an inactive PE to the external adder assembly 1100 may be 0.

The final outputs of the PE column 1105 may be available in any of the tiers 1130, depending on the kernel size of the depthwise convolution. In an example where the kernel size is 2×2, the external adder assembly 700 may perform an inter row-wise reduction among two PEs 1110 that hold the partial sums of row0-1 of the 2×2 kernel to produce the final outputs, and the final outputs of the PE column 1105 is available in the first tier 1130A. In an example where the kernel size is 3×3 or 4×4, the external adder assembly 700 may perform an inter row-wise reduction among three or four PEs 1110 that hold the partial sums of row0-2 of the 3×3 kernel or row0-3 of the 4×4 kernel to produce the final outputs, and the final outputs of the PE column 1105 is available in the second tier 1130B. Similarly, the final outputs of the PE column 1105 is available in the third tier 1130C in an example where the kernel size is 5×5 or 6×6, and the final outputs of the PE column 1105 is available in the fourth tier 1130D in an example where the kernel size is 7×7 or 8×8. In some embodiments, a tier 1130 that is subsequent to the tier 1130 where the final outputs are available may be inactive, and the external adder(s) 1120 in the subsequent tier may not perform accumulation operations. For instance, in embodiments where the final outputs are available from the external adders 11201-L in the second tier 1130B, the externals adders 1120M-O in the third tier 1130C and the fourth tier 1130D can be inactive and not perform any accumulations.

FIGS. 6, 7A-I, 8, and 9A-C illustrate example depthwise convolutions of integers. The DNN accelerator in the present disclosure can also be used for FP depthwise convolutions.

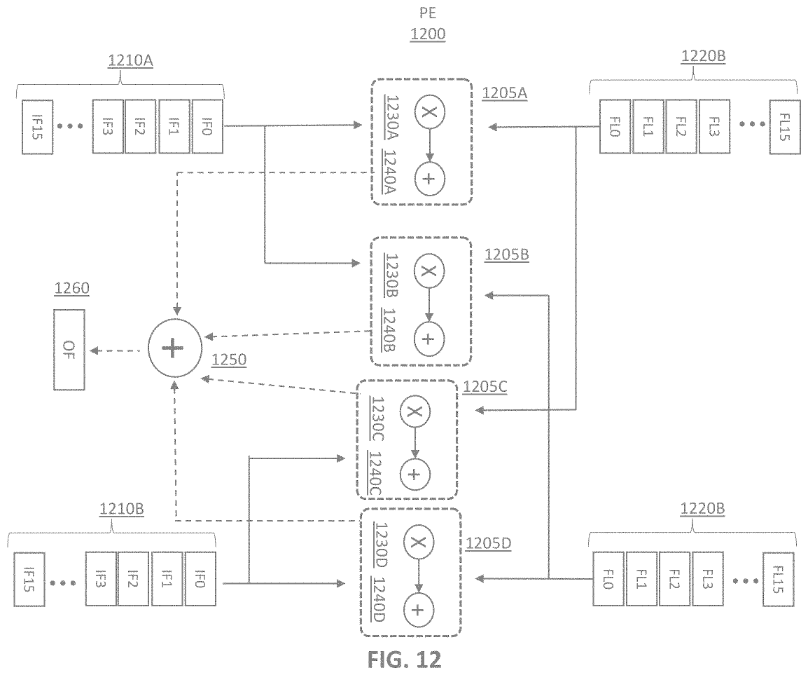

FIG. 12 illustrates FPMAC operations within a PE 1200, in accordance with various embodiments. FIG. 12 shows an example matrix-matrix FPMAC operation by the PE 1200. The PE 1200 may also perform vector-vector FPMAC or vector-matrix FPMAC. The PE 1200 includes two input register files 1210A and 1210B (collectively referred to as “input register files 1210” or “input register file 1210”), two weight register files 1220A and 1220B (collectively referred to as “weight register files 1220” or “weight register file 1220”), four FPMAC units 1205A-D (collectively referred to as “FPMAC units 1205” or “FPMAC unit 1205”), four multipliers 1230A-D (collectively referred to as “multipliers 1230” or “multipliers 1230”), four accumulators 1240A-D (collectively referred to as “accumulators 1240” or “accumulators 1240”), an FP adder 1250, and an output register file 1260. Each FPMAC unit 1205 includes a multiplier 1230 and an accumulator 1240. In some embodiments, the PE 1200 may include more, fewer, or different components. For instance, the PE 1200 may include a different number of input register file, weight register file, or output register file.

The input register file 1210A stores an input operand IF0-IF15. The input register file 1210B stores another input operand IF0-IF15. The weight register file 1220A stores a weight operand FL0-FL15. The weight register file 1220B stores another weight operand FL0-FL15.

In the embodiments of FIG. 12, each operand is considered as a vector. FIG. 12 shows a matrix-matrix FPMAC operation based on the four operands. It may be considered that the two input operands constitute an input matrix, and the two weight operands constitute a weight matrix. The matrix-matrix FPMAC operation includes four vector-vector FPMAC operations. Each pair of a multiplier 1230 and an accumulator 1240 performs one of the four vector-vector FPMAC operations.

As shown in FIG. 12, the input operand in the input register file 1210A and the weight operand in the weight register file 1220A are fed into the FPMAC unit 1205A. The multiplier 1230A performs a series of multiplications, each of which is a multiplication of an IF with an FL. The accumulator 1240A performs an accumulation of the results of the multiplications and generates a first sum. Similarly, the input operand in the input register file 1210A and the weight operand in the weight register file 1220B are fed into the FPMAC unit 1205B. The multiplier 1230B performs a series of multiplications, then the accumulator 1240B performs an accumulation of the results of the multiplications and generates a second sum. Also, the input operand in the input register file 1210B and the weight operand in the weight register file 1220A are fed into the FPMAC unit 1205C. The multiplier 1230C performs a series of multiplications, then the accumulator 1240C performs an accumulation of the results of the multiplications and generates a third sum. Further, the input operand in the input register file 1210B and the weight operand in the weight register file 1220B are fed into the FPMAC unit 1205D. The multiplier 1230D performs a series of multiplications, then the accumulator 1240D performs an accumulation of the results of the multiplications and generates a fourth sum.

The four sums are fed into the FP adder 1250. The FP adder 1250 accumulates the four sums and generates a total sum of the matrix-matrix FPMAC operation. In other embodiments, the addition of the four sums may be performed by an accumulator 1240 in one of the FPMAC units 1205. The total sum is stored in the output register file 1260.

In some embodiments, the multipliers 1230 perform multiplication based on FP16 or BF16 format. The accumulators 1240 and FP adder 1250 perform accumulations based on FP32 format. In some embodiments, the FP adder 750 may be one of the accumulators 1240.

Each matrix in FIG. 12 includes two vectors. In other embodiments, a matrix in a matrix-matrix FPMAC operation may include more vectors, such as three, four, five, and so on. Even though not show in FIG. 7 or FIG. 12, a PE including multiple FPMAC units can be used to perform vector-matrix or matrix-vector FPMAC operations. For instance, a first pair of multiplier and accumulation unit can perform an FPMAC operation based on a first input operand and a weight operand, and a second pair of multiplier and accumulation unit can perform an FPMAC operation based on a second input operand and a weight operand. As another example, a first pair of multiplier and accumulation unit can perform an FPMAC operation based on an input operand and a first weight operand, and a second pair of multiplier and accumulation unit can perform an FPMAC operation based on the input operand and a second weight operand

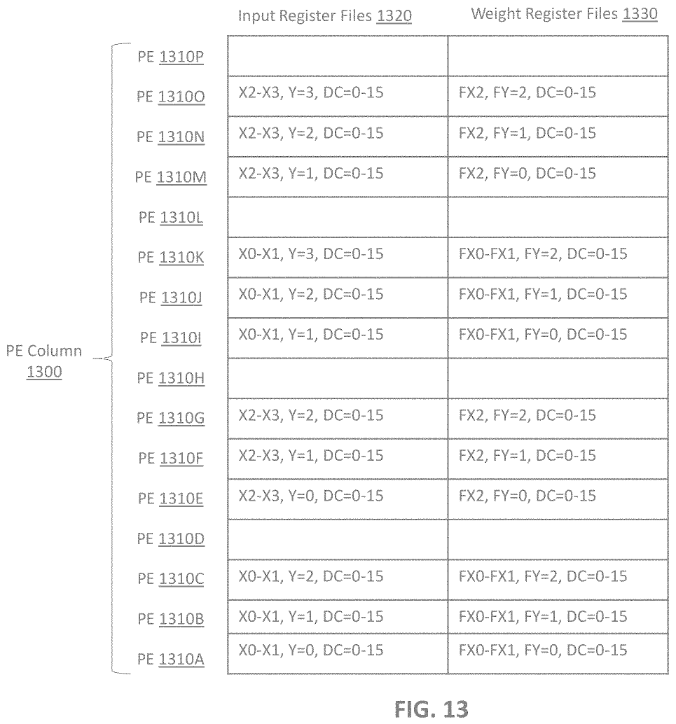

FIG. 13 illustrates an example memory layout within a PE column 1300 for reusing data in a FP depthwise convolution, in accordance with various embodiments. The PE column 1300 may be an embodiment of a PE column 405 in FIG. 4. In some embodiments, the memory layout is determined and implemented through the controlling module 340. Similar to the embodiment of FIG. 6, FIG. 13 shows a PE column 1300 including 16 PEs 1310A-O (collectively referred to as “PEs 1310” or “PE 1310”). The PEs 1310A-C, 1310E-G, 1310I-K, and 1310M-O are active, versus the PEs 1310D, 1310H, 1310L, and 1310P are inactive. Each PE 1310 includes four input register files 1320 for storing input operands and four weight register files 1330 for storing weight operands. Each register file may store 16 data entries. A data entry may have a size of 1 byte. Also, the depth convolution is a 3×3s1 depth convolution and has 16 depthwise channels, 3×3 refers to a 3×3 kernel, and s1 refers to a stride of 1. In other embodiments, the PE column 1300 may include a different number of PEs 1310, the PEs 1310 may be arranged in multiple columns, or a PE 1310 may include a different number of register files. Also, the memory layout can be accommodated for depthwise convolutions having other filter sizes or strides.

In the embodiments of FIG. 13, a register file of a PE 1310 may store up to 8 data entries, which is half of the number of data entries that a register file in FIG. 6 can store. That is because the depth convolution in FIG. 13 is for FP numbers (e.g., having FP format of FP16 or BF 16), versus the depth convolution in FIG. 6 is for integers (e.g., having data format of INT8). Accordingly, each active PE 1310 is loaded with input elements having two X coordinates: X0-X1. Also, each active PE 1310 is loaded with weights having one or two X coordinates: FX0-FX1 or FX2. The output of the six PEs 610 (e.g., PEs 1310A-C and 1310E-G, or PEs 1310I-K and 1310M-N) will be accumulated to produce a final output of the PE column. The final output includes an output element for each depthwise channel.

The data layout within the PE column 1300 achieves input data reuse in the Y direction. The input elements loaded to some of the 1310 have the same Y coordinate. As shown by the arrows in FIG. 13, the PE 1310B and PE 1310E receive the same input elements (X0-X3 and Y=1); the PE 1310C, PE 1310F, and PE 1310I receive the same input elements (X0-X3 and Y=2); the PE 1310G, PE 1310J, and PE 1310M receive the same input elements (X0-X3 and Y=3); and the PE 1310K and PE 1310N receive the same input elements (X0-X3 and Y=4).

Also, as each PE 1310 includes four weight register files 1330, each PE 1310 can store up to four corresponding coordinates for the filter. As the kernel is 3×3, each PE 1310 stores three coordinates for the filter, which are FX0-FX2. As shown in Error! Reference source not found. 13, row 0 (FY=0) of the 3×3 kernel are broadcast to the PEs 1310A, 1310E, 1310I, and 1310M. Row 1 (FY=1) of the 3×3 kernel are broadcast to the PEs 1310B, 1310F, 1310J, and 1310N. Row 2 (FY=2) of the 3×3 kernel are broadcast to the PEs 1310C, 1310G, 1310K, and 1310O. This allows each of the PEs 1310 to operate on a single row of the 3×3 kernel.

Each PE 1310 receives 16 depthwise channels (DC0-15) for the input elements as well as the weights. Different from depthwise convolutions performed by conventional DNN accelerators, there is no reduction in the Z direction in the embodiments of FIG. 13. Rather, the depthwise convolution in the embodiments of FIG. 13 include an intra row-wise reduction within a single PE 1310 through an internal adder assembly of the PE 1310 and an inter row-wise reduction across multiple PEs 1310 within the column through an external adder assembly. More details regarding internal adder assembly and external adder assembly are provided below in conjunction with FIGS. 10 and 11, respectively. The input element reuse in the X direction occurs within an individual PE 1310. More details regarding input element reuse in the X direction are provided below in conjunction with FIGS. 7A-1 and 9A-C. Even though not shown in FIG. 13, the depthwise convolution may use other PEs. For instance, for larger kernel sizes, the processing of a single output operand needs to be spread amongst multiple columns of PEs.

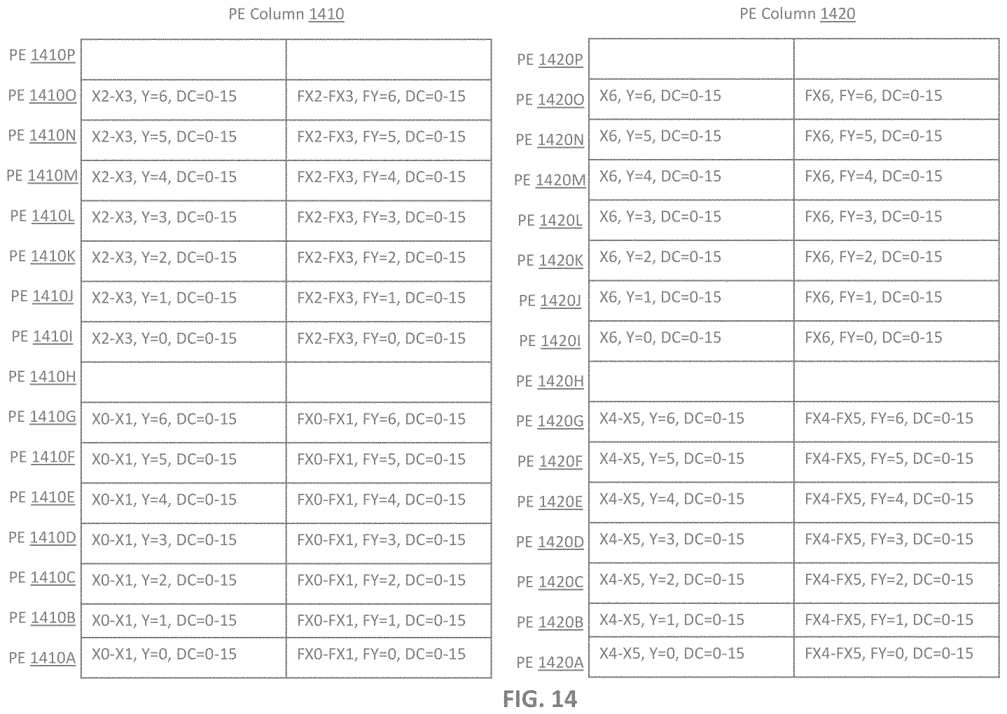

FIG. 14 illustrates an example memory layout within two PE columns 1400 and 1450 for reusing data in a FP depthwise convolution, in accordance with various embodiments. The PE columns 1400 and 1450 may be an embodiment of two PE columns 405 in FIG. 4. In some embodiments, the memory layout is determined and implemented through the controlling module 340. Different from the depth convolution in FIG. 13, the depth convolution in the embodiments of FIG. 14 is a 7×7s1 depth convolution, 7×7 refers to a 7×7 kernel, and s1 refers to a stride of 1. Two PE columns 1400 and 1450 are used to process a single output operand for the 7×7 kernel. Similar to the PE column 1300, the PE column 1400 includes 16 PEs 1410A-O (collectively referred to as “PEs 1410” or “PE 1410”). Each PE 1410 includes four input register files 1420 for storing input operands and four weight register files 1430 for storing weight operands. The PE columns 1450 includes 16 PEs 1460A-O (collectively referred to as “PEs 1460” or “PE 1460”). Each PE 1460 includes four input register files 1470 for storing input operands and four weight register files 1480 for storing weight operands. Each register file may store 16 data entries. A data entry may have a size of 1 byte.

In the PE column 1400, the PEs 1410A-G and 14101-O are active, versus the PEs 1410H and 1410P are inactive. In the PE column 1450, the PEs 1460A-G and 14601-O are active, versus the PEs 1460H and 1460P are inactive. The active PEs 1410 and 1460 can be loaded with a portion of an IFM or a whole IFM. The output of all the active PEs 1410 and 1460 will be accumulated to produce an output operand. The output operand includes an output element for each depthwise channel.

The memory layout shown in FIG. 13 or 14 may be for a single round of MAC operations in the depthwise convolution, such as the first round. The memory layout may change for another round of MAC operations in the depthwise convolution. For instance, some of the input register files of a PE may be loaded with new input operands in the subsequent round, and the new input operands may replace the input operands in the current round. The other input register files of the PE may store the same input operands in the subsequent round, in which these input operands will be reused for the subsequent round of MAC operations.

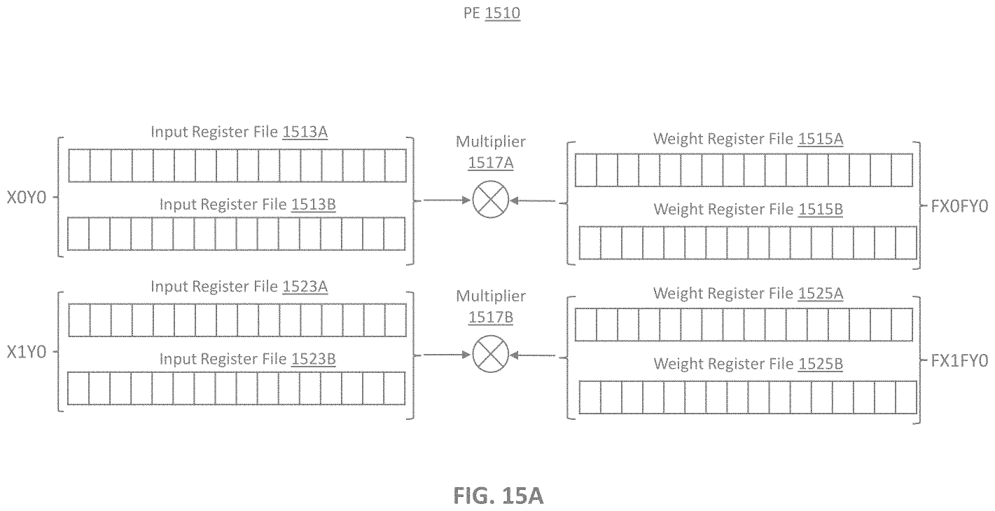

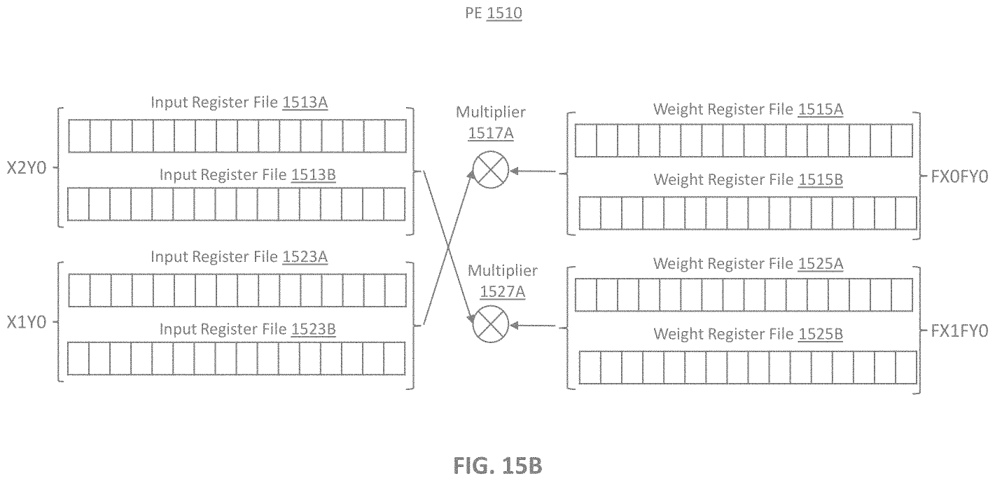

FIGS. 15A and 15B illustrate example rounds of FPMAC operations in a FP depthwise convolution, in accordance with various embodiments. In the embodiments of FIGS. 15A and 15B, the depth convolution is a 3×3s1 depth convolution and has 16 depthwise channels. The depthwise convolution may be based on the memory data layout shown in FIG. 13. In other embodiments, the depth convolution may use a different kernel size, a different stride, or a different number of depthwise channels. For purpose of simplicity and illustrations, FIGS. 15A and 15B shows two rounds of MAC operations in a PE 1510, which may be an embodiment of the PE 1310A in FIG. 13.

FIG. 15A shows the first round of FPMAC operations in the PE 1510. The PE 1510 includes four input register files 1513A-D (collectively referred to as “input register files 1513” or “input register file 1513”), four weight register files 1515A-D (collectively referred to as “weight register files 1515” or “weight register file 1515”), and two multipliers 1517A and 1517B (collectively referred to as “multipliers 1517” or “multiplier 1517”). Even though not shown in FIG. 15A, the PE 1510 may include other components, such as an internal adder assembly, an output register file, etc. Also, the PE 1510 may include a different number of input register files or weight register files.

In the first round, the input register files 1513A and 1513B are loaded with an input operand X0Y0. The input operand X0Y0 includes 16 input elements. In the embodiments of FIG. 5A, each input element has a size of 2 byte and each input register file 1513 has a storage capacity of 16 bytes, so two input register files 1513 are needed to store one input operand. Similarly, two weight register files 1515 are needed to store one weight operand. Even though not shown in FIG. 15A, the PE 1500 may include a concatenating module that can links the input elements from the two input register files 1513A and 1513B and arrange the 16 input elements of the input operand X0Y0 sequentially, e.g., in the order of the depthwise channels. The concatenating module can also link weights from the two weight register files 1515A and 1515B and arrange the 16 weights of the weight operand FX0FY0 sequentially. That way, the input elements in the input operand X0Y0 and weights in the weight operand FX0FY0 can be fed sequentially into the multiplier 1517A.

The multiplier 1517A receives the input operand from the input register file 1513A and the weight operand from the weight register file 1515A. In the first MAC round, the multiplier 1517A sequentially performs 16 cycles of multiplication operations. In each cycle, the multiplier 1517A multiplies an input element and a weight and generates a product. The input element and weight may correspond to the same depthwise channel. The multiplier 1517A processes the input elements and weights sequentially based on their positions in the input operand and weight operand.

Similarly, the input operand X1Y0 is stored in the input register files 1513C and 1513D and weights in the weight operand FX1FY0 is stored in the input register files 1515C and 1515D. The concatenating module can facilitate sequential arrangement of the 16 input elements of the input operand X1Y0 and the 16 weights of the weight operand FX1FY0, which will be fed into the multiplier 1517B. The multiplier 1517B, after receiving the input operand X1Y0 and the weight operand FX1FY0, performs 16 cycles of multiplication operations and generates a product for each depthwise channel.

FIG. 15B shows the second round of multiplication operations in the PE 1510. In the second round, the input register files 1513A and 1513B are loaded with a new input operand X2Y0, but the input register files 1513C and 1513D still stores the same input operand X1Y0. All the weight register files 1515 still stores the same weight operands. The multiplier 1517A performs multiplication operations on the input operand X1Y0 stored in the input register files 1513C and 1513D and the weight operand FX0FY0, and the multiplier 1517B performs multiplication operations on the new input operand X2Y0 and the weight operand FX1FY0. Thus, the input operand X1Y0 is reused in the second round.

Example Channel-Separable Pooling Operations

As mentioned above, pooling operations can down-sample a feature map without reducing the number of channels. In some embodiments, a pooling layer receives an output tensor of a convolution layer as an input tensor of the pooling layer. A pooling operation will be performed on the input tensor to reduce the size of the input tensor and to generate an output tensor of the pooling layer. A channel-separable pooling operation may be performed on an input operand that includes a plurality of depthwise channels. The input operand may be an output operand of a depthwise convolution, e.g., one of the depthwise convolutions described above. The pooling operation is channel-separable, meaning a pooling operation may be separately performed on the input array for each of the depthwise channels. For instance, for each depthwise channel, an output element is generated from a window in the X and Y dimensions. The input elements may be organized in a similar manner to depthwise convolution with different X coordinates across different input register files within a PE and different Y coordinates across different PEs. Successive separable channels, with one channel being evaluated per cycle, may occupy consecutive register file entries.

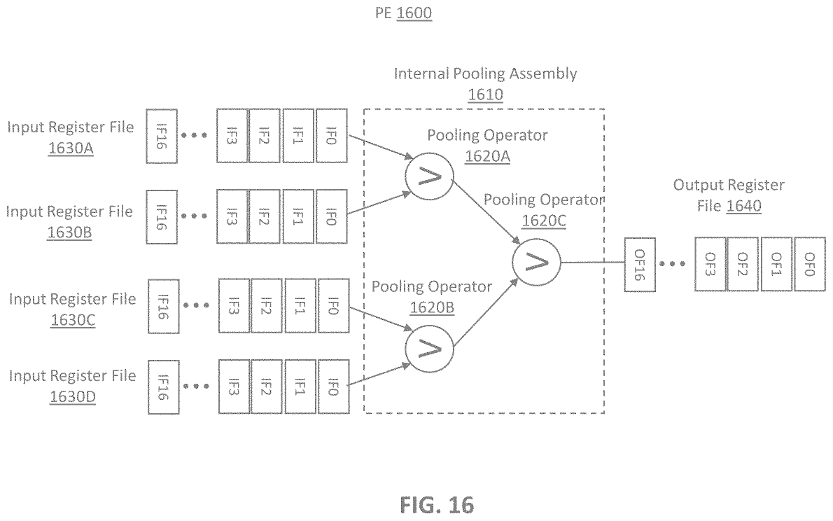

FIG. 16 illustrates an example channel-separable pooling operation within a PE 1600, in accordance with various embodiments. The channel-separable pooling operation in the embodiments of FIG. 16 may determine a value from a fixed window in the X and Y dimensions through an entire tensor volume without changing the Z dimension. As shown in FIG. 16, the PE 1600 includes an internal pooling assembly 1610, input register files 1630A-D (collectively referred to as “input register files 1630” or “input register file 1630”), and an output register file 1640.

Each input register file 1630 stores an input operand that includes 16 input elements IF0-IF15. Each input element corresponds to a different depthwise channel. The 16 input elements of each input operand may be fed subsequentially into the internal pooling assembly 1610. Each input element or weight may be stored in a storage unit of the corresponding register file. The storage unit may have a size of a byte. The input element or weight may be an integer, e.g., in the data format of INT8.

The internal pooling assembly 1610 performs pooling operations on the input operands from the input register files 1630. In an embodiment, the pooling operations are max pooling operations, and the internal pooling assembly 1610 may take a maximum value from a fixed window in the X and Y dimensions through an entire tensor volume without changing the Z dimension. In another embodiment, the pooling operations are average pooling operations, and the internal pooling assembly 1610 may determine an average of a fixed window in the X and Y dimensions through an entire tensor volume without changing the Z dimension. In other embodiments, the internal pooling assembly 1610 may perform other types of pooling operations.

The internal pooling assembly 1610 includes internal pooling operators 1620A-C (collectively referred to as “internal pooling operators 1620” or “internal pooling operator 1620”). The internal pooling operators 1620 are arranged in two tiers. The first tier includes the internal pooling operators 1620A and 16206. The second tier includes the internal pooling operator 1620C. Each of the internal pooling operators 1620 in the first tier receives two input operands from two input register files 1630. For instance, the internal pooling operator 1620A receives the input operands from the input register files 1610A and 1610B. The internal pooling operator 1620A performs 16 cycles of pooling operations. In each cycle, the internal pooling operator 1620A performs a pooling operation on an input element from the input register file 1610A and an input element from the input register file 1610B. For instance, internal pooling operator 1620A selects the input element that has a greater value or determine an average value of the two input elements. The two input elements, which are used in each cycle, correspond to the same depthwise channel. Accordingly, the internal pooling operator 1620A generate an output operand that includes 16 elements, each of which corresponds to a different depthwise channel.

Similarly, the internal pooling operator 1620B receives the input operands from the input register files 1610C and 1610D, and performs 16 cycles of pooling operations on the two input operands, each cycle of which includes a pooling operation on an input element from the input register file 1610A and an input element from the input register file 1610B. The internal pooling operator 1620B generate an output operand that includes 16 elements.

The output operands of the internal pooling operators 1620A and 1620B are provided to the internal pooling operator 1620C as two input operands of the internal pooling operator 1620C. The internal pooling operator 1620C performs 16 cycles of pooling operations on the two input operands. In each cycle, the internal pooling operator 1620C may compare an input element from the internal pooling operator 1620A and an input element from the internal pooling operator 1620B and selects the input element having a greater value, or determine an average value of the two input elements. The internal pooling operator 1620B generate an output operand that includes 16 elements OF0-OF16, each of which corresponds to a depthwise channel. The internal pooling assembly 1610 reduces the four input operands in the input register files 1630 into one output operand in the output register file 1640.

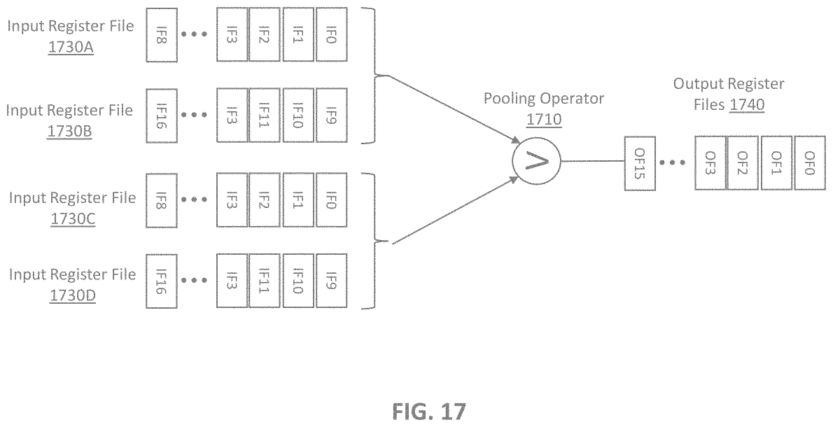

FIG. 17 illustrates another example channel-separable pooling operation in a PE 1700, in accordance with various embodiments. The channel-separable pooling operation in the embodiments of FIG. 17 may determine a value from a fixed window in the X and Y dimensions through an entire tensor volume without changing the Z dimension. As shown in FIG. 17, the PE 1700 includes an internal pooling operator 1710, input register files 1730A-D (collectively referred to as “input register files 1730” or “input register file 1730”), and two output register files 1740.

In the embodiments of FIG. 17, two input register files 1730 store an input operand that includes 16 input elements IF0-IF15, i.e., the four input register files 1730 store two input operands. Each input element corresponds to a different depthwise channel. The 16 input elements of each input operand may be fed subsequentially into the internal pooling operator 1710, e.g., through a concatenating module. Each input element or weight may be stored in two storage units of the corresponding register file. A storage unit may have a size of a byte. The input element or weight may be a FP number, e.g., in the data format of FP16 or BF 16.

The internal pooling operator 1710 performs pooling operations on the two input operands from the input register files 1730. In an embodiment, the pooling operations are max pooling operations, and the internal pooling operator 1710 may take a maximum value from a fixed window in the X and Y dimensions through an entire tensor volume without changing the Z dimension. In another embodiment, the pooling operations are average pooling operations, and the internal pooling operator 1710 may determine an average of a fixed window in the X and Y dimensions through an entire tensor volume without changing the Z dimension. In other embodiments, the internal pooling operator 1710 may perform other types of pooling operations. For instance, the internal pooling operator 1720 performs 16 cycles of pooling operations. In each cycle, the internal pooling operator 1720A performs a pooling operation on an input element of the first input operand, which is from the input register files 1710A and 1710B, and an input element of the second input operand, which is from the input register files 1710C and 1710D. The internal pooling operator 1720 may select the input element that has a greater value or determine an average value of the two input elements. The two input elements, which are used in each cycle, correspond to the same depthwise channel. Accordingly, the internal pooling operator 1720A generate an output operand that includes 16 elements OF0-OF15, each of which corresponds to a different depthwise channel. The output operand can be stored in the output register files 1740.

In some embodiments (e.g., embodiments where the channel-separatable pooling is average pooling), a PE used for channel-separatable pooling may be an embodiment of a PE that can be used for depthwise convolution, e.g., the PE 500, 610, 810, etc. For example, a multiplier in the PE may multiply each input element of an input operand with 1, so the product is the input element. The internal adder assembly in the PE may perform accumulation operations on the products generated by the multipliers in the PE. A divider, which may be in the PE or outside the PE, may perform dividing operations on the output of the internal adder assembly, e.g., dividing each output element from the internal adder assembly by a predetermined number. The predetermined number may be the number of input operands received by the internal adder assembly.

Example Channel-Separable Elementwise Operations

Elementwise add operations take two input tensors and performs a vector addition or perform a vector addition after an initial scalar multiplication. The dimensions of the two input tensor may be identical. Separate scale values can be applied to one or both input tensors.

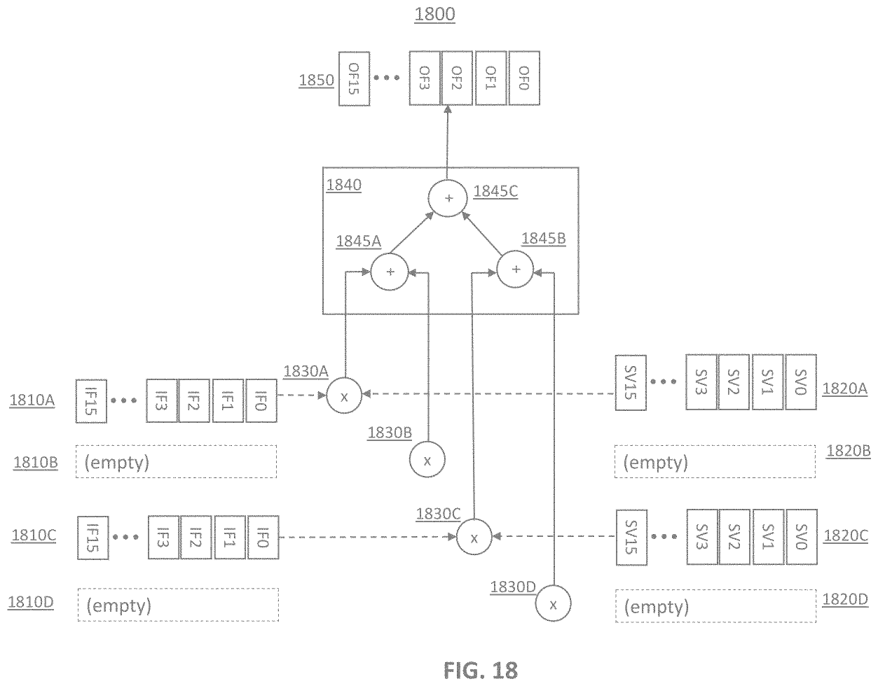

FIG. 18 illustrates an example channel-separable elementwise add operation in a PE 1800, in accordance with various embodiments. The channel-separable elementwise add operation involves scale values. The size of the scale value is 8 bits, i.e., a byte, which is the same as the size of an input element. The PE 1800 has the same or similar components as a PE that can be used for depthwise convolution, e.g., the PE 500 or 1000. As shown in FIG. 18, the PE 1800 includes four input register files 1810 (collectively referred to as “input register files 1810” or “input register file 1810”), four scale register files 1820 (collectively referred to as “scale register files 1820” or “scale register file 1820”), four multipliers 1830A-D (collectively referred to as “multipliers 1830” or “multiplier 1830”), an internal adder assembly 1840 that includes three internal adders 1845A-C collectively referred to as “internal adders 1845” or “internal adder 1845”), and an output register file 1850. In other embodiments, the PE 1800 may include a different number of input register files 1810, scale register files 1820, multipliers 1830, internal adders 1845, or output register file 1850.

The input register file 1810A stores a first input operand, which is from one of the two input tensor. The input register file 1810C stores a second input operand, which is from the other one of the two input tensor. Each input operand includes 16 input elements, IF0-IF15, each of which corresponds to a different depthwise channel. The input register files 1810B and 1810D are empty. The scale register files 1820A and 1820C each store a vector of 16 scale values: SV0-SV15. The scale values may be one or more fixed values, which may be determined by training the DNN.

The multiplier 1830A performs multiplication operations on the first input operand and the vector of scale values from the scale register file 1820A. Similarly, the multiplier 1830B performs multiplication operations on the second input operand and the vector of scale values from the scale register file 1820B. The multipliers 1830B and 1830D are inactive.

The products generated through the multiplication operations are fed into the internal adder assembly 1840. As the multipliers 1830B and 1830D are inactive, the values provided to the internal adder assembly 1840 from the multipliers 1830B and 1830D may to zero. The internal adder assembly 1840 includes internal adders 1845A-C, each of which can perform channel-separable accumulation operations, which are similar as the accumulation operations of the internal adders 1045 described above in conjunction with FIG. 10. The internal adder assembly 1040 outputs an output operand that includes 16 output elements OF0-OF 15. The output operand is stored in the output register file 1850.

In embodiments where the elementwise add operation does not involve scale values, the values stored in the scale register files 1820A and 1820C can be 1, so that the output of the multipliers 1830A and 1830C will be the input operands themselves.

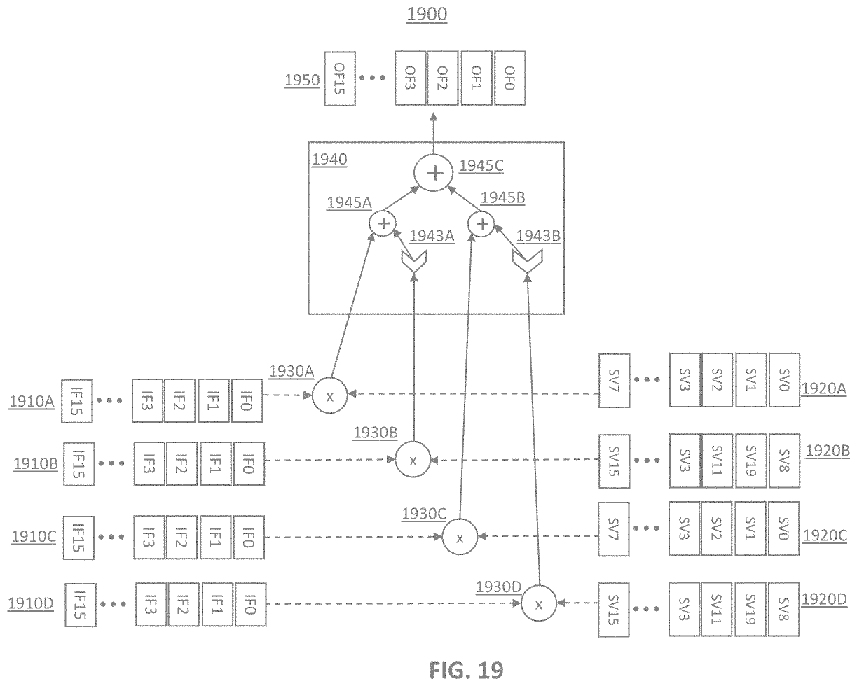

FIG. 19 illustrates another example channel-separable elementwise addition in a PE 1900, in accordance with various embodiments. The channel-separable elementwise add operation involves scale values. The size of the scale value is 16 bits, i.e., 2 bytes, which is twice the size of an input element. The PE 1900 has the same or similar components as a PE that can be used for depthwise convolution, e.g., the PE 500 or 1000. As shown in FIG. 19, the PE 1900 includes four input register files 1910 (collectively referred to as “input register files 1910” or “input register file 1910”), four scale register files 1920 (collectively referred to as “scale register files 1920” or “scale register file 1920”), four multipliers 1930A-D (collectively referred to as “multipliers 1930” or “multiplier 1930”), an internal adder assembly 1940 that includes three internal adders 1945A-C collectively referred to as “internal adders 1945” or “internal adder 1945”) and two bit shifters 1943A and 1943B, and an output register file 1950. In other embodiments, the PE 1900 may include a different number of input register files 1910, scale register files 1920, multipliers 1930, internal adders 1945, or output register file 1950.

In FIG. 19, each input register file 1910 stores an input operand. The input register files 1910A and 1910B store the same input operand (e.g., a first input operand from one of the two input tensors), and the input register files 1910A and 1910B store the same input operand (e.g., a second input operand from the other one of the two input tensors). The scale register files 1920A and 1920B each store a half of a scale vector. The scale register file 1920A stores the lower bytes SV0-SV7, and the scale register file 1920B stores the higher bytes SV8-SV15. Similarly, the scale register files 1920C and 1920D each store a half of another scale vector. The scale register file 1920C stores the lower bytes SV0-SV7, and the scale register file 1920D stores the higher bytes SV8-SV15.

The multiplier 1930A performs multiplication operations on the first input operand from the input register file 1910A and the first half of the first scale vector from the scale register file 1920A. The multiplier 1930B performs multiplication operations on the first input operand from the input register file 1910B and the second half of the first scale vector from the scale register file 1920B. Similarly, the multiplier 1930C performs multiplication operations on the second input operand from the input register file 1910C and the first half of the second scale vector from the scale register file 1920C, and the multiplier 1930D performs multiplication operations on the second input operand from the input register file 1910D and the second half of the second scale vector from the scale register file 1920D.

The products generated by the four multipliers 1930 are fed into the internal adder assembly 1940. The products from the multipliers 1930A and 1930C are directly provided to the internal adder 1945A and 1945B, respectively. The products from the multipliers 1930B and 1930D are first provided to the bit shifters 1943A and 1943B, respectively. The bit shifters 1943A can change the positions of the products from the multipliers 1930B, which are then combined with the products from the multipliers 1930A by the internal adder 1945A. Similarly, the bit shifters 1943B can change the positions of the products from the multipliers 1930D, which are then combined with the products from the multipliers 1930C by the internal adder 1945B. The sums from the internal adders 1945A and 1945B are then provided to the internal adder 1945C, which generate an output operand including 16 output elements OF0-OF15. The output operand is stored in the output register file 1950.

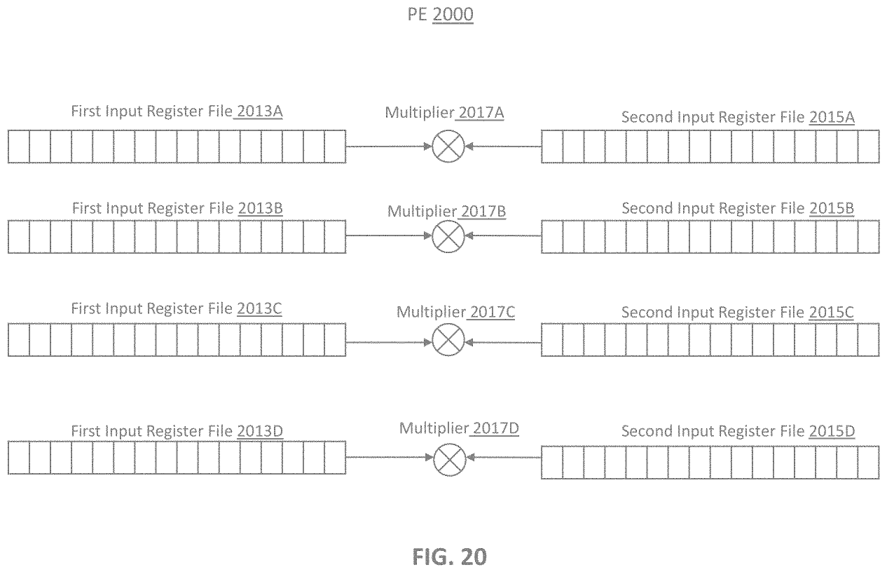

FIG. 20 illustrates an example channel-separable elementwise multiplication in a PE 2000, in accordance with various embodiments. The channel-separable elementwise multiplication is performed on two input tensors, which may be from two DNN layers. The two input tensors may have the same dimensions. The result of the channel-separable elementwise multiplication may be a new tensor (also referred to as output tensor) with the same dimensions as the input tensors. The output tensor includes a plurality of scalar values. Each scalar value may be a product of a first scale value in the first input tensor and a second scalar value in the second input tensor.

As shown in FIG. 20, the PE 2010 includes four first input register files 2013A-D (collectively referred to as “first input register files 2013” or “first input register file 2013”), four second input register files 2015A-D (collectively referred to as “second input register files 2015” or “second input register file 2015”), and four multipliers 2017A-D (collectively referred to as “multipliers 2017” or “multiplier 2017”). Even though not shown in FIG. 20A, the PE 2010 may include other components, such as an internal adder assembly, an output register file, etc. The internal adder assembly may not be used for the channel-separable elementwise multiplication. Also, the PE 2010 may include a different number of first input register files or second input register files. The PE 2010 may be the same or similar to a PE used to perform depthwise convolutions, such as the PE 500, 610, or 710.

The first input tensor and the second input tensor may be separately loaded to the first input register files 2013 and the second input register files 2015, respectively. As shown in FIG. 20, each first input register file 2013 stores a first input operand, which may be a portion of the first input tensor. Each second input register file 2015 stores a second input operand, which may be a portion of the second input tensor. Each multiplier 2017 performs multiplication operations, e.g., 16 sequential cycles of multiplication, on a first input operand and a second input operand. Each cycle may be a multiplication of an input element in the first input operand and an input element in the second input operand. The two input elements may correspond to a same depthwise channel. The product produced by multiplying each pair of input elements may be an output element of an output operand, which can be written into an output register file of the PE 2010. The existence of multiple register files 2013 or 2015 for each input tensor and multiple multipliers 2017 in the PE 2010 allows the PE 2010 to implement N parallel contexts, where N is an integer and equals the number of multipliers 2017 (N=4 in FIG. 20). A context may refer to individual partial sums for different output elements. This is possible as the PE architecture allows bypassing the internal adder assembly and write the contexts in parallel to the output register file. Furthermore, the channel-separable elementwise multiplication may not need external adders.

Compared with conventional elementwise multiplication that produces a single context per clock cycle, the PE 2010 is more advantageous. In conventional elementwise multiplication, subsequent channels can be fed to different multipliers in parallel to produce a single context. Then the channels are reduced through adders before writing to the output register file. The result of accumulating across channels through the adders would produce an incorrect elementwise multiplication result and hence only a single multiplier per PE can be used. In contrast, in the embodiments of FIG. 20, four multipliers 2017 can be utilized within the PE 2010, the throughput will be four times that of the conventional elementwise multiplication.

Example Method for Depthwise Convolution with Data Reuse

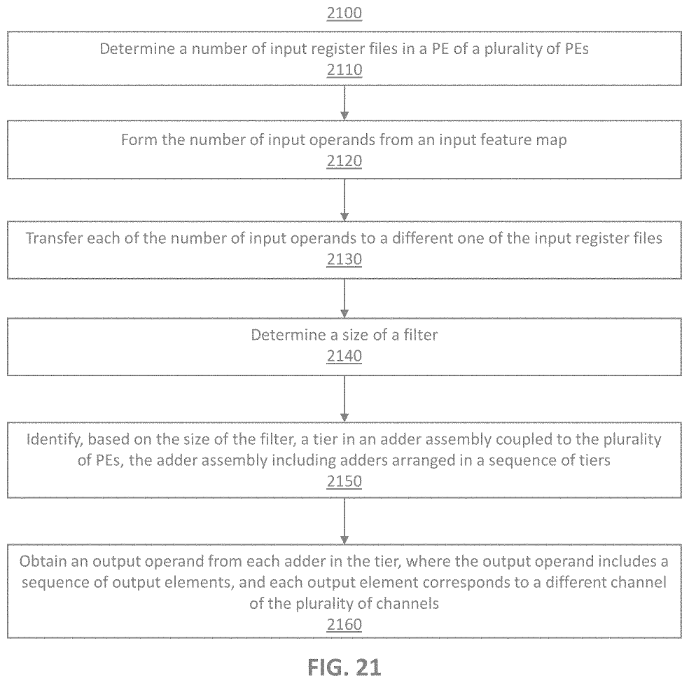

FIG. 21 is a flowchart illustrating a method 2100 for depthwise convolution with data reuse, in accordance with various embodiments. The method 2100 may be performed by the controlling module 340 in FIG. 3. Although the method 2100 is described with reference to the flowchart illustrated in FIG. 21, many other methods for depthwise convolution may alternatively be used. For example, the order of execution of the steps in FIG. 21 may be changed. As another example, some of the steps may be changed, eliminated, or combined.

The controlling module 340 determines 2110 a number of input register files in a PE of a plurality of PEs. The plurality of PEs are configured to perform multiply-accumulation operations on a filter and an input feature map that includes a plurality of channels.

The controlling module 340 forms 2120 the number of input operands from the input feature map. Each input operand includes a sequence of input elements from the input feature map. Each input element corresponds to a different channel of the plurality of channels. The controlling module 340 transfers 2130 each of the number of input operands to a different one of the input register files. The controlling module 340 may transfer same input operands to the input register files in the PE and to input register files in another PE of the plurality of PEs. The controlling module 340 may also transfer same weight operands to weight register files in the PE and to weight register files in another PE of the plurality of PEs, where each weight operand includes a sequence of weight from the filter, and each weight corresponds to a different channel of the plurality of channels.

In some embodiments, the controlling module 340 also determines an additional number of weight register files in the PE. The controlling module 340 may form the additional number of weight operands from the filter. Each weight operand includes a sequence of weight from the filter. Each weight corresponds to a different channel of the plurality of channels. The controlling module 340 may transfer each of the additional number of weight operands to a different one of the weight register files. In some embodiments, the additional number may be the same as or smaller than the number.

The PE may include multipliers coupled to the register files. In some embodiments, the controlling module 340 may instruct, at a first time, a first multiplier in the PE to perform multiplication operations on a first input operand from a first input register file and a first weight operand from a first weight register file. The controlling module 340 may instruct, at a second time that is different from the first time, a second multiplier of the PE to perform multiplication operations on the first input operand from the first input register file and a second weight operand from a second weight register file.

The controlling module 340 may also instruct, at the first time, the second multiplier of the PE to perform multiplication operations on a second input operand and the second weight operand at the first time. The controlling module 340 may transfer, at the second time, a new input operand to the first input register file. The controlling module 340 may also instruct, at a third time that is after the second time, a third multiplier to perform multiplication operations on the new input operand from the first input register file and a third weight operand from a third weight register file.

The controlling module 340 determines 2140 a size of the filter. In some embodiments, the filter includes a plurality of kernel. Each kernel may correspond to a different depthwise channel and include weights arranged in rows and columns. The size of the filter may include a number of the rows, a number of the columns, or both. In some embodiments, the controlling module 340 may select, based on the size of the filter, a subset of PEs from the plurality of PEs and transfer input operands to input registers files of the PEs in the subset. The controlling module 340 may not transfer input operands to other PEs.

The controlling module 340 identifies 2150, based on the size of the filter, a tier in an adder assembly. The adder assembly includes a plurality of adders arranged in a sequence of tiers. Each tier includes one or more adders. The controlling module 340 obtains 2160 an output operand from each adder in the tier. The output operand includes a sequence of output elements. Each output element corresponds to a different channel of the plurality of channels.

Example DL Environment

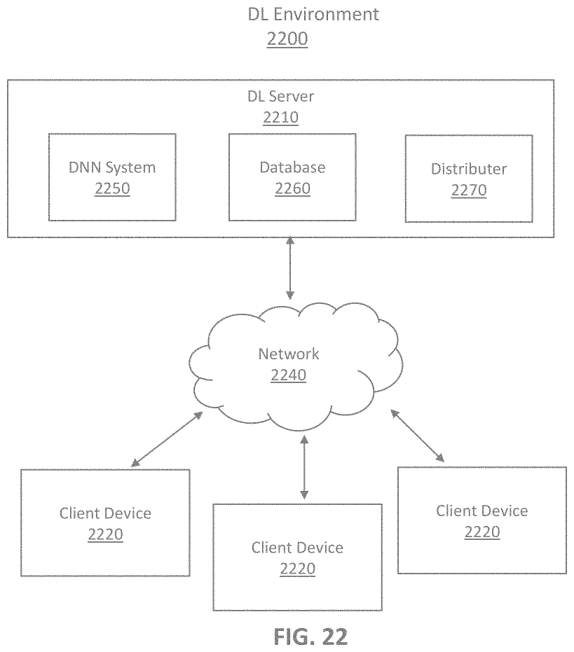

FIG. 22 illustrates a DL environment 2200, in accordance with various embodiments. The DL environment 2200 includes a DL server 2210 and a plurality of client devices 2220 (individually referred to as client device 2220). The DL server 2210 is connected to the client devices 2220 through a network 2240. In other embodiments, the DL environment 2200 may include fewer, more, or different components.

The DL server 2210 trains DL models using neural networks. A neural network is structured like the human brain and consists of artificial neurons, also known as nodes. These nodes are stacked next to each other in three types of layers: input layer, hidden layer(s), and output layer. Data provides each node with information in the form of inputs. The node multiplies the inputs with random weights, calculates them, and adds a bias. Finally, nonlinear functions, also known as activation functions, are applied to determine which neuron to fire. The DL server 2210 can use various types of neural networks, such as DNN, recurrent neural network (RNN), generative adversarial network (GAN), long short-term memory network (LSTMN), and so on. During the process of training the DL models, the neural networks use unknown elements in the input distribution to extract features, group objects, and discover useful data patterns. The DL models can be used to solve various problems, e.g., making predictions, classifying images, and so on. The DL server 2210 may build DL models specific to particular types of problems that need to be solved. A DL model is trained to receive an input and outputs the solution to the particular problem.

In FIG. 22, the DL server 2210 includes a DNN system 2250, a database 2260, and a distributer 2270. The DNN system 2250 trains DNNs. The DNNs can be used to process images, e.g., images captured by autonomous vehicles, medical devices, satellites, and so on. In an embodiment, a DNN receives an input image and outputs classifications of objects in the input image. An example of the DNNs is the DNN 220 described above in conjunction with FIG. 1. The DNN system 2250 also compresses the trained DNNs to reduce the sizes of the trained DNNs. As the compressed DNNs has a smaller size, application of the compressed DNNs requires less time and computing resources (e.g., memory, processor, etc.) compared with uncompressed DNNs. The compressed DNNs may be used on low memory systems, like mobile phones, IOT edge devices, and so on. The DNN system 2250 can also rearrange weight operands and activation operands in a trained or compressed DNN to balance sparsity in the weight operands and activation operands. More details regarding the DNN system 2250 are described below in conjunction with FIG. 11.

The database 2260 stores data received, used, generated, or otherwise associated with the DL server 2210. For example, the database 2260 stores a training dataset that the DNN system 2250 uses to train DNNs. In an embodiment, the training dataset is an image gallery that can be used to train a DNN for classifying images. The training dataset may include data received from the client devices 2220. As another example, the database 2260 stores hyperparameters of the neural networks built by the DL server 2210.

The distributer 2270 distributes DL models generated by the DL server 2210 to the client devices 2220. In some embodiments, the distributer 2270 receives a request for a DNN from a client device 2220 through the network 2240. The request may include a description of a problem that the client device 2220 needs to solve. The request may also include information of the client device 2220, such as information describing available computing resource on the client device. The information describing available computing resource on the client device 2220 can be information indicating network bandwidth, information indicating available memory size, information indicating processing power of the client device 2220, and so on. In an embodiment, the distributer may instruct the DNN system 2250 to generate a DNN in accordance with the request. The DNN system 2250 may generate a DNN based on the description of the problem. Alternatively or additionally, the DNN system 2250 may compress a DNN based on the information describing available computing resource on the client device.

In another embodiment, the distributer 2270 may select the DNN from a group of pre-existing DNNs based on the request. The distributer 2270 may select a DNN for a particular client device 2230 based on the size of the DNN and available resources of the client device 2230. In embodiments where the distributer 2270 determines that the client device 2230 has limited memory or processing power, the distributer 2270 may select a compressed DNN for the client device 2230, as opposed to an uncompressed DNN that has a larger size. The distributer 2270 then transmits the DNN generated or selected for the client device 2220 to the client device 2220.

In some embodiments, the distributer 2270 may receive feedback from the client device 2220. For example, the distributer 2270 receives new training data from the client device 2220 and may send the new training data to the DNN system 2250 for further training the DNN. As another example, the feedback includes an update of the available computer resource on the client device 2220. The distributer 2270 may send a different DNN to the client device 2220 based on the update. For instance, after receiving the feedback indicating that the computing resources of the client device 2220 have been reduced, the distributer 2270 sends a DNN of a smaller size to the client device 2220.

The client devices 2220 receive DNNs from the distributer 2270 and applies the DNNs to solve problems, e.g., to classify objects in images. In various embodiments, the client devices 2220 input images into the DNNs and uses the output of the DNNs for various applications, e.g., visual reconstruction, augmented reality, robot localization and navigation, medical diagnosis, weather prediction, and so on. A client device 2220 may be one or more computing devices capable of receiving user input as well as transmitting and/or receiving data via the network 2240. In one embodiment, a client device 2220 is a conventional computer system, such as a desktop or a laptop computer. Alternatively, a client device 2220 may be a device having computer functionality, such as a personal digital assistant (PDA), a mobile telephone, a smartphone, an autonomous vehicle, or another suitable device. A client device 2220 is configured to communicate via the network 2240. In one embodiment, a client device 2220 executes an application allowing a user of the client device 2220 to interact with the DL server 2210 (e.g., the distributer 2270 of the DL server 2210). The client device 2220 may request DNNs or send feedback to the distributer 2270 through the application. For example, a client device 2220 executes a browser application to enable interaction between the client device 2220 and the DL server 2210 via the network 2240. In another embodiment, a client device 2220 interacts with the DL server 2210 through an application programming interface (API) running on a native operating system of the client device 2220, such as IOS® or and ROID™.

In an embodiment, a client device 2220 is an integrated computing device that operates as a standalone network-enabled device. For example, the client device 2220 includes display, speakers, microphone, camera, and input device. In another embodiment, a client device 2220 is a computing device for coupling to an external media device such as a television or other external display and/or audio output system. In this embodiment, the client device 2220 may couple to the external media device via a wireless interface or wired interface (e.g., an HDMI cable) and may utilize various functions of the external media device such as its display, speakers, microphone, camera, and input devices. Here, the client device 2220 may be configured to be compatible with a generic external media device that does not have specialized software, firmware, or hardware specifically for interacting with the client device 2220.

The network 2240 supports communications between the DL server 2210 and client devices 2220. The network 2240 may comprise any combination of local area and/or wide area networks, using both wired and/or wireless communication systems. In one embodiment, the network 2240 may use standard communications technologies and/or protocols. For example, the network 2240 may include communication links using technologies such as Ethernet, 8010.11, worldwide interoperability for microwave access (WiMAX), 3G, 5G, code division multiple access (CDMA), digital subscriber line (DSL), etc. Examples of networking protocols used for communicating via the network 2240 may include multiprotocol label switching (MPLS), transmission control protocol/Internet protocol (TCP/IP), hypertext transport protocol (HTTP), simple mail transfer protocol (SMTP), and file transfer protocol (FTP). Data exchanged over the network 2240 may be represented using any suitable format, such as hypertext markup language (HTML) or extensible markup language (XML). In some embodiments, all or some of the communication links of the network 2240 may be encrypted using any suitable technique or techniques.

Example DNN System

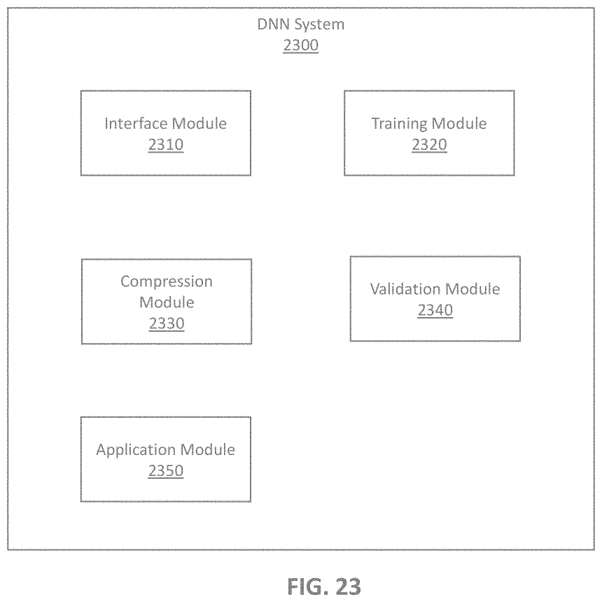

FIG. 23 is a block diagram of a DNN system 2300, in accordance with various embodiments. The DNN system 2300 may be an embodiment of the DNN system 2250 or the DNN accelerator 300. The DNN system 2300 trains DNNs. The DNN system 2300 can train DNNs that can be used to solve various problems, such as image classification, learning relationships between biological cells (e.g., DNA, proteins, etc.), control behaviors for devices (e.g., robots, machines, etc.), and so on. The DNN system 2300 includes an interface module 2310, a training module 2320, a compression module 2330, a validation module 2340, and an application module 2350. In other embodiments, alternative configurations, different or additional components may be included in the DNN system 2300. Further, functionality attributed to a component of the DNN system 2300 may be accomplished by a different component included in the DNN system 2300.

The interface module 2310 facilitates communications of the DNN system 2300 with other systems. For example, the interface module 2310 establishes communications between the DNN system 2300 with an external database to receive data that can be used to train DNNs or input into DNNs to perform tasks. As another example, the interface module 2310 supports the DNN system 2300 to distribute DNNs to other systems, e.g., computing devices configured to apply DNNs to perform tasks.

The training module 2320 trains DNNs by using a training dataset. The training module 2320 forms the training dataset. In an embodiment where the training module 2320 trains a DNN to recognize objects in images, the training dataset includes training images and training labels. The training labels describe ground-truth classifications of objects in the training images. In some embodiments, each label in the training dataset corresponds to an object in a training image. In some embodiments, a part of the training dataset may be used to initially train the DNN, and the rest of the training dataset may be held back as a tuning subset used by the compression module 2330 to tune a compressed DNN or as a validation subset used by the validation module 2340 to validate performance of a trained or compressed DNN. The portion of the training dataset not including the tuning subset and the validation subset may be used to train the DNN.

The training module 2320 also determines hyperparameters for training the DNN. Hyperparameters are variables specifying the DNN training process. Hyperparameters are different from parameters inside the DNN (e.g., weights of weight operands). In some embodiments, hyperparameters include variables determining the architecture of the DNN, such as number of hidden layers, etc. Hyperparameters also include variables which determine how the DNN is trained, such as batch size, number of epochs, etc. A batch size defines the number of training samples to work through before updating the parameters of the DNN. The batch size is the same as or smaller than the number of samples in the training dataset. The training dataset can be divided into one or more batches. The number of epochs defines how many times the entire training dataset is passed forward and backwards through the entire network. The number of epochs defines the number of times that the DL algorithm works through the entire training dataset. One epoch means that each training sample in the training dataset has had an opportunity to update the parameters inside the DNN. An epoch may include one or more batches. The number of epochs may be 10, 100, 500, 1000, or even larger.

The training module 2320 defines the architecture of the DNN, e.g., based on some of the hyperparameters. The architecture of the DNN includes an input layer, an output layer, and a plurality of hidden layers. The input layer of a DNN may include tensors (e.g., a multidimensional array) specifying attributes of the input image, such as the height of the input image, the width of the input image, and the depth of the input image (e.g., the number of bits specifying the color of a pixel in the input image). The output layer includes labels of objects in the input layer. The hidden layers are layers between the input layer and output layer. The hidden layers include one or more convolutional layers and one or more other types of layers, such as rectified liner unit (ReLU) layers, pooling layers, fully connected layers, normalization layers, softmax or logistic layers, and so on. The convolutional layers of the DNN abstract the input image to a feature map that is represented by a tensor specifying the feature map height, the feature map width, and the feature map channels (e.g., red, green, blue images include three channels). A pooling layer is used to reduce the spatial volume of input image after convolution. It is used between two convolution layers. A fully connected layer involves weights, biases, and neurons. It connects neurons in one layer to neurons in another layer. It is used to classify images between different category by training.

The training module 2320 inputs the training dataset into the DNN and modifies the parameters inside the DNN to minimize the error between the generated labels of objects in the training images and the training labels. The parameters include weights of weight operands in the convolutional layers of the DNN. In some embodiments, the training module 2320 uses a cost function to minimize the error. After the training module 2320 finishes the predetermined number of epochs, the training module 2320 may stop updating the parameters in the DNN. The DNN having the updated parameters is referred to as a trained DNN.

The compression module 2330 compresses trained DNNs to reduce complexity of the trained DNNs at the cost of small loss in model accuracy. The compression module 2330 converts some or all of the convolutional tensors in a trained DNN into reduced tensors that have reduced dimensions from the corresponding convolutional tensors. The compression module 2330 then integrates the reduced tensors into the trained DNN to reduce the complexity of the trained DNN. In some embodiments, the compression module 2330 prunes a subset of the weight operands in a convolutional layer to generate a sparse tensor and then decomposes the sparse tensor to generate the reduced tensor of the convolutional layer. The compression module 2330 compresses the trained DNN by removing the convolutional tensor from the network and placing the reduced tensor into the network. After some or all of the convolutional tensor in the trained DNN is removed and their reduced tensors are integrated, a compressed DNN is generated. The compression module 2330 may fine-tune the compressed DNN. For instance, the compression module 2330 uses the training dataset, or a subset of the training dataset, to train the compressed DNN. As the compressed DNN is converted from the pre-trained DNN, the fine-tuning process is a re-training process.

The validation module 2340 verifies accuracy of trained or compressed DNN. In some embodiments, the validation module 2340 inputs samples in a validation dataset into the DNN and uses the outputs of the DNN to determine the model accuracy. In some embodiments, a validation dataset may be formed of some or all the samples in the training dataset. Additionally or alternatively, the validation dataset includes additional samples, other than those in the training sets. In some embodiments, the validation module 2340 determines may determine an accuracy score measuring the bit precision, recall, or a combination of bit precision and recall of the DNN. The validation module 2340 may use the following metrics to determine the accuracy score: Bit precision=TP/(TP+FP) and Recall=TP/(TP+FN), where bit precision may be how many the reference classification model correctly predicted (TP or true positives) out of the total it predicted (TP+FP or false positives), and recall may be how many the reference classification model correctly predicted (TP) out of the total number of objects that did have the property in question (TP+FN or false negatives). The F-score (F-score=2*PR/(P+R)) unifies bit precision and recall into a single measure.

The validation module 2340 may compare the accuracy score with a threshold score. In an example where the validation module 2340 determines that the accuracy score of the augmented model is lower than the threshold score, the validation module 2340 instructs the training module 2320 or the compression module 2330 to re-train the DNN. In one embodiment, the training module 2320 or the compression module 2330 may iteratively re-train the DNN until the occurrence of a stopping condition, such as the accuracy measurement indication that the DNN may be sufficiently accurate, or a number of training rounds having taken place.

In some embodiments, the validation module 2340 instructs the compression module 2330 to compress DNNs. For example, the validation module 2340 may determine whether an accuracy score of a compressed DNN is above a threshold score. In response to determining that the accuracy score of a compressed DNN is above a threshold score, the validation module 2340 instructs the compression module 2330 to further compress the DNN, e.g., by compressing an uncompressed convolutional layer in the DNN. In an embodiment, the validation module 2340 may determine a compression rate based on the accuracy score and instructs the compression module 2330 to further compress the DNN based on the compression rate. The compression rate, e.g., is a percentage indicating the reduced size of the DNN from compression.

The application module 2350 applies the trained or compressed DNN to perform tasks. For instance, the application module 2350 inputs images into the DNN. The DNN outputs classifications of objects in the images. As an example, the DNN may be provisioned in a security setting to detect malicious or hazardous objects in images captured by security cameras. As another example, the DNN may be provisioned to detect objects (e.g., road signs, hazards, humans, pets, etc.) in images captured by cameras of an autonomous vehicle. The input to the DNN may be formatted according to a predefined input structure mirroring the way that the training dataset was provided to the DNN. The DNN may generate an output structure which may be, for example, a classification of the image, a listing of detected objects, a boundary of detected objects, or the like.

Example Computing Device

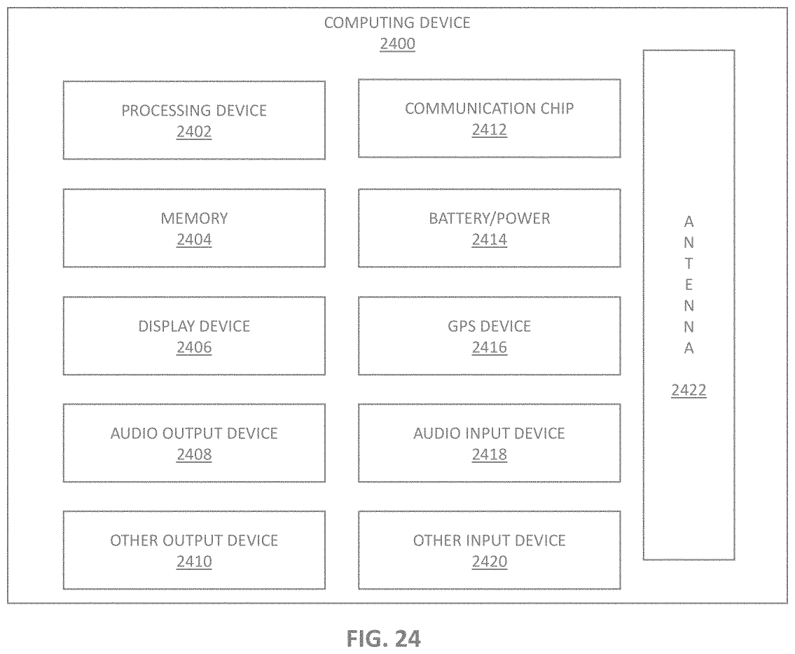

FIG. 24 is a block diagram of an example computing device 2400, in accordance with various embodiments. A number of components are illustrated in FIG. 24 as included in the computing device 2400, but any one or more of these components may be omitted or duplicated, as suitable for the application. In some embodiments, some or all of the components included in the computing device 2400 may be attached to one or more motherboards. In some embodiments, some or all of these components are fabricated onto a single system on a chip (SoC) die. Additionally, in various embodiments, the computing device 2400 may not include one or more of the components illustrated in FIG. 24, but the computing device 2400 may include interface circuitry for coupling to the one or more components. For example, the computing device 2400 may not include a display device 2406, but may include display device interface circuitry (e.g., a connector and driver circuitry) to which a display device 2406 may be coupled. In another set of examples, the computing device 2400 may not include an audio input device 2418 or an audio output device 2408, but may include audio input or output device interface circuitry (e.g., connectors and supporting circuitry) to which an audio input device 2418 or audio output device 2408 may be coupled.

The computing device 2400 may include a processing device 2402 (e.g., one or more processing devices). As used herein, the term “processing device” or “processor” may refer to any device or portion of a device that processes electronic data from registers and/or memory to transform that electronic data into other electronic data that may be stored in registers and/or memory. The processing device 2402 may include one or more digital signal processors (DSPs), application-specific ICs (ASICs), central processing units (CPUs), graphics processing units (GPUs), cryptoprocessors (specialized processors that execute cryptographic algorithms within hardware), server processors, or any other suitable processing devices. The computing device 2400 may include a memory 2404, which may itself include one or more memory devices such as volatile memory (e.g., DRAM), nonvolatile memory (e.g., read-only memory (ROM)), flash memory, solid state memory, and/or a hard drive. In some embodiments, the memory 2404 may include memory that shares a die with the processing device 2402. In some embodiments, the memory 2404 includes one or more non-transitory computer-readable media storing instructions executable to perform operations for deep learning, e.g., the method 2100 described above in conjunction with FIG. 21 or the operations performed by the controlling module 340 described above in conjunction with FIG. 3. The instructions stored in the one or more non-transitory computer-readable media may be executed by the processing device 2402.

In some embodiments, the computing device 2400 may include a communication chip 2412 (e.g., one or more communication chips). For example, the communication chip 2412 may be configured for managing wireless communications for the transfer of data to and from the computing device 2400. The term “wireless” and its derivatives may be used to describe circuits, devices, DNN accelerators, methods, techniques, communications channels, etc., that may communicate data through the use of modulated electromagnetic radiation through a nonsolid medium. The term does not imply that the associated devices do not contain any wires, although in some embodiments they might not.

The communication chip 2412 may implement any of a number of wireless standards or protocols, including but not limited to Institute for Electrical and Electronic Engineers (IEEE) standards including Wi-Fi (IEEE 802.13 family), IEEE 802.16 standards (e.g., IEEE 802.16-2005 Amendment), Long-Term Evolution (LTE) project along with any amendments, updates, and/or revisions (e.g., advanced LTE project, ultramobile broadband (UMB) project (also referred to as “3GPP2”), etc.). IEEE 802.16 compatible Broadband Wireless Access (BWA) networks are generally referred to as WiMAX networks, an acronym that stands for Worldwide Interoperability for Microwave Access, which is a certification mark for products that pass conformity and interoperability tests for the IEEE 802.16 standards. The communication chip 2412 may operate in accordance with a Global system for Mobile Communication (GSM), General Packet Radio Service (GPRS), Universal Mobile Telecommunications system (UMTS), High Speed Packet Access (HSPA), Evolved HSPA (E-HSPA), or LTE network. The communication chip 2412 may operate in accordance with Enhanced Data for GSM Evolution (EDGE), GSM EDGE Radio Access Network (GERAN), Universal Terrestrial Radio Access Network (UTRAN), or Evolved UTRAN (E-UTRAN). The communication chip 2412 may operate in accordance with CDMA, Time Division Multiple Access (TDMA), Digital Enhanced Cordless Telecommunications (DECT), Evolution-Data Optimized (EV-DO), and derivatives thereof, as well as any other wireless protocols that are designated as 3G, 5G, 5G, and beyond. The communication chip 2412 may operate in accordance with other wireless protocols in other embodiments. The computing device 2400 may include an antenna 2422 to facilitate wireless communications and/or to receive other wireless communications (such as AM or FM radio transmissions).

In some embodiments, the communication chip 2412 may manage wired communications, such as electrical, optical, or any other suitable communication protocols (e.g., the Ethernet). As noted above, the communication chip 2412 may include multiple communication chips. For instance, a first communication chip 2412 may be dedicated to shorter-range wireless communications such as Wi-Fi or Bluetooth, and a second communication chip 2412 may be dedicated to longer-range wireless communications such as global positioning system (GPS), EDGE, GPRS, CDMA, WiMAX, LTE, EV-DO, or others. In some embodiments, a first communication chip 2412 may be dedicated to wireless communications, and a second communication chip 2412 may be dedicated to wired communications.

The computing device 2400 may include battery/power circuitry 2414. The battery/power circuitry 2414 may include one or more energy storage devices (e.g., batteries or capacitors) and/or circuitry for coupling components of the computing device 2400 to an energy source separate from the computing device 2400 (e.g., AC line power).

The computing device 2400 may include a display device 2406 (or corresponding interface circuitry, as discussed above). The display device 2406 may include any visual indicators, such as a heads-up display, a computer monitor, a projector, a touchscreen display, a liquid crystal display (LCD), a light-emitting diode display, or a flat panel display, for example.

The computing device 2400 may include an audio output device 2408 (or corresponding interface circuitry, as discussed above). The audio output device 2408 may include any device that generates an audible indicator, such as speakers, headsets, or earbuds, for example.

The computing device 2400 may include an audio input device 2418 (or corresponding interface circuitry, as discussed above). The audio input device 2418 may include any device that generates a signal representative of a sound, such as microphones, microphone arrays, or digital instruments (e.g., instruments having a musical instrument digital interface (MIDI) output).

The computing device 2400 may include a GPS device 2416 (or corresponding interface circuitry, as discussed above). The GPS device 2416 may be in communication with a satellite-based system and may receive a location of the computing device 2400, as known in the art.

The computing device 2400 may include an other output device 2413 (or corresponding interface circuitry, as discussed above). Examples of the other output device 2413 may include an audio codec, a video codec, a printer, a wired or wireless transmitter for providing information to other devices, or an additional storage device.

The computing device 2400 may include an other input device 2420 (or corresponding interface circuitry, as discussed above). Examples of the other input device 2420 may include an accelerometer, a gyroscope, a compass, an image capture device, a keyboard, a cursor control device such as a mouse, a stylus, a touchpad, a bar code reader, a Quick Response (QR) code reader, any sensor, or a radio frequency identification (RFID) reader.

The computing device 2400 may have any desired form factor, such as a handheld or mobile computing system (e.g., a cell phone, a smart phone, a mobile internet device, a music player, a tablet computer, a laptop computer, a netbook computer, an ultrabook computer, a PDA, an ultramobile personal computer, etc.), a desktop computing system, a server or other networked computing component, a printer, a scanner, a monitor, a set-top box, an entertainment control unit, a vehicle control unit, a digital camera, a digital video recorder, or a wearable computing system. In some embodiments, the computing device 2400 may be any other electronic device that processes data.

### Select Examples

The following paragraphs provide various examples of the embodiments disclosed herein.

Example 1 provides an apparatus for deep learning, the apparatus including a PE that includes a plurality of input register files, an input register file configured to store an input operand that includes a sequence of input elements from an input feature map, the input feature map including a plurality of channels, and each input element corresponding to a different channel of the plurality of channels; a plurality of weight register files, a weight register file configured to store a weight operand that includes a sequence of weights from a filter; a plurality of multipliers, a multiplier configured to perform multiplication operations on a respective input operand from a respective input register file and a respective weight operand from a respective weight register file, where each multiplication operation includes a multiplication of a different input element in the respective input operand and a different weight in the respective weight operand; an adder assembly configured to perform accumulation operations on products generated by at least some of the plurality of multipliers and to generate an output operand; and an output register file configured to store the output operand, where the output operand includes a sequence of output elements, and each output element corresponds to a different channel of the plurality of channels.

Example 2 provides the apparatus of example 1, where a position of the different input element in the respective input operand matches a position of the different weight in the respective weight operand.

Example 3 provides the apparatus of example 1, where the filter includes a plurality of weights arranged in rows and columns, an output element in the output operand is a sum of products of input elements from different input operands and weights from different weight operands, and the weights for the output element are in a same row of the filter.

Example 4 provides the apparatus of example 1, where the adder assembly including a first group of adders and a second group of one or more adders, an adder in the first group is configured to accumulate products generated by at least two multipliers of the plurality of multipliers, and an adder in the second group is configured to accumulate sums generated by at least two adders in the first group.

Example 5 provides the apparatus of example 1, further including a plurality of PEs including the PE, the plurality of PEs configured to generate a number of output operands, each of which is generated by a different one of the plurality of PEs; and an additional adder assembly configured to perform accumulation operations on the number of output operands and to generate a new output operand, where each accumulation operation includes an accumulation of the number of output elements, each of the number of output elements is from a different one of the number of output operands, and the number of output elements correspond to a same channel of the plurality of channels.

Example 6 provides the apparatus of example 5, where the plurality of PEs is arranged in a column, and the additional adder assembly is external to the column.

Example 7 provides the apparatus of example 5, where the filter includes a plurality of weights arranged in rows and columns, each of the number of output elements is a sum of products of input elements from different input operands and weights from different weight operands, the weights for an output element of the number of output elements are in a same row of the filter and are in a different row of the filter from another output element of the number of output elements.

Example 8 provides the apparatus of example 5, where the additional adder assembly includes a first group of adders and a second group of one or more adders, an adder in the first group is configured to accumulate outputs from at least two PEs of the plurality of PEs, and an adder in the second group is configured to accumulate outputs from at least two adders in the first group.

Example 9 provides the apparatus of example 1, where the plurality of multipliers includes a first multiplier and a second multiplier, the first multiplier is configured to perform multiplication operations on a first input operand from a first input register file and a first weight operand from a first weight register file at a first time, the second multiplier is configured to perform multiplication operations on the first input operand from the first input register file and a second weight operand from a second weight register file at a second time, the second time different from the first time.

Example 10 provides the apparatus of example 9, where the second multiplier is configured to perform multiplication operations on a second input operand and the second weight operand at the first time.

Example 11 provides the apparatus of example 9, where the first input register file is configured to store a new input operand at the second time.

Example 12 provides the apparatus of example 11, where the plurality of multipliers further includes a third multiplier, and the third multiplier is configured to perform multiplication operations on the new input operand from the first input register file and a third weight operand from a third weight register file at a third time, and the third time is after the second time.

Example 13 provides the apparatus of example 1, further including an array of PEs that includes the PE, where input register files of one or more other PEs in the array are configured to store same input operands as the plurality of input register files of the PE.

Example 14 provides the apparatus of example 1, where weight register files of one or more other PEs in the array are configured to store same weight operands as the plurality of weight register files of the PE.

Example 15 provides the apparatus of example 1, where a weight register file of the plurality of weight register files is configured not to store any weight operand at a time, and another weight register file of the plurality of weight register files is configured to store a weight operand at the time.

Example 16 provides a method for deep learning, including determining a number of input register files in a PE of a plurality of PEs, the plurality of PEs configured to perform multiply-accumulation operations on a filter and an input feature map that includes a plurality of channels; forming the number of input operands from the input feature map, each input operand including a sequence of input elements from the input feature map, each input element corresponding to a different channel of the plurality of channels; transferring each of the number of input operands to a different one of the input register files; determining a size of the filter; identifying, based on the size of the filter, a tier in an adder assembly coupled to the plurality of PEs, the adder assembly including adders arranged in a sequence of tiers, each tier including one or more adders; and obtaining an output operand from each adder in the tier, where the output operand includes a sequence of output elements, and each output element corresponds to a different channel of the plurality of channels.

Example 17 provides the method of example 16, where the filter includes weights arranged in rows and columns, and the size of the filter is a number of the rows or a number of the columns.

Example 18 provides the method of example 16, further including determining an additional number of weight register files in the PE; forming the additional number of weight operands from the filter, each weight operand including a sequence of weight from the filter, each weight corresponding to a different channel of the plurality of channels; and transferring each of the additional number of weight operands to a different one of the weight register files.

Example 19 provides the method of example 16, further including instructing, at a first time, a first multiplier in the PE to perform multiplication operations on a first input operand from a first input register file and a first weight operand from a first weight register file; and instructing, at a second time that is different from the first time, a second multiplier of the PE to perform multiplication operations on the first input operand from the first input register file and a second weight operand from a second weight register file.

Example 20 provides the method of example 19, further including instructing, at the first time, the second multiplier of the PE to perform multiplication operations on a second input operand and the second weight operand at the first time.

Example 21 provides the method of example 19, further including transferring, at the second time, a new input operand to the first input register file.

Example 22 provides the method of example 21, further including instructing, at a third time that is after the second time, a third multiplier to perform multiplication operations on the new input operand from the first input register file and a third weight operand from a third weight register file.

Example 23 provides the method of example 16, further including transferring same input operands to the input register files in the PE and to input register files in another PE of the plurality of PEs.

Example 24 provides the method of example 23, further including transferring same weight operands to weight register files in the PE and to weight register files in another PE of the plurality of PEs, where each weight operand includes a sequence of weight from the filter, and each weight corresponds to a different channel of the plurality of channels.

Example 25 provides the method of example 16, further including selecting, based on the size of the filter, a subset of PEs from the plurality of PEs; and transferring input operands to input registers files of the PEs in the subset.

26 provides one or more non-transitory computer-readable media storing instructions executable to perform operations for deep learning, the operations including determining a number of input register files in a PE of a plurality of PEs, the plurality of PEs configured to perform multiply-accumulation operations on a filter and an input feature map that includes a plurality of channels; forming the number of input operands from the input feature map, each input operand including a sequence of input elements from the input feature map, each input element corresponding to a different channel of the plurality of channels; transferring each of the number of input operands to a different one of the input register files; determining a size of the filter; identifying, based on the size of the filter, a tier in an adder assembly coupled to the plurality of PEs, the adder assembly including adders arranged in a sequence of tiers, each tier including one or more adders; and obtaining an output operand from each adder in the tier, where the output operand includes a sequence of output elements, and each output element corresponds to a different channel of the plurality of channels.

Example 27 provides the one or more non-transitory computer-readable media of example 26, where the filter includes weights arranged in rows and columns, and the size of the filter is a number of the rows or a number of the columns.

Example 28 provides the one or more non-transitory computer-readable media of example 26, where the operations further include determining an additional number of weight register files in the PE; forming the additional number of weight operands from the filter, each weight operand including a sequence of weight from the filter, each weight corresponding to a different channel of the plurality of channels; and transferring each of the additional number of weight operands to a different one of the weight register files.

Example 29 provides the one or more non-transitory computer-readable media of example 26, where the operations further include instructing, at a first time, a first multiplier in the PE to perform multiplication operations on a first input operand from a first input register file and a first weight operand from a first weight register file; and instructing, at a second time that is different from the first time, a second multiplier of the PE to perform multiplication operations on the first input operand from the first input register file and a second weight operand from a second weight register file.

Example 30 provides the one or more non-transitory computer-readable media of example 29, where the operations further include instructing, at the first time, the second multiplier of the PE to perform multiplication operations on a second input operand and the second weight operand at the first time.

Example 31 provides the one or more non-transitory computer-readable media of example 29, where the operations further include transferring, at the second time, a new input operand to the first input register file.

Example 32 provides the one or more non-transitory computer-readable media of example 31, where the operations further include instructing, at a third time that is after the second time, a third multiplier to perform multiplication operations on the new input operand from the first input register file and a third weight operand from a third weight register file.

Example 33 provides the one or more non-transitory computer-readable media of example 26, where the operations further include transferring same input operands to the input register files in the PE and to input register files in another PE of the plurality of PEs.

Example 34 provides the one or more non-transitory computer-readable media of example 33, where the operations further include transferring same weight operands to weight register files in the PE and to weight register files in another PE of the plurality of PEs, where each weight operand includes a sequence of weight from the filter, and each weight corresponds to a different channel of the plurality of channels

Example 35 provides the one or more non-transitory computer-readable media of example 26, where the operations further include selecting, based on the size of the filter, a subset of PEs from the plurality of PEs; and transferring input operands to input registers files of the PEs in the subset.

Example 36 provides an apparatus for deep learning, the apparatus including a PE that includes a plurality of input register files configured to store input operands, where each input operand includes a number of input elements from an input feature map, the input feature map includes the number of channels, and each input element corresponds to a different channel of the plurality of channels; a pooling assembly configured to perform a sequence of pooling operations on the input operands and to generate an output operand; and an output register file configured to store the output operand, where the output operand includes the number of output elements, and each output element corresponds to a different channel of the plurality of channels.

Example 37 provides the apparatus of example 36, where each pooling operation in the sequence includes determining an output element from a plurality of input elements, each of the plurality of input elements is from a different one of the input operands, and the plurality of input elements corresponds to a same channel of the plurality of channels.

Example 38 provides the apparatus of example 37, where for each pooling operation, the pooling assembly is configured to determine the output element based on a particular input element of the plurality of input elements, and the particular input element has a greater value than other input elements of the plurality of input elements.

Example 39 provides the apparatus of example 37, where for each pooling operation, the pooling assembly is configured to determine the output element based on an average value of the plurality of input elements.

Example 40 provides the apparatus of example 36, where the pooling assembly includes a plurality of pooling operators arranged in a sequence of tiers, a pooling operator in a first tier in the sequence is configured to perform pooling operations on two or more of the input operands, and a pooling operator in a second tier in the sequence is configured to perform pooling operations on outputs of two or more pooling operators in the first tier.

Example 41 provides an apparatus for deep learning, including a plurality of input register files, an input register file configured to store an input operand that includes a sequence of input elements from an input feature map, the input feature map including a plurality of channels, and each input element corresponding to a different channel of the plurality of channels; a plurality of scale register files, a scale register file configured to store a scale operand that includes a sequence of scale elements having a predetermined value; and a plurality of multipliers, a multiplier configured to perform multiplication operations on a respective input operand from a respective input register file and a respective scale operand from a respective scale register file, where each multiplication operation includes a multiplication of a different input element in the respective input operand and a different scale element in the respective scale operand; an adder assembly configured to perform accumulation operations on products generated by at least some of the plurality of multipliers and to generate an output operand; and an output register file configured to store the output operand, where the output operand includes a sequence of output elements, and each output element corresponds to a different channel of the plurality of channels.

Example 42 provides the apparatus of example 41, where a position of the different input element in the respective input operand matches a position of the different scale element in the respective scale weight operand.

Example 43 provides the apparatus of example 41, where the plurality of multipliers includes a first multiplier and a second multiplier that perform multiplication operations on a same input operand and two different scale operands.

Example 44 provides the apparatus of example 43, where in the second multiplier is configured to generate a product operand including a sequence of products, each product is a result of multiplying an input element in the same input operand and a scale element in one of the two different scale operands, the apparatus further includes a bit shifter configured to change positions of the products in the product operand.

Example 45 provides the apparatus of example 41, where the adder assembly including a first group of adders and a second group of one or more adders, an adder in the first group is configured to accumulate products generated by at least two multipliers of the plurality of multipliers, and an adder in the second group is configured to accumulate sums generated by at least two adders in the first group.

Example 46 provides an apparatus for deep learning, the apparatus including a PE that includes a plurality of first register files, a first register file configured to store an operand that includes a number of elements from a first feature map including the number of channels; a plurality of second register files, a second register file configured to store an operand that includes the number of elements from a second feature map including the number channels; a plurality of multipliers, a multiplier configured to perform multiplication operations on a first operand from a respective first register file and a second operand from a respective second register file, where each multiplication operation includes a multiplication of a first element in the first operand and a second element in the second operand; and a plurality of output register files, an output register file configured to store an output operand from a multiplier of the plurality of multipliers, where the output operand includes a sequence of output elements, and each output element corresponds to a different channel of the number of channels.

Example 47 provides the apparatus of example 46, where the first feature map is from a first layer of a deep neural network, and the second feature map is from a second layer of the deep neural network.

Example 48 provides the apparatus of example 46, where a position of the first element in the first operand matches a position of the second element in the second operand.

Example 49 provides the apparatus of example 46, where the plurality of multipliers includes a first multiplier and a second multiplier that are configured to perform multiplication operations at a same time.

Example 50 provides the apparatus of example 46, where the first operand or the second operand includes a sequence of elements, and each element in the sequence corresponds to a different channel of the number of the channels.

The above description of illustrated implementations of the disclosure, including what is described in the Abstract, is not intended to be exhaustive or to limit the disclosure to the precise forms disclosed. While specific implementations of, and examples for, the disclosure are described herein for illustrative purposes, various equivalent modifications are possible within the scope of the disclosure, as those skilled in the relevant art will recognize. These modifications may be made to the disclosure in light of the above detailed description.

1. An apparatus for deep learning, the apparatus comprising a processing element that includes:
a plurality of input register files, an input register file configured to store an input operand that includes a sequence of input elements from an input feature map, the input feature map comprising a plurality of channels, and each input element corresponding to a different channel of the plurality of channels;
a plurality of weight register files, a weight register file configured to store a weight operand that includes a sequence of weights from a filter;
a plurality of multipliers, a multiplier configured to perform multiplication operations on a respective input operand from a respective input register file and a respective weight operand from a respective weight register file, wherein each multiplication operation includes a multiplication of a different input element in the respective input operand and a different weight in the respective weight operand;
an adder assembly configured to perform accumulation operations on products generated by at least some of the plurality of multipliers and to generate an output operand; and
an output register file configured to store the output operand, wherein the output operand includes a sequence of output elements, and each output element corresponds to a different channel of the plurality of channels.

2. The apparatus of claim 1, wherein a position of the different input element in the respective input operand matches a position of the different weight in the respective weight operand.

3. The apparatus of claim 1, wherein the filter includes a plurality of weights arranged in rows and columns, an output element in the output operand is a sum of products of input elements from different input operands and weights from different weight operands, and the weights for the output element are in a same row of the filter.

4. The apparatus of claim 1, wherein the adder assembly comprising a first group of adders and a second group of one or more adders, an adder in the first group is configured to accumulate products generated by at least two multipliers of the plurality of multipliers, and an adder in the second group is configured to accumulate sums generated by at least two adders in the first group.

5. The apparatus of claim 1, further comprising:
a plurality of processing elements including the processing element, the plurality of processing elements configured to generate a number of output operands, each of which is generated by a different one of the plurality of processing elements; and
an additional adder assembly configured to perform accumulation operations on the number of output operands and to generate a new output operand, wherein each accumulation operation includes an accumulation of the number of output elements, each of the number of output elements is from a different one of the number of output operands, and the number of output elements correspond to a same channel of the plurality of channels.

6. The apparatus of claim 5, wherein the plurality of processing elements is arranged in a column, and the additional adder assembly is external to the column.

7. The apparatus of claim 5, wherein the filter includes a plurality of weights arranged in rows and columns, each of the number of output elements is a sum of products of input elements from different input operands and weights from different weight operands, the weights for an output element of the number of output elements are in a same row of the filter and are in a different row of the filter from another output element of the number of output elements.

8. The apparatus of claim 5, wherein the additional adder assembly comprises a first group of adders and a second group of one or more adders, an adder in the first group is configured to accumulate outputs from at least two processing elements of the plurality of processing elements, and an adder in the second group is configured to accumulate outputs from at least two adders in the first group.

9. The apparatus of claim 1, wherein:
the plurality of multipliers comprises a first multiplier and a second multiplier,
the first multiplier is configured to perform multiplication operations on a first input operand from a first input register file and a first weight operand from a first weight register file at a first time,
the second multiplier is configured to perform multiplication operations on the first input operand from the first input register file and a second weight operand from a second weight register file at a second time, the second time different from the first time.

10. The apparatus of claim 9, wherein the second multiplier is configured to perform multiplication operations on a second input operand and the second weight operand at the first time.

11. The apparatus of claim 9, wherein the first input register file is configured to store a new input operand at the second time.

12. The apparatus of claim 11, wherein the plurality of multipliers further comprises a third multiplier, and the third multiplier is configured to perform multiplication operations on the new input operand from the first input register file and a third weight operand from a third weight register file at a third time, and the third time is after the second time.

13. The apparatus of claim 1, further comprising an array of processing elements that includes the processing element, wherein input register files of one or more other processing elements in the array are configured to store same input operands as the plurality of input register files of the processing element.

14. The apparatus of claim 13, wherein weight register files of one or more other processing elements in the array are configured to store same weight operands as the plurality of weight register files of the processing element.

15. The apparatus of claim 1, wherein a weight register file of the plurality of weight register files is configured not to store any weight operand at a time, and another weight register file of the plurality of weight register files is configured to store a weight operand at the time.

16. A method for deep learning, comprising:
determining a number of input register files in a processing element (PE) of a plurality of PEs, the plurality of PEs configured to perform multiply-accumulation operations on a filter and an input feature map that includes a plurality of channels;
forming the number of input operands from the input feature map, each input operand including a sequence of input elements from the input feature map, each input element corresponding to a different channel of the plurality of channels;
transferring each of the number of input operands to a different one of the input register files;
determining a size of the filter;
identifying, based on the size of the filter, a tier in an adder assembly coupled to the plurality of PEs, the adder assembly including adders arranged in a sequence of tiers, each tier including one or more adders; and
obtaining an output operand from each adder in the tier, wherein the output operand includes a sequence of output elements, and each output element corresponds to a different channel of the plurality of channels.

17. The method of claim 16, wherein the filter includes weights arranged in rows and columns, and the size of the filter is a number of the rows or a number of the columns.

18. The method of claim 16, further comprising:
determining an additional number of weight register files in the PE;
forming the additional number of weight operands from the filter, each weight operand including a sequence of weight from the filter, each weight corresponding to a different channel of the plurality of channels; and
transferring each of the additional number of weight operands to a different one of the weight register files.

19. The method of claim 16, further comprising:
instructing, at a first time, a first multiplier in the PE to perform multiplication operations on a first input operand from a first input register file and a first weight operand from a first weight register file; and
instructing, at a second time that is different from the first time, a second multiplier of the PE to perform multiplication operations on the first input operand from the first input register file and a second weight operand from a second weight register file.

20. The method of claim 19, further comprising:
instructing, at the first time, the second multiplier of the PE to perform multiplication operations on a second input operand and the second weight operand at the first time.

21. The method of claim 19, further comprising:
transferring, at the second time, a new input operand to the first input register file.

22. The method of claim 21, further comprising:
instructing, at a third time that is after the second time, a third multiplier to perform multiplication operations on the new input operand from the first input register file and a third weight operand from a third weight register file.

23. The method of claim 16, further comprising:
transferring same input operands to the input register files in the PE and to input register files in another PE of the plurality of PEs.

24. The method of claim 23, further comprising:
transferring same weight operands to weight register files in the PE and to weight register files in another PE of the plurality of PEs,
wherein each weight operand includes a sequence of weight from the filter, and each weight corresponds to a different channel of the plurality of channels.

25. The method of claim 16, further comprising:
selecting, based on the size of the filter, a subset of PEs from the plurality of PEs; and
transferring input operands to input registers files of the PEs in the subset.
